(19) United States
(12) Patent Application Publication
(10) Pub. No.: US 2026/0159621 A1
(43) Pub. Date: Jun. 11, 2026

(54) POLYMER-BASED PORTION, FOLDABLE APPARATUS, AND METHODS OF MAKING

(71) Applicant: CORNING INCORPORATED, CORNING, NY (US)

(72) Inventors: SUSHMIT SUNIL KUMAR GOYAL, PAINTED POST, NY (US); FRANKLIN LANGLANG LEE, GREEN BROOK, NJ (US); KEVIN ROBERT MCCARTHY, HORSEHEADS, NY (US); YOUSEF KAYED QAROUSH, PAINTED POST, NY (US); ARLIN LEE WEIKEL, MANSFIELD, PA (US); TINGGE XU, SAN JOSE, CA (US)

(21) Appl. No.: 18/706,468

(22) PCT Filed: Nov. 4, 2022
(86) PCT No.: PCT/US2022/048952

§ 371 Date: May 1, 2024

Related U.S. Application Data
(60) Provisional application No. 63/275,710, filed on Nov. 4, 2021.

(51) Int. Cl. C08F 220/34; C08F 220/18; C08F 220/30; C08F 283/12; C08K 5/5425; C08K 5/548

(52) U.S. Cl. CPC C08F 220/343; C08F 220/1818; C08F 220/301; C08F 283/124; C08K 5/5425; C08K 5/548; C08F 2800/20

(57) ABSTRACT

A polymer-based portion comprises an index of refraction from about 1.48 to about 1.54. The polymer-based portion comprises the product of curing a composition. In aspects, the composition comprises a ratio of an amount of a difunctional urethane-acrylate oligomer to an amount of a reactive diluent from about 0.4 to about 1.5. In aspects, the composition comprises 35-65 wt % of a difunctional urethane-acrylate oligomer and 40-65 wt % of a reactive diluent. Methods of forming the polymer-based portion comprise curing the composition. A foldable apparatus comprises the polymer-based portion at least partially positioned in a recess defined between a first portion and a second portion. The polymer-based portion further comprising a polymer thickness of about 40 micrometers or less measured from a third surface area of the first portion. The foldable substrate comprises a first substrate contacting a fourth contact surface of the polymer-based portion.

### CROSS-REFERENCE TO RELATED APPLICATION

This application claims the benefit of priority under 35 U.S.C. § 119 of U.S. Provisional Application Ser. No. 63/275,710 filed on Nov. 4, 2021, the content of which is relied upon and incorporated herein by reference in its entirety.

### FIELD

The present disclosure relates generally to polymer-based portions, foldable apparatus, and methods of making and, more particularly, to polymer-based portions comprising a urethane acrylate and foldable apparatus comprising a foldable substrate and methods of making.

### BACKGROUND

Foldable substrates are commonly used, for example, in display applications, for example, liquid crystal displays (LCDs), electrophoretic displays (EPD), organic light-emitting diode displays (OLEDs), plasma display panels (PDPs), or the like.

There is a desire to develop foldable displays as well as foldable protective covers to mount on foldable displays. Foldable displays and foldable covers should have good impact and puncture resistance. At the same time, foldable displays and foldable covers should have small minimum bend radii (e.g., about 10 millimeters (mm) or less).

Some prior foldable displays have used polymer-based portions. However, polymer-based portions can impair the flexibility, and/or impact resistance of the foldable display and/or foldable protective cover. Moreover, adhesives and/or polymer-based portions can impair the flexibility and bending performance of the foldable display and/or foldable protective cover if the bending strain exceeds the ultimate elongation of the polymer-based portion.

There is a desire for foldable apparatus, for example, as foldable displays or foldable protective covers to mount on foldable displays. Foldable apparatus should have good impact and puncture resistance. At the same time, foldable displays and foldable covers should have small minimum bend radii (e.g., about 10 millimeters (mm) or less). Additionally, there is a need to develop foldable substrates (e.g., glass-based substrates, ceramic-based substrates) and polymer-based portions for foldable apparatus that have high transparency, low haze, low minimum bend radii, and good impact and puncture resistance.

### SUMMARY

There are set forth herein polymer-based portion and/or foldable apparatus comprising a polymeric material and methods of making the same. In aspects, an index of refraction of the polymeric material of the polymer-based portion can comprise a small (e.g., about 0.01 or less) absolute difference from an index of refraction of a substrate (e.g., first substrate, second substrate). Providing an index of refraction for the polymer-based portion within one or more of the above-mentioned ranges can reduce an absolute difference of index of refraction between the polymer-based portion and components (e.g., substrate, adhesive, hard-coating) that can be adjacent to the polymer-based portion in an application, which can reduce optical distortions. Providing a plurality of reactive diluents (e.g., 2, 3, 4, or more) in the composition used to form the polymer-based portion can enable the polymer-based portion to better match the index of refraction of adjacent components. Providing a polymeric material comprising low haze can enable good visibility through the polymer-based portion and/or foldable apparatus.

The polymer-based portion can comprise a urethane acrylate material that is elastomeric. By providing an elastomeric polymer-based portion, the polymer-based portion can recover (e.g., fully recover) from folding-induced strains and/or impact-induced strains, which can decrease fatigue of the polymer-based portion from repeated folding, enable a low force to achieve a given parallel plate distance, and enable good impact and/or good puncture resistance. Providing a composition that is substantially solvent-free can increase its curing rate, which can decrease processing time. Providing a composition that is substantially solvent-free can reduce (e.g., decrease, eliminate) the use of rheology modifiers and increase composition homogeneity, which can increase the optical transparency (e.g., transmittance) of the resulting adhesive. Providing a composition that is substantially free of a multi-functional monomer can enable a lower elastic modulus of the resulting polymer-based portion, which can improve foldability of a foldable apparatus with the polymer-based portion.

Providing a low glass transition temperature (e.g., about −10° C. or less, about −20° C. or less) of the polymer-based portion can enable consistent mechanical properties of the polymer-based portion across a temperature range in which it is used (e.g., from about 0° C. to about 60° C.). Providing a difunctional urethane-acrylate oligomer can comprise a low glass transition temperature (e.g., less than the glass transition temperature of the polymer-based portion, about −10° C. or less, about −30° C. or less). Also, the polymer-based portion can withstand high strains (e.g., about 50% or more, from about 100% to about 250%), which can improve folding performance and durability. Providing a silane-coupling agent can increase adhesion of the polymer-based portion to substrates (e.g., glass-based substrates, ceramic-based substrates, polymer-based substrates) and/or adhesives.

Methods are disclosed that can form a foldable apparatus from a polymer-based portion and a substrate (e.g., first substrate, second substrate). For example, a polymer-based portion can be formed of a polymeric material by heating a liquid comprising the material. Providing a polymer-based portion can reduce processing steps to assemble the foldable apparatus. For example, foldable apparatus can be assembled using methods of the disclosure using a single heating cycle to bond one or more polymer-based portions, substrates, and/or other components of the foldable apparatus. Consequently, processing time and costs to create the foldable apparatus can be reduced. Providing polymer-based portions can reduce energy use, reduce material waste, and otherwise improve forming of the foldable apparatus.

A foldable apparatus according to the aspects of the disclosure can provide several technical benefits. For example, the foldable apparatus can provide small effective minimum bend radii while simultaneously providing good impact and puncture resistance. The foldable apparatus can comprise glass-based and/or ceramic-based materials comprising one or more compressive stress regions, which can further provide increased impact resistance and/or puncture resistance while simultaneously facilitating good bending performance. Providing a foldable apparatus comprising a central portion comprising a central thickness that is less than a first thickness of the first portion and/or second portion can enable small effective minimum bend radii (e.g., about 10 millimeters (mm) or less) based on the reduced thickness in the central portion.

A ribbon, substrates, and/or portions can comprise glass-based and/or ceramic-based portions, which can provide good dimensional stability, reduced incidence of mechanical instabilities, good impact resistance, and/or good puncture resistance. The ribbon, the substrate, the first portion, and/or the second portion can comprise glass-based and/or ceramic-based portions comprising one or more compressive stress regions, which can further provide increased impact resistance and/or increased puncture resistance. By providing the substrate, the first portion, and/or the second portion comprising a glass-based and/or ceramic-based substrate, the substrate can also provide increased impact resistance and/or puncture resistance while simultaneously facilitating good folding performance. Providing a ribbon comprising a central portion comprising a central thickness that is less than a substrate thickness (e.g., first thickness of the first portion and/or second thickness of the second portion) can enable small effective minimum bend radii (e.g., about 10 millimeters or less) based on the reduced thickness in the central portion.

Providing the polymer-based portion can be used as an adhesive layer and as a polymeric (e.g., elastomeric) portion. Using the polymer-based portion as both an adhesive layer and a polymer portion can reduce a number of components in the foldable apparatus. An elastic modulus of the polymer-based portion and a polymer thickness of the polymer-based portion can enable substrates, portions, and/or a ribbon to be at least partially decoupled. For example, an at least partially decoupled foldable apparatus can comprise an apparatus bend force near (e.g., within a factor of 2, from about 0.5 times to about 1 time) of a total bend force from bending each first portion individually, which can enable low user-applied forces to fold the foldable apparatus. For example, a ratio of an elastic modulus of the substrates (e.g., first substrate, second substrate), the portions, and/or the ribbon to the elastic modulus of the polymer-based portion is in a range from about 500 to about 200,000. For example, a polymer thickness can be in a range from about 10 micrometers to about 30 micrometers. Providing the elastic modulus and/or the polymer thickness of the polymer-based portion can reduce bend-induced stresses on one or more of the first portions in the adjacent pair of first portions. Reducing bend-induced stresses can reduce (e.g., decreases, eliminate) bend-induced mechanical instabilities of the foldable apparatus. Also, reducing bend-induced stresses can reduce fatigue of the foldable apparatus while increasing the reliability and/or durability of the foldable apparatus. In aspects, the polymer-based portion can comprise a second neutral plane between two first neutral planes, which can reflect the decoupling of the components of the foldable apparatus.

Some example aspects of the disclosure are described below with the understanding that any of the features of the various aspects may be used alone or in combination with one another.

Aspect 1. A polymer-based portion comprising an index of refraction in a range from about 1.48 to about 1.54, wherein the polymer-based portion comprises the product of curing a composition, the composition comprises a ratio of an amount of a difunctional urethane-acrylate oligomer to an amount of a reactive diluent in a range from about 0.4 to about 1.5.

Aspect 2. The polymer-based portion of aspect 1, wherein the composition comprises the following in weight % (wt %):
35-60 wt % of the difunctional urethane-acrylate oligomer; and
40-65 wt % of the reactive diluent.

Aspect 3. A polymer-based portion comprising an index of refraction in a range from about 1.48 to about 1.54, wherein the polymer-based portion comprises the product of curing a composition, the composition comprises the following in weight % (wt %).
35-60 wt % of a difunctional urethane-acrylate oligomer; and
40-65 wt % of a reactive diluent.

Aspect 4. The polymer-based portion of any one of aspects 1-3, wherein the difunctional urethane-acrylate oligomer comprises a difunctional aliphatic urethane acrylate.

Aspect 5. The polymer-based portion of any one of aspects 1-4, wherein the reactive diluent comprises one or more of biphenylmethyl acrylate, phenol ether acrylate, an alkyl phenol ether acrylate, or isooctyl acrylate.

Aspect 6. The polymer-based portion of any one of aspects 1-5, wherein the reactive diluent comprises a monofunctional acrylate.

Aspect 7. The polymer-based portion of any one of aspects 1-6, wherein the polymer-based portion comprises a glass transition temperature in a range from about −40° C. to about −10° C.

Aspect 8. The polymer-based portion of aspect 7, wherein the glass transition temperature is in a range from about −35° C. to about −20° C.

Aspect 9. The polymer-based portion of any one of aspects 1-8, wherein the composition further comprises 0.2-2 wt % of a photo-initiator.

Aspect 10. The polymer-based portion of aspect 9, wherein the photo-initiator comprises ethyl (2,4,6-trimethylbenzoyl) phenylphosphinate.

Aspect 11. The polymer-based portion of any one of aspects 1-10, wherein the composition further comprises 0.1-4.9 wt % of a silane coupling agent.

Aspect 12. The polymer-based portion of aspect 11, wherein the silane coupling agent comprises a mercapto-silane or an acrylate-silane.

Aspect 13. The polymer-based portion of aspect 12, wherein the mercapto-silane comprises 3-mercaptopropyltrimethoxysilane.

Aspect 14. The polymer-based portion of any one of aspects 1-13, wherein the polymer-based portion is substantially free of a multi-functional monomer.

Aspect 15. The polymer-based portion of any one of aspects 1-14, wherein the polymer-based portion is substantially free of a thermoplastic elastomer.

Aspect 16. The polymer-based portion of any one of aspects 1-15, wherein the polymer-based portion comprises an average transmittance of about 90% or more measured over optical wavelengths in a range from 400 nanometers to 760 nanometers.

Aspect 17. The polymer-based portion of any one of aspects 1-16, wherein the polymer-based portion comprises a haze of about 0.2% or less.

Aspect 18. The polymer-based portion of any one of aspects 1-17, wherein the index of refraction of the polymer-based portion is in a range from 1.49 to about 1.51.

Aspect 19. The polymer-based portion of any one of aspects 1-18, wherein the polymer-based portion comprises an ultimate elongation of about 100% or more.

Aspect 20. The polymer-based portion of aspect 19, wherein the ultimate elongation is in a range from about 100% to about 250%.

Aspect 21. The polymer-based portion of any one of aspects 1-20, wherein the polymer-based portion comprises a tensile strength in a range from about 0.5 MegaPascals to about 2 MegaPascals.

Aspect 22. The polymer-based portion of any one of aspects 1-21, wherein the polymer-based portion comprises an elastic modulus in a range from about 0.5 MegaPascals to about 10 MegaPascals.

Aspect 23. The polymer-based portion of any one of aspects 1-21, wherein the polymer-based portion comprises an elastic modulus in a range from about 0.8 MegaPascals to about 3 MegaPascals.

Aspect 24. The polymer-based portion of any one of aspects 1-21, wherein the polymer-based portion comprises an elastic modulus in a range from about 100 MegaPascals to about 1,100 MegaPascals.

Aspect 25. The polymer-based portion of aspect 24, wherein the polymer-based portion further comprises silica nanoparticles or alumina nanoparticles.

Aspect 26. The polymer-based portion of any one of aspects 1-24, wherein the polymer-based portion is free of silica nanoparticles and alumina nanoparticles.

Aspect 27. The polymer-based portion of any one of aspects 1-26, wherein the polymer-based portion further comprises a functionalized oligomeric silsesquioxane.

Aspect 28. The polymer-based portion of any one of aspects 1-27, wherein the polymer-based portion at 23° C. can fully recover after being extended to a strain of 10% at a strain rate of 10% strain per minute.

Aspect 29. The polymer-based portion of any one of aspects 1-28, wherein the polymer-based portion can withstand 200,000 bending cycles at a parallel plate distance of 3 millimeters.

Aspect 30. The polymer-based portion of any one of aspects 1-28, wherein the polymer-based portion achieves a parallel plate distance of 10 millimeters.

Aspect 31. The polymer-based portion of any one of aspects 1-30, wherein the polymer-based portion comprises a minimum parallel plate distance in a range from about 2 millimeters to about 10 millimeters.

Aspect 32. A foldable apparatus comprising: a ribbon comprising a central portion positioned between a first portion and a second portion, the central portion comprises a central thickness defined between a first central surface area and a second central surface area opposite the first central surface area, the ribbon comprises a ribbon thickness defined between a first major surface and a second major surface opposite the first major surface, the first central surface area recessed from the first major surface by a first distance, wherein the recess is defined between a first plane defined by the first major surface and a second plane defined by the first central surface area; and the polymer-based portion of any one of aspects 1-20 at least partially positioned in the recess.

Aspect 33. The foldable apparatus of aspect 32, wherein a magnitude of a difference between an index of refraction of the ribbon and the index of refraction of the polymer-based portion is about 0.05 or less.

Aspect 34. The foldable apparatus of any one of aspects 32-33, wherein the second major surface and the second central surface area are coplanar.

Aspect 35. The foldable apparatus of any one of aspects 32-34, wherein the foldable apparatus can withstand 200,000 bending cycles at a parallel plate distance of 3 millimeters.

Aspect 36. The foldable apparatus of any one of aspects 32-34, wherein the foldable apparatus achieves a parallel plate distance of 10 millimeters.

Aspect 37. The foldable apparatus of any one of aspects 32-34, wherein the foldable apparatus comprises a minimum parallel plate distance in a range from about 2 millimeters to about 10 millimeters.

Aspect 38. A consumer electronic product, comprising:
a housing comprising a front surface, a back surface and side surfaces;
electrical components at least partially within the housing, the electrical components comprising a controller, a memory, and a display, the display at or adjacent the front surface of the housing; and
a cover substrate disposed over the display,
wherein at least one of a portion of the housing or the cover substrate comprises the foldable apparatus of any one of aspects 32-37.

Aspect 39. A foldable apparatus comprising:
a first portion comprising a first surface area and a second surface area opposite the first surface area, a first edge surface defined between the first surface area and the second surface area, and a first portion thickness defined between the first surface area and the second surface area;
a second portion comprising a third surface area and a fourth surface area opposite the third surface area, a second edge surface defined between the third surface area and the fourth surface area, and a second portion thickness between the third surface area and the fourth surface area;
a polymer-based portion at least partially positioned between the first edge surface and the second edge surface, the polymer-based portion comprises a first contact surface and a second contact surface opposite the first contact surface, wherein the polymer-based portion contacts the first surface area of the first portion and the third surface area of the second portion, and the polymer-based portion further comprises a polymer thickness of about 40 micrometers or less measured from the first surface area of the first portion in a direction of the first portion thickness; and
a first substrate contacting the second contact surface of the polymer-based portion.

Aspect 40. The foldable apparatus of aspect 39, wherein the polymer thickness is in a range from about 10 micrometers to about 30 micrometers.

Aspect 41. The foldable apparatus of any one of aspects 39-40, wherein the polymer-based portion comprises the polymer-based portion of any one of aspects 1-20.

Aspect 42. The foldable apparatus of any one of aspects 39-41, wherein the polymer-based portion comprises an elastic modulus in a range from about 0.8 MegaPascals to about 2 MegaPascals.

Aspect 43. The foldable apparatus of any one of any one of aspects 39-41, wherein the elastic modulus of the polymer-based portion is in a range from about 0.5 MegaPascals to about 1.1 MegaPascals.

Aspect 44. The foldable apparatus of any one of aspects 42-43, wherein a ratio of an elastic modulus of the first substrate to the elastic modulus of the polymer-based portion is in a range from about 500 to about 200,000.

Aspect 45. The foldable apparatus of any one of aspects 39-44, wherein the first substrate comprises a polymeric substrate.

Aspect 46. The foldable apparatus of any one of aspects 39-44, wherein the first substrate comprises a glass-based substrate or a ceramic-based substrate.

Aspect 47. The foldable apparatus of any one of aspects 39-46, wherein an absolute difference between the index of refraction of the polymer-based portion and an index of refraction of the first portion is about 0.05 or less.

Aspect 48. The foldable apparatus of any one of aspects 39-46, wherein an absolute difference between the index of refraction of the polymer-based portion and an index of refraction of the first portion is about 0.02 or less.

Aspect 49. The foldable apparatus of any one of aspects 39-48, further comprising a second substrate disposed over the second surface area of the first portion, the fourth surface area of the second portion, and the first contact surface of the polymer-based portion.

Aspect 50. The foldable apparatus of aspect 49, wherein the second substrate comprises a second substrate thickness in a range from about 30 micrometers to about 100 micrometers.

Aspect 51. The foldable apparatus of any one of aspects 49-50, wherein the second substrate comprises a glass-based substrate or a ceramic-based substrate.

Aspect 52. The foldable apparatus of any one of aspects 49-51, wherein the first substrate and the second substrate each comprise a first neutral plane, and the polymer-based portion comprises a second neutral plane.

Aspect 53. The foldable apparatus of any one of aspects 39-52, wherein the foldable apparatus can withstand 200,000 bending cycles at a parallel plate distance of 3 millimeters.

Aspect 54. The foldable apparatus of any one of aspects 39-52, wherein the foldable apparatus achieves a parallel plate distance of 10 millimeters.

Aspect 55. The foldable apparatus of any one of aspects 39-54, wherein the foldable apparatus comprises a minimum parallel plate distance in a range from about 2 millimeters to about 10 millimeters.

Aspect 56. A consumer electronic product, comprising:
a housing comprising a front surface, a back surface and side surfaces;
electrical components at least partially within the housing, the electrical components comprising a controller, a memory, and a display, the display at or adjacent the front surface of the housing; and
a cover substrate disposed over the display,
wherein at least one of a portion of the housing or the cover substrate comprises the foldable apparatus of any one of aspects 39-55.

Aspect 57. A method of forming a polymer-based portion comprising:
creating a composition comprising a ratio of an amount of a difunctional urethane-acrylate oligomer to an amount of a reactive diluent in a range from about 0.4 to about 1.5; and
curing the composition to form the polymer-based portion,
wherein the polymer-based portion comprises an index of refraction in a range from about 1.48 to about 1.54.

Aspect 58. The method of aspect 57, wherein the composition comprises the following in weight % (wt %):
35-60 wt % of the difunctional urethane-acrylate oligomer; and
40-65 wt % of the reactive diluent.

Aspect 59. A method of forming a polymer-based portion comprising:
creating a composition by combining the following in weight % (wt %):
   35-60 wt % of a difunctional urethane-acrylate oligomer; and
   40-65 wt % of a reactive diluent; and
curing the composition to form the polymer-based portion,
wherein the polymer-based portion comprising an index of refraction in a range from about 1.48 to about 1.54.

Aspect 60. The method of any one of aspects 57-59, wherein the difunctional urethane-acrylate oligomer comprises a difunctional aliphatic urethane acrylate.

Aspect 61. The method of any one of aspects 57-60, wherein the reactive diluent comprises one or more of biphenylmethyl acrylate, phenol ether acrylate, an alkyl phenol ether acrylate, or isooctyl acrylate.

Aspect 62. The method of any one of aspects 57-61, wherein the reactive diluent comprises a monofunctional acrylate.

Aspect 63. The method of any one of aspects 57-62, wherein the polymer-based portion comprises a glass transition temperature in a range from about −40° C. to about −10° C.

Aspect 64. The method of aspect 63, wherein the glass transition temperature is in a range from about −35° C. to about −20° C.

Aspect 65. The method of any one of aspects 57-64, wherein creating the composition further comprises combining a 0.2-2 wt % of a photo-initiator, and curing the composition comprises irradiating the composition with at least one wavelength of light that the photo-initiator is sensitive to.

Aspect 66. The method of aspect 65, wherein the photo-initiator comprises ethyl (2,4,6-trimethylbenzoyl) phenylphosphinate.

Aspect 67. The method of any one of aspects 57-66, wherein the composition further comprises 1-4.9 wt % of a silane coupling agent.

Aspect 68. The method of aspect 67, wherein the silane coupling agent comprises a mercapto-silane or an acrylate-silane.

Aspect 69. The method of aspect 68, wherein the mercapto-silane comprises 3-mercaptopropyltrimethoxysilane.

Aspect 70. The method of any one of aspects 59-69, wherein the composition is substantially free of a multi-functional monomer.

Aspect 71. The method of any one of aspects 59-70, wherein the composition is substantially free of a thermoplastic elastomer.

Aspect 72. The method of any one of aspects 57-71, wherein the polymer-based portion comprises an average transmittance of about 90% or more measured over optical wavelengths in a range from 400 nanometers to 760 nanometers.

Aspect 73. The method of any one of aspects 57-72, wherein the polymer-based portion comprises a haze of about 0.2% or less.

Aspect 74. The method of any one of aspects 57-73, wherein the index of refraction of the polymer-based portion is in a range from 1.49 to about 1.51.

Aspect 75. The method of any one of aspects 57-74, wherein the polymer-based portion comprises an ultimate elongation of about 100% or more.

Aspect 76. The method of aspect 75, wherein the ultimate elongation is in a range from about 100% to about 250%.

Aspect 77. The method of any one of aspects 57-76, wherein the polymer-based portion comprises a tensile strength in a range from about 0.5 MegaPascals to about 2 MegaPascals.

Aspect 78. The method of any one of aspects 57-77, wherein the polymer-based portion at 23° C. can fully recover after being extended to a strain of 10% at a strain rate of 10% strain per minute.

Aspect 79. The method of any one of aspects 57-78, wherein the polymer-based portion comprises an elastic modulus in a range from about 0.5 MegaPascals to about 10 MegaPascals.

Aspect 80. The method of any one of aspects 56-78, wherein the polymer-based portion comprises an elastic modulus in a range from about 0.8 MegaPascals to about 3 MegaPascals.

Aspect 81. The method of any one of aspects 56-78, wherein the polymer-based portion comprises an elastic modulus in a range from about 100 MegaPascals to about 1,100 MegaPascals.

Aspect 82. The method of aspect 81, wherein the polymer-based portion further comprises silica nanoparticles or alumina nanoparticles.

Aspect 83. The method of any one of aspects 57-81, wherein the polymer-based portion is free of silica nanoparticles and alumina nanoparticles.

Aspect 84. The method of any one of aspects 57-83, wherein the polymer-based portion further comprises a functionalized oligomeric silsesquioxane.

Aspect 85. The method of any one of aspects 57-84, wherein the polymer-based portion can withstand 200,000 bending cycles at a parallel plate distance of 3 millimeters.

Aspect 86. The method of any one of aspects 57-84, wherein the polymer-based portion achieves a parallel plate distance of 10 millimeters.

Aspect 87. The method of any one of aspects 57-86, wherein the polymer-based portion comprises a minimum parallel plate distance in a range from about 2 millimeters to about 10 millimeters.

Throughout the disclosure, the drawings are used to emphasize certain aspects. As such, it should not be assumed that the relative size of different regions, portions, and substrates shown in the drawings are proportional to its actual relative size, unless explicitly indicated otherwise.

### BRIEF DESCRIPTION OF THE DRAWINGS

The above and other features and advantages of aspects of the present disclosure are better understood when the following detailed description is read with reference to the accompanying drawings, in which:

FIG. 1 is a schematic perspective view of an example foldable apparatus in a flat configuration according to aspects, wherein a schematic perspective view of the folded configuration may appear as shown in FIG. 4;

FIGS. 2-3 are cross-sectional views of foldable apparatus along line 2-2 of FIG. 1 according to aspects;

FIG. 4 is a schematic perspective view of an example foldable apparatus in a folded configuration according to aspects, wherein a schematic perspective view of the flat configuration may appear as shown in FIG. 1;

FIG. 5-6 are cross-sectional views of the example foldable apparatus in the folded configuration along line 5-5 of FIG. 4 according to aspects;

FIG. 7 schematic plan view of an example consumer electronic device according to aspects;

FIG. 8 is a schematic perspective view of the example consumer electronic device of FIG. 7;

FIGS. 9-10 are flow charts illustrating example methods making a foldable apparatus in accordance with aspects of the disclosure;

FIGS. 11-17 schematically illustrate steps in methods of making a foldable apparatus;

FIG. 18 is a schematic perspective view of a pen drop apparatus;

FIG. 19 schematically shows a view of a foldable apparatus with a mechanical instability in a folded configuration;

FIG. 20 schematically shows a view of a foldable apparatus with another mechanical instability in a folded configuration; and

FIGS. 21-28 are plots of strain as a function of depth through the thickness of a foldable apparatus.

### DETAILED DESCRIPTION

Aspects will now be described more fully hereinafter with reference to the accompanying drawings in which example aspects are shown. Whenever possible, the same reference numerals are used throughout the drawings to refer to the same or like parts.

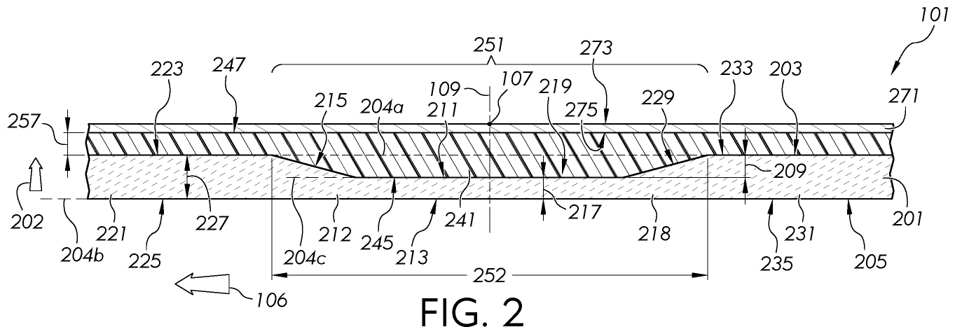

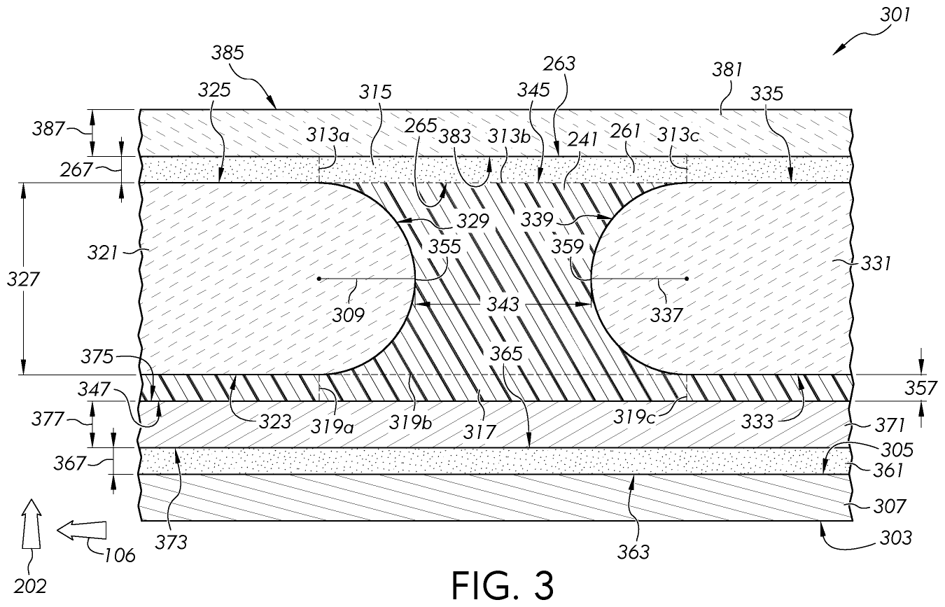

The polymer-based portions of aspects of the disclosure can be used, for example, in a foldable apparatus 101 and/or 301 illustrated in FIGS. 2-3. However, it is to be understood that the polymer-based portions are not limited to such applications and can be used in other applications. Unless otherwise noted, a discussion of features of aspects of one polymer-based portion and/or foldable apparatus can apply equally to corresponding features of any aspect of the disclosure. For example, identical part numbers throughout the disclosure can indicate that, in some aspects, the identified features are identical to one another and that the discussion of the identified feature of one aspect, unless otherwise noted, can apply equally to the identified feature of any other aspect of the disclosure.

Aspects of the disclosure can comprise a polymer-based portion. As shown in FIGS. 2-3, the polymer-based portion 241 can comprise a first contact surface 245 or 345 and a second contact surface 247 or 347 opposite the first contact surface 245 or 347. In aspects, as shown, the first contact surface 245 or 345 can comprise a planar surface. In aspects, as shown in FIG. 3, the second contact surface 247 or 347 can comprise a planar surface. In further aspects, as shown in FIG. 3, the first contact surface 345 can be parallel to the second contact surface 347.

Throughout the disclosure, an index of refraction may be a function of a wavelength of light passing through a material. Throughout the disclosure, for light of a first wavelength, an index of refraction of a material is defined as the ratio between the speed of light in a vacuum and the speed of light in the corresponding material. Without wishing to be bound by theory, an index of refraction of a material can be determined using a ratio of a sine of a first angle to a sine of a second angle, where light of the first wavelength is incident from air on a surface of the material at the first angle and refracts at the surface of the material to propagate light within the material at a second angle. The first angle and the second angle are both measured relative to a direction normal to a surface of the material. As used herein, the index of refraction is measured in accordance with ASTM E1967-19, where the first wavelength comprises 589 nm. In aspects, an index of refraction of the polymer-based portion may be about 1.45 or more, about 1.47 or more, about 1.48 or more, about 1.49 or more, about 1.495 or more, about 1.50 or more, about 1.54 or less, about 1.53 or less, about 1.52 or less, about 1.51 or less, or about 1.505 or less. In aspects, the index of refraction of the polymer-based portion can be in a range from about 1.45 to about 1.54, from about 1.46 to about 1.54, from about 1.46 to about 1.53, from about 1.47 to about 1.53, from about 1.47 to about 1.52, from about 1.48 to about 1.52, from about 1.48 to about 1.51, from about 1.49 to about 1.51, from about 1.49 to about 1.505, from about 1.495 to about 1.505, from about 1.50 to about 1.505, from about 1.49 to about 1.50, from about 1.495 to about 1.50, or any range or subrange therebetween. Providing an index of refraction for the polymer-based portion within one or more of the above-mentioned ranges can reduce an absolute difference of index of refraction between the polymer-based portion and components (e.g., substrate, adhesive, hard-coating) that can be adjacent to the polymer-based portion in an application, which can reduce optical distortions.

As used herein, “optically transparent” or “optically clear” means an average transmittance of 70% or more in the wavelength range of 400 nm to 700 nm through a 1.0 mm thick piece of material, wherein the thickness is measured along the path length of light travelling through the piece of material. As used herein, an average transmittance of a material is measured by averaging over optical wavelengths in a range from 400 nm to 700 nm through a 1.0 mm thick piece of the material, which comprises measuring the transmittance of whole number wavelengths from about 400 nm to about 700 nm and averaging the measurements. Unless specified otherwise, “transmittance” of a material refers to the average transmittance of the material. In aspects, an “optically transparent material” or an “optically clear material” may have an average transmittance of 75% or more, 80% or more, 85% or more, or 90% or more, 92% or more, 94% or more, 96% or more in the wavelength range of 400 nm to 700 nm through a 1.0 mm thick piece of the material. In aspects, the polymer-based portion can be optically transparent. In further aspects, the polymer-based portion can comprise an average transmittance measured over optical wavelengths in a range from 400 nm to 700 nm of about 90% or more, about 91% or more, about 92% or more, about 93% or more, 100% or less, about 96% or less, about 95% or less, or about 94% or less. In further aspects, the polymer-based portion can comprise an average transmittance measured over optical wavelengths in a range from 400 nm to 700 nm in a range from about 90% to 100%, from about 90% to about 96%, from about 91% to about 96%, from about 91% to about 95%, from about 92% to about 95%, from about 92% to about 94%, from about 93% to about 94%, or any range or subrange therebetween.

The polymer-based portion can comprise a haze as a function of an angle of illumination relative to a direction normal to a surface of the polymer-based portion. As used herein, haze refers to transmission haze that is measured in accordance with ASTM E430. Haze can be measured using a haze meter supplied by BYK Gardner under the trademark HAZE-GUARD PLUS, using an aperture over the source port. The aperture has a diameter of 8 mm. A CIE C illuminant is used as the light source for illuminating the foldable apparatus. Unless indicated otherwise, haze is measured at about 100 relative to an angle of incidence normal to a surface of the polymer-based portion. In aspects, the haze at about 0° and/or 100 relative to an angle of incidence normal to the surface of the polymer-based portion measured through a 1.0 millimeter (mm) thick piece of the polymer-based portion can be about 1% or less, about 0.5% or less, about 0.2% or less, about 0.15% or less, about 0.1% or less, or about 0.01% or more, about 0.02% or more, about 0.05% or more, or about 0.08% or more. In aspects, the haze at about 0° and/or 100 relative to an angle of incidence normal to the surface of the polymer-based portion measured through a 1.0 mm thick piece of the polymer-based portion can be in a range from 0% to about 1%, from 0% to 0.5%, from 0% to 0.2%, from about 0.01% to about 0.2%, from about 0.02% to about 0.2%, from about 0.05% to about 0.2%, from about 0.08% to about 0.2%, from about 0.08% to about 0.15%, from about 0.08% to about 0.1%, or any range or subrange therebetween. In aspects, the haze at about 0° and/or 100 relative to an angle of incidence normal to the surface of the polymer-based portion measured through a 1.0 mm thick piece of the polymer-based portion can be in a range from about 0.01% to about 0.15%, from about 0.02% to about 0.15%, from about 0.05% to about 0.15, or any range or subrange therebetween. In aspects, the haze at about 20° relative to an angle of incidence normal to the surface of the polymer-based portion can be within one or more of the ranges specified above for 0° and/or 10°. Providing a polymer-based portion comprising low haze can enable good visibility through the polymer-based portion.

The polymer-based portion can comprise a glass transition (Tg) temperature. As used herein, the glass transition temperature, a storage modulus at a range of temperatures, a storage modulus (e.g., at a glassy plateau), and a loss modulus (e.g., at a glass plateau) are measured using Dynamic Mechanical Analysis (DMA) with an instrument, for example, the DMA 850 from TA Instruments. The samples for the DMA analysis comprise a film secured by a tension clamp. As used herein, the storage modulus refers to the in-phase component of a response of the polymer-based material to the dynamic testing. Throughout the disclosure, the modulus of elasticity of a polymer-based material refers to the storage modulus of the polymer-based material because, without wishing to be bound by theory, the in-phase component of the response is attributed to the elastic portion of a viscoelastic material. As used herein, the loss modulus refers to the out-of-phase component of a response to the polymer-based material during the dynamic testing. Without wishing to be bound by theory, the loss modulus can correspond to the viscous component of a viscoelastic material. As used herein, the glass transition temperature corresponds to a maximum value of a tan delta, which is a ratio of the loss modulus to the storage modulus.

In aspects, the glass transition temperature (Tg) of the polymer-based portion can be about 0° or less, −10° C. or less, about −15° C. or less, about −20° C. or less, about −25° C. or less, about −30° C. or less, about −60° C. or more, about −40° C. or more, or about −35° C. or more. In aspects, the glass transition temperature (Tg) of the polymer-based portion can be in a range from about −60° C. to about 0° C., from about −60° C. to about −10° C., from about −40° C. to about −10° C., from about −40° C. to about −15° C., from about −40° C. to about −20° C., from about −35° C. to about −20° C., from about −35° C. to about −25° C., from about −35° C. to about −30° C., or any range or subrange therebetween. Providing a polymer-based portion with a glass transition temperature outside of an operating range (e.g., from about 0° C. to about 40° C., from about −10° C. to about 60° C.) can enable consistent properties across the operating range.

Throughout the disclosure, a tensile strength, ultimate elongation (e.g., strain at failure), and yield point of the polymer-based portion and elastomers is determined using ASTM D412A using a tensile testing machine, for example, an Instron 3400 or Instron 6800, at 23° C. and 50% relative humidity with a type I dogbone shaped sample. In aspects, a tensile strength of the polymer-based portion can be about 0.3 MPa or more, 0.5 MPa or more, about 0.6 MPa, about 0.7 MPa or more, about 1 MPa or more, about 1.2 MPa or less, about 50 MPa or less, about 10 MPa or less, about 6 MPa or less, about 3 MPa or less, about 2 MPa or less, or about 1.5 MPa or less. In aspects, a tensile strength of the polymer-based portion can be in a range from about 0.3 MPa to about 50 MPa, from about 0.3 MPa to about 10 MPa, from about 0.5 MPa to about 10 MPa, from about 0.5 MPa to about 6 MPa, from about 0.5 MPa to about 3 MPa, from about 0.5 MPa to about 2 MPa, from about 0.5 MPa to about 1.5 MPa, from about 0.6 MPa to about 1.5 MPa, from about 0.7 MPa to about 1.5 MPa, from about 1 MPa to about 1.5 MPa, from about 1.2 MPa to about 1.5 MPa, or any range or subrange therebetween. In aspects, a tensile strength of the polymer-based portion can be from about 0.6 MPa to about 2.0 MPa, 0.7 MPa to about 2 MPa, from about 1.0 MPa to about 2 MPa, or any range or subrange therebetween.

In aspects, an ultimate elongation of the polymer-based portion can be about 10% or more, about 70% or more, about 100% or more, about 105% or more, about 110% or more, about 140% or more, about 500% or less, about 300% or less, about 250% or less, about 220% or less, about 200% or less, about 180% or less, about 160% or less, or about 130% or less. In aspects, an ultimate elongation of the polymer-based portion can be in a range from about 10% to about 500%, from about 70% to about 500%, from about 70% to about 300%, from about 70% to about 250%, from about 100% to about 250%, from about 100% to about 220%, from about 100% to about 200%, from about 105% to about 200%, from about 105% to about 180%, from about 110% to about 180%, from about 110% to about 160%, from about 110% to about 130%, or any range or subrange therebetween. In aspects, an ultimate elongation of the polymer-based portion can be in a range from about 110% to about 200%, from about 140% to about 200%, from about 140% to about 180%, from about 140% to about 160%, or any range or subrange therebetween.

Throughout the disclosure, an elastic modulus of the polymer-based portion and elastomers is measured using ISO 527-1:2019. In aspects, an elastic modulus of the polymer-based portion can be about 0.5 MPa or more, about 0.8 MPa or more, about 0.9 MPa or more, about 1.1 MPa or more, about 1.3 MPa or more, about 50 MPa or less, about 15 MPa or less, about 10 MPa or less, about 5 MPa or less, about 3 MPa or less, about 2 MPa or less, or about 1.5 MPa or less. In aspects, an elastic modulus of the polymer-based portion can be in a range from about 0.5 MPa to about 50 MPa, from about 0.5 MPa to about 15 MPa, from about 0.5 MPa to about 10 MPa, from about 0.5 MPa to about 5 MPa, from about 0.6 MPa to about 5 MPa, from about 0.7 MPa to about 5 MPa, from about 0.7 MPa to about 3 MPa, from about 0.9 MPa to about 3 MPa, from about 0.9 MPa to about 2.5 MPa, from about 1.1 MPa to about 2.5 MPa, from about 1.1 MPa to about 2 MPa, from about 1.3 MPa to about 2 MPa, from about 1.5 MPa to about 2 MPa, or any range or subrange therebetween.

Throughout the disclosure, tension set of a sample is measured using ASTM D-412 as the strain at zero stress after the sample is stretched to a specified strain. In aspects, the polymer-based portion can comprise a tension set after being extended to a strain of 10% at a strain rate of 10% strain per minute at 23° C. In further aspects, the tension set can be about 2% or less, about 1% or less, about 0.5% or less, or 0% or more. In further aspects, the tension set can be in a range from 0% to about 2%, from 0% to about 1%, from 0% to about 0.5%, or any range or subrange therebetween. In further aspects, the polymer-based portion can fully recover after being extended to a strain of 10% at a strain rate of 10% strain per minute at 23° C. In aspects, the polymer-based portion can fully recover after being extended to a strain of 10% at a strain rate of 10% strain per minute at 0° C. In aspects, the polymer-based portion can comprise a tension set after 200 cycles extending the polymer-based portion to a strain of 10% at a strain rate of 10% strain per minute at 23° C. In further aspects, the tension set can be about 2% or less, about 1% or less, about 0.5% or less, or 0% or more. In further aspects, the tension set can be in a range from 0% to about 2%, from 0% to about 1%, from 0% to about 0.5%, or any range or subrange therebetween.

The polymer-based portion described above can be formed as the product of curing a composition. Methods of forming the polymer-based portion described above will now be described.

Methods of forming the polymer-based portion can comprise creating a composition. The composition can comprise a difunctional urethane-acrylate oligomer. In aspects, the difunctional urethane-acrylate oligomer can comprise one or more of the following products in the Miramer product line available from Miwon: PU210, PU256, PU2050, PU2100, PU2300C, PU2560, PU320, PU340, PU3000, PU3200, PU340, PU5000, PU610, PU6510, PU9500, PU9800, PUA2516, SC2100, SC2404, SC2565, and/or SC9211. In aspects, the difunctional urethane-acrylate oligomer can comprise one or more of the following products in the Photomer product line available from IGM Resins: 6009, 6210, 6230, 6620, 6630, 6638, 6643, 6645, 6891, 6582, and/or 6581. In aspects, the difunctional urethane-acrylate oligomer can comprise the following products available from Arkema (Sartomer): PR013944, PR014213, CN8881, CN90004, CN9009, CN9030, CN9031, CN964, CN966J75, CN981, CN991, and/or CN 96. In aspects, the difunctional urethane-acrylate oligomer can comprise the following products from Dymax (Bomar): BR343, CR-344, BR-345, BR-374, BR-3042, BR-3641AA, BR-3641AJ, BR-3741AJ, BR-3741-AJ, BR-3747AE, BR-541S, BR-543, BR-543TF, BR-571, BR-582E8, BR-641E, BR-744BT, BR-744SD, and/or BR-771F. In aspects, the difunctional urethane-acrylate oligomer can comprise a polyether urethane acrylate. In aspects, the difunctional urethane-acrylate oligomer can comprise difunctional aliphatic urethane acrylate. An exemplary aspect of a difunctional urethane-acrylate oligomer is BR-543 (Dymax/Bomar).

In aspects, the difunctional urethane-acrylate oligomer can comprise a glass transition temperature within one or more of the ranges discussed above for the polymer-based portion. In aspects, the difunctional urethane-acrylate oligomer can comprise a glass transition temperature less than the glass transition temperature of the resulting polymer-based portion. In aspects, the difunctional urethane-acrylate oligomer can comprise a glass transition temperature in a range from about −60° C. to about −30° C., from about −50° C. to about −30°, from about −50° C. to about −40° C. From example, difunctional urethane-acrylate oligomers available from Dymax (Bromar) with a glass transition temperature in a range from −50° C. to −30° C. include BR343, CR-344, BR-345, BR-374, BR-3042, BR-3641AA, BR-3641AJ, BR-3741AJ, and BR-3747AE.

In aspects, the composition can comprise a difunctional urethane-acrylate oligomer in a weight % (wt %) of about 20 wt % or more, 35 wt % or more, about 40% or more, about 45 wt % or more, about 70 wt % or less, about 60 wt % or less, about 55 wt % or less, or about 50 wt % or less. In aspects, the composition can comprise a difunctional urethane-acrylate oligomer in a weight % (wt %) ranging from about 20 wt % to about 70 wt %, from about 35 wt % to about 70 wt %, from about 35 wt % to about 60 wt %, from about 40 wt % to about 60 wt %, from about 40 wt % to about 55 wt %, from about 45 wt % to about 55 wt %, from about 45 wt % to about 50 wt %, from about 35 wt % to about 45 wt %, or any range or subrange therebetween.

In aspects, the composition can comprise a reactive diluent. As used herein, a reactive diluent is a monofunctional compound that can decrease the viscosity of the composition and decrease a cross-linking density of the polymer-based portion. Without wishing to be bound by theory, decreasing the cross-linking density of the polymer-based portion can decrease the glass transition temperature of the polymer-based portion. In aspects, the reactive diluent can comprise a monofunctional acrylate. In further aspects, the reactive diluent comprising a monofunctional acrylate can include isobornyl acrylate (e.g., Miramer 1140 (Miwon), Photomer 4012 (IGM Resins)), biphenyl-methyl acrylate (e.g., Miramer 1192 (Miwon)), 2-propyl-heptyl acrylate, butyl acrylate, biphenyl methyl acrylate, nonyl phenol acrylates (e.g., Miramer 164 (Miwon), Miramer 166 (Miwon)), ethoxy ethyl acrylate (e.g., Miramer 170 (Miwon)), isooctyl acrylate (e.g., Miramer 1084 (Miwon)), 2-[(butylamino)carbonyl-oxy-ethyl]acrylate (e.g., Photomer 4184 (IGM Resins)), and/or a phenol ether acrylate (e.g., Miramer 144 (Miwon)). In further aspects, the reactive diluent can comprise a monofunctional acrylate (e.g., mono-acrylate monomer). In further aspects, the reactive diluent can comprise a vinyl-terminated mono-acrylate monomer. Exemplary aspects of the reactive diluent include biphenylmethyl acrylate, nonyl phenol acrylate, 2-[(butylamino)carbonyl-oxy-ethyl]acrylate, and/or isooctyl acrylate. In aspects, the reactive diluent can comprise 2 or more, 3 or more, or 4 or more different compounds (e.g., a phenol ether acrylate, isooctyl acrylate, biphenylmethyl acrylate, and/or a nonyl phenyl ether acrylate) that are each reactive diluents. In aspects, the reactive diluent can comprise one or more of biphenylmethyl acrylate, phenol ether acrylate, an alkyl phenol ether acrylate, or isooctyl acrylate.

In aspects, the composition can comprise a reactive diluent in combination with a difunctional urethane-acrylate oligomer and a difunctional cross-linking agent. In further aspects, the composition can comprise the reactive diluent in a weight % (wt %) of about 5 wt % or more, about 35 wt % or more, about 40 wt % or more, about 45 wt % or more, about 50 wt % or less, about 70 wt % or less, about 65 wt % or less, about 60 wt % or less, or about 55 wt % or less. In further aspects, the composition can comprise the reactive diluent in a weight % (wt %) ranging from about 5 wt % to about 70 wt %, from about 35 wt % to about 70 wt %, from about 35 wt % to about 65 wt %, from about 40 wt % to about 65 wt %. In further aspects, the composition can comprise the reactive diluent in a weight % (wt %) ranging from about 35 wt % about 60 wt %, from about 40 wt % to about 60 wt %, from about 45 wt % to about 55 wt %, from about 50 wt % to about 55 wt %, from about 45 wt % to about 50 wt %, or any range or subrange therebetween.

In aspects, the composition can comprise both the reactive diluent and the difunctional urethane-acrylate oligomer such that a ratio can be defined as the amount (in wt %) of the difunctional urethane-acrylate oligomer to the amount (in wt %) of the reactive diluent. In further aspects, the ratio of the amount (in wt %) of the difunctional urethane-acrylate oligomer to an amount (in wt %) of the reactive diluent can be about 0.4 or more, about 0.5 or more, about 0.6 or more, about 0.8 or more, about 0.9 or less, about 1.5 or less, about 1.2 or less, about 1.1 or less, or about 0.7 or less. In further aspects, the ratio of the amount (in wt %) of the difunctional urethane-acrylate oligomer to an amount (in wt %) of the reactive diluent can be in a range from about 0.4 to about 1.5, from about 0.5 to about 1.5, from about 0.6 to about 1.5, from about 0.8 to about 1.5, from about 0.8 to about 1.2, from about 0.9 to about 1.1, or any range of subrange therebetween. In further aspects, the ratio of the amount (in wt %) of the difunctional urethane-acrylate oligomer to an amount (in wt %) of the reactive diluent can be in a range from about 0.5 to about 1.2, from about 0.5 to about 1.1, from about 0.5 to about 0.7, from about 0.6 to about 0.7, or any range or subrange therebetween.

In aspects, the composition can comprise a silane coupling agent. In further aspects, the silane coupling agent can comprise a mercapto-silane and/or an acrylate-silane. In even further aspects, the silane coupling agent can comprise 3-mercaptopropylmethyldimethoxysilane (e.g., SIM6474.0 (Gelest), 3-mercaptopropyltrimethoxysilane (e.g., SIM6476.0 (Gelest)), 3-mercaptopropylmethyldiethoxysilane, 3-mercaptopropyltriethoxysilane (e.g., SIM6475.0 (Gelest)), 11-mercaptoundecyltrimethoxysilane (e.g., SIM6480.0 (Gelest)), (mercaptomethyl)methyldiethoxysilane (e.g., SIM6473.0 (Gelest)), and/or 3-mercaptopropylmethyldimethoxysilane (e.g., SIM6474.0 (Gelest)). In even further aspects, the silane coupling agent can comprise 3-acryloxypropyltrimethoxysilane (e.g., SIA0200.0 (Gelest)), 3-acryloxypropyltriethoxysilane, 3-arcyloxypropyldimethylmethoxysilane (e.g., SIA0190.0 (Gelest)), 3-acryloxyproplydimethylethoxysilane, 3-acryloxypropylmethyldiethoxysilane (e.g., SIA0197.0 (Gelest)), 3-acryloxypropylmethyldimethoxysilane (e.g., SIA0198.0 (Gelest)), N-(3-acryloxy-2-hydroxypropyl)-3-aminopropyltrimethoxysilane, N-(3-acryloxy-2-hydroxypropyl)-3-aminopropyltriethoxysilane (e.g., SIA0180.0 (Gelest)), acryloxymethyltrimethoxysilane (e.g., SIA0182.0 (Gelest)), acryloxymethyltriethoxysilane, acryloxymethylphenethyltrimethoxysilane (e.g., SIA0184.0 (Gelest), and acryloxymethylphenethyltriethoxysilane. An exemplary aspect of the silane coupling agent comprises 3-mercaptopropyltrimethoxysilane.

In further aspects, the composition can comprise the silane coupling agent in a weight % (wt %) of about 0.1 wt % or more, about 0.2 wt % or more, about 0.5 wt % or more, about 4.9 wt % or less, about 2 wt % or less, or about 1 wt % or less. In further aspects, the composition can comprise the silane coupling agent in a weight % (wt %) ranging from about 0.1 wt % to about 4.9 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween. Providing a silane coupling agent can increase adhesion of the polymer-based portion to a substrate (e.g., glass-based substrate, ceramic-based substrate, the rest of a foldable apparatus) and improve the durability of the polymer-based portion and/or foldable apparatus.

In aspects, the composition can comprise a photo-initiator. As used herein a photo-initiator is a compound sensitive to one or more wavelengths that upon absorbing light comprising the one or more wavelengths undergoes a reaction to produce one or more radicals or ionic species that can initiate a polymerization reaction. In further aspects, the photo-initiator may be sensitive to one or more wavelengths of ultraviolet (UV) light. Example aspects of photoinitiators sensitive to UV light include without limitation benzoin ethers, benzil ketals, dialkoxyacetophenones, hydroxyalkylphenones, aminoalkylphenones, acylphosphine oxides, thioxanthones, hydroxyalkylketones, and thoxanthanamines. In further aspects, the photoinitiator may be sensitive to one or more wavelengths of visible light. Example aspects of photoinitiators sensitive to visible light include without limitation 5,7-diiodo-3-butoxy-6-fluorone, bis(4-methoxybenzoyl) diethylgermanium, bis(2,4,6-trimethylbenzoyl)-phenylphosphineoxide, 3-methyl-4-aza-6-helicene, and thiocyanide borates. In further aspects, the photoinitiator may be sensitive to a wavelength that other components of the polymer-based portion and/or composition are substantially transparent at. As used herein, a compound (e.g., component of the composition) is substantially transparent at a predetermined wavelength if it comprises an average transmittance of 75% or more (e.g., 80% or more, 85% or more, or 90% or more, 92% or more, 94% or more, 96% or more) through a 1.0 mm thick piece of the compound at the predetermined wavelength. Providing a photo-initiator can enable controlled activation of curing of the composition. Providing a photo-initiator can enable uniform curing of the composition.

In further aspects, the photo-initiator may produce one or more ions. Example aspects of photoinitiators producing one or more ions include without limitation triarylsulfonium hexfluoroantimonate, triphenylsulfonium hexafluoroantimonate, and bis(4-tert-butylphenyl)iodonium perfluoro-1-butanesulfonate. Commercially available photoinitiators include without limitation the Irgacure product line from Ciba Specialty Chemical. Exemplary aspects of photoinitiators include acetophenone-based compounds, for example, dimethoxyphenyl acetophenone. In further aspects, the photo-initiator may produce one or more radicals (e.g., free radicals). Example aspects of photo-initiators producing one or more radicals include acetophenone, anisoin, anthraquinone, benzene, benzil, benzoin, benzoin ethyl ether, benzoin isobutyl ether, benzoin methyl ether, benzophenone, hydroxycyclohexyl phenyl ketone, 4-benzoylbiphernyl, camphorquinone, 2-chlorothioxanthen-9-one, bibezosuberenone, 2-,2-diethyoxyacetophenone, dimethylbenzil, ferrocene, ethylanthraquinone, hydroxyacetophenone, hydroxybenzophenone, thioxanthene-9-one, diphenyl(2,4,6-trimethylbenzoyl)phosphine oxide, and phophineoxide. In even further aspects, the photo-initiator can comprise ethyl (2,4,6-trimethylbenzoyl) phenylphosphinate.

In aspects, the composition can comprise the photo-initiator in a weight % (wt %) of about 0.1 wt % or more, about 0.2 wt % or more, about 0.5 wt % or more, about 3 wt % or less, about 2 wt % or less, or about 1 wt % or less. In aspects, the composition can comprise the silane coupling agent in a weight % (wt %) ranging from about 0.1 wt % to about 3 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween.

In aspects, the polymer-based portion and/or composition can comprise a catalyst. Without wishing to be bound by theory, a catalyst can increase a rate of the curing (e.g., polymerization, reaction), and the catalyst may avoid permanent chemical change as a result of the curing. In aspects, the catalyst can comprise one or more platinum group metals, for example, ruthenium, rhodium, palladium, osmium, iridium, and/or platinum. In aspects, the catalyst can comprise a platinum-based Karstedt's catalyst solution. Exemplary aspects of platinum-based catalysts include chloroplatinic acid, platinum-fumarate, colloidal platinum, metallic platinum, and/or platinum-nickel nanoparticles.

In aspects, the polymer-based portion and/or composition can comprise an antioxidant. In further aspects, the antioxidant can comprise a phenolic-based compound or a phosphite-based compound. Exemplary aspects of antioxidants comprising phenolic-based compounds available include pentaerythritol tetrakis(3-(3,5-di-tert-butyl-4-hydroxyphenyl)propionate (e.g., Irganox 1010 (BASF)), thiodiethylene bis[3-(3,5-di-ter-butyl-4-hydroxy-phenyl)]propionate (e.g., Irganox 1035 (BASF)), octadecyl-3-(3,5-di-tert-butyl-4-hydroxyphenyl)propionate (e.g., Irganox 1076 (BASF)), benzenepropanoic acid (e.g., Irganox 1135 (BASF)), 3,3′,3′,5,5′,5′-hexa-tert-butyl-a,a′,a′-(mesitylene-2,4,6-triyl)tri-p-cresol (e.g., Irganox 1330 (BASF)), (1,1-di-tert-butyl)-4-hydroxyphenyl)methyl)ethylphosphonate (e.g., Irganox 1425 (BASF)), 4,6-bis[octylthiomethyl]-o-crsol (e.g., Irganox 1520 (BASF)), 1,3,5-tris[3,5-di-tert-butyl-4-hydroxybenzyl)-1,3,5-triazine-2,4,5(1H,3H,5H)-trione (e.g., Irganox 3114 (BASF)), 2,6-di-tert-butyl-4-(4,6-bis(octothiol)-1,3,5-triazin-2-ylamino)phenol (e.g., Irganox 565 (BASF)), and 2′,3-bis[3-(3,5-di-tert-butyl-4-hydroxyphenyl)propionyl]propionohydrazine (e.g., Irganox MD-1024 (BASF)). Exemplary aspects of antioxidants comprising phosphite-based compounds include 2,2′,2″-nitrolo(triethyl-tris[3,3′, 5,5′-terta-tert-butyl-1,1′-biphenyl-2,2′-diyl])phosphile (e.g., Irgafos 12 BASF), bis[2,4-di-tert-butylphenol]pentaerythritol diphosphate (e.g., Irgafos 126 (BASF), tris[2,4-ditert-butylphenyl]phosphite (e.g., Irgafos 168 (BASF)), bis[2,4-di-tert-butyl-6-methylphenyl]-ethyl-phosphite (e.g., Irgafos 38 (BASF)), trisnonylphenyl phosphite (e.g., Weston 399 (Addivant)), 3,9-bis(octadecyloxy)-2,4,8,10-tetraoxa-3,9-diphosphaspiroundecane (e.g., Weston 618 (Addivant)) [1,3,2-dioxaphosphorinane, 5-butyl-5-ethyle-2-(2,4,6-tris[1,1-dimethylethyl]phenoxy)-1,3,2-dioxaphosphinane](e.g., Ultranox 641 (SI Group)), 2,2′-ethyidene-bis[4,6-di-tert-butylphenyl]fluorophosphate (e.g., Ethenox 398 (SI Group)), and 2,2′-Methylene-bis[4,6-di-tert-butylphenyl]-2-ethylhexyl phosphite (e.g., ADK STAB HP-10 (Adeka)). In further aspects, an amount of the antioxidant can be about 0.01 wt % or more, about 0.1 wt % or more, about 0.2 wt % or more, about 0.5 wt % or less, about 0.4 wt % or less, or about 0.3 wt % or less. In further aspects, an amount of the antioxidant can be in a range from about 0.01 wt % to about 0.5 wt %, from about 0.1 wt % to about 0.5 wt %, from about 0.1 wt % to about 0.4 wt %, from about 0.2 wt % to about 0.3 wt %, or any range or subrange therebetween. In further aspects, an amount of the antioxidant can be in a range from about 0.01 wt % to about 0.3 wt %, from about 0.01 wt % to about 0.2 wt %, or any range or subrange therebetween. Providing an antioxidant can improve a color of the polymer-based portion and/or foldable apparatus, for example by decreasing yellowing as the polymer-based portion and/or foldable apparatus.

In aspects, the composition and/or the polymer-based portion can be substantially free of a multi-functional monomer. As used herein, “multi-functional monomer” means a compound comprising two or more reactive functional groups that is not part of an oligomer. In further aspects, the composition and/or the polymer-based can be free of a multi-functional monomer. Providing a composition that is substantially free of a multi-functional monomer can enable a lower elastic modulus and/or greater adhesion of the resulting polymer-based portion, which can improve foldability of a foldable apparatus with the polymer-based portion, for example, by decreasing a cross-linking density. In aspects, the composition and/or the polymer-based portion can be substantially free of fluorine-based compounds. As used herein, the composition and/or the polymer-based portion can be substantially free of fluorine-based compounds while containing a trace amount of fluorine in a minor component (e.g., about 2 wt % or less of a photoinitiator) of the composition corresponding to an overall wt % of fluorine of about 0.25 wt % or less. In further aspects, the polymer-based portion and/or composition can be free of fluorine-based compounds.

In aspects, the composition can be substantially free and/or free of functionalized oligomeric silsesquioxanes. Providing a composition free of functionalized oligomeric silsesquioxanes can decrease a cost to produce the composition and/or resulting polymer-based portion, increase a flexibility of the resulting polymer-based portion, and/or increase an adhesion of the resulting polymer-based portion. In aspects, the composition can comprise functionalized oligomeric silsesquioxanes. Providing a composition comprising functionalized oligomeric silsesquioxanes can increase a hardness and/or impact resistance of the resulting polymer-based portion. As used herein a functionalized oligomeric silsesquioxane means an organosilicon compound comprises at least two monomers represented as RSiO_{1.5}, where there are three oxygen atoms with each oxygen atom shared with another monomer bonded thereto and R is a functional group that “functionalizes” an oligomeric silsesquioxane to form the functionalized oligomeric silsesquioxane, although the R of one monomer need not be the same as the R of another monomer. In aspects, a number of the RSiO_{1.5} monomers in the functionalized oligomeric silsesquioxane can be a whole number of 4 or more, 6 or more, 8 or more, 50 or less, 30 or less, 20 or less, 16 or less, about 12 or less, or 10 or less. In aspects, a number of the RSiO_{1.5} monomers in the functionalized oligomeric silsesquioxane can be a whole number in a range from 4 to 50, 4 to 30, 4 to 20, 6 to 20, 6 to 16, 6 to 12, 8 to 12, 8 to 10, or any range or subrange therebetween.

In aspects, the functionalized oligomeric silsesquioxane can further comprise any number of RSiO₂ monomers in addition to the RSiO_{1.5} monomeric units discussed above, where again the R can vary between monomers of either or both the RSiO₂ monomers and RSiO_{1.5} monomers. In further aspects, a RSiO₂ monomer can be a terminal monomer, meaning that it is connected to only one other monomer. For simplicity, these “terminal monomers” will be referred to as RSiO₂ with the understanding that terminal RSiO₂ monomers can refer to either RSiO_{3.5}, RSiO_{2.5}, R₂SiO_{2.5}, R₂SiO_{2.5}, R₂SiO_{1.5}, R₃SiO_{3.5}, R₃SiO_{2.5}, R₃SiO_{1.5}, or R₃SiO_{0.5}, where a first R of a single terminal monomer can be the same or different another (e.g., one, all) R of the same single terminal monomer. In further aspects, a RSiO₂ monomer can be bonded to two other monomers. For example, a RSiO₂ monomer can be bonded to another RSiO₂ and a RSiO_{1.5} monomer or two RSiO_{1.5} monomers. For simplicity, “non-terminal RSiO₂ monomers” can refer to either RSiO₃, RSiO₂, R₂SiO₃, or R₂SiO₂, where a first R of a single “non-terminal RSiO₂” monomer can be the same or different another (e.g., one, all) R of the same single “non-terminal RSiO₂ monomer.” In further aspects, the number of RSiO₂ monomers can be less than or equal to the number of RSiO_{1.5} monomers. For example, when the number of RSiO₂ monomers is 4 and the number of the RSiO_{1.5} monomers is 4 or more, a ladder-type functionalized oligomeric silsesquioxane can be formed, where each of the RSiO_{1.5} monomers is connected to two other RSiO_{1.5} monomers and either a RSiO_{1.5} monomer or a RSiO₂ monomer. In even further aspects, a reactant can comprise a ladder-type functionalized oligomeric silsesquioxanes.

In further aspects, the functionalized oligomeric silsesquioxane can comprise from 1 to 3 of RSiO₂ monomers (e.g., 1, 2, 3). In even further aspects, an adjacent pair of RSiO_{1.5} monomers can be connected to each other by two or more non-overlapping paths, where each path comprises at least one monomer other than the adjacent pair of RSiO_{1.5} monomers and the first path is connected to the second path without passing through the adjacent pair of monomers. For example, an open-cage functionalized oligomer silsesquioxane can comprise the adjacent pair of RSiO_{1.5} monomers connected to each other by two or more non-overlapping paths and the first path is connected to the second path without passing through the adjacent pair of monomers while also comprising from 1 to 3 of RSiO₂ monomers. In even further aspects, a reactant can comprise an open-cage functionalized oligomer silsesquioxane. In aspects, the functionalized oligomeric silsesquioxane can consist of RSiO_{1.5} monomers. As used herein, a polyhedral oligomeric silsesquioxane (POSS) refers to a functionalized oligomer silsesquioxane consisting of RSiO_{1.5} monomers. Exemplary aspects of functionalized POSS can comprise 6, 8, 10, or 12 RSiO_{1.5} monomers, although other aspects are possible. For example, functionalized oligomeric silsesquioxane consisting of 8 RSiO_{1.5} monomers is an octahedral functionalized POSS (e.g., polyoctahedral silsesquioxane). In aspects, functionalized oligomeric silsesquioxanes can be formed from condensation reactions of silane. As used herein a condensation reaction produces an R₂O byproduct, where R can include any of the R units discussed below and can further comprise hydrogen (e.g., with a hydroxyl or water byproduct). For example, silanes (e.g., R₃OSi) can be reacted to form terminal RSiO₂ monomers. For example, a terminal RSiO₂ monomer can react with another RSiO₂ monomer (e.g., terminal, non-terminal) to form an RSiO_{1.5} monomer as an oxygen atom of one monomer forms a bond with a silicon atom of another monomer, producing the condensation byproduct. It is to be understood that the RSiO_{1.5} silsesquioxane monomers are different from siloxane monomers, which can include M-type siloxane monomers (e.g., R₃SiO_{1.5}), D-type siloxane monomers (e.g., R₂SiO₂), and/or silica-type siloxane monomers (SiO₂).

Functionalized oligomeric silsesquioxanes can be functionalized by one or more functional groups. As used herein, a functional group functionalizing the functionalized oligomeric silsesquioxane can exclude hydrogen, bisphenols, and/or fluorine-containing functional groups. In aspects, the functional group functionalizing the functionalized oligomeric silsesquioxane can exclude isocyanates, alkenes, and/or alkynes. In aspects, a functional group for the functionalized oligomeric silsesquioxane can comprise epoxies, glycidyls, acrylates, and methacrylates. In further aspects, the functional group for the functionalized oligomeric silsesquioxane can be a glycidyl functional group, an epoxycyclohexyl functional group, or a methacrylate functional group. Throughout the disclosure, a functionalized POSS that is functionalized by a glycidyl group is referred to as GPOSS. Exemplary aspects of glycidyl functional groups include amine glycidyls, alkyl glycidyls (e.g., glycidylpropyl), ether glycidyls (e.g., glycidyloxy), siloxane glycidyls (e.g., glycidyldimethyoxy), and combinations thereof (e.g., glycidyloxypropyl, glycidyloxypropyldimethylsiloxy). Commercially available examples of GPOSS include 3-glycidyloxypropyl functionalized POSS (e.g., EP0408 (Hybrid Plastics), EP0409 (Hybrid Plastics)), 3-glycidylpropoxy functionalized POSS (e.g., 560624 (Sigma Aldrich)), and 3-glycidyloxypropyldimethysiloxy (e.g., 593869 (Sigma Aldrich)). Exemplary aspects of epoxy functional groups include epoxy, alkyl epoxy (e.g., epoxyethyl, epoxypropyl), and cycloalkyl epoxy (e.g., epoxycyclohexyl). A commercially available example of epoxy functionalized POSS includes (3,4, epoxycyclohexyl)ethyl functionalized POSS (e.g., 560316 (Sigma Aldrich)). Example aspects of acrylates include acrylate, alkyl acrylates (e.g., acrylopropyl, acryloisobutyl), and cycloalkyl acrylates (acrylocyclohexyl). Commercially available examples of acylate functionalized POSS include acrylopropyl functionalized POSS (e.g., MA0736 (Hybrid Polymers) and acryloisobutyl functionalized POSS (e.g., MA0701 (Hybrid Polymers)). Example aspects of methacrylates include methacrylate, alkyl methacrylates (e.g., methacrylomethyl, methacrylopropyl), cycloalkyl methacrylates (e.g., methacrylocyclopentyl), and combinations thereof (e.g., (propylmethacryl)cyclopentyl). Commercially available examples of methacrylate functionalized POSS include methylmethacrylate functionalized POSS (e.g., MA0706 (Hybrid Polymers), MA0716 (Hybrid Polymers), MA0718 (Hybrid Polymers)), methacrylopropyl functionalized POSS (e.g., 534633 (Sigma Aldrich), MA0702 (Hybrid Polymers), MA0735 (Hybrid Polymers), MA0719 (Hybrid Polymers)), and (propylmethacryl)cyclopentyl functionalized POSS (e.g., 560340 (Sigma Aldrich). A functionalized POSS can be cross-linked with a difunctional polymer before being added to the composition. For example, the difunctional polymer can comprise poly(propylene oxide) or poly(dimethyl siloxane) that can be functionalized by an amine functional group.

In aspects, the composition can comprise the functionalized oligomeric silsesquioxanes in an amount of about 20 wt % or more, about 25 wt % or more, about 30 wt % or more, about 50 wt % or less, about 45 wt % or less, or about 35 wt % or less. In aspects, the composition can comprise the functionalized oligomeric silsesquioxanes in a range from about 20 wt % to about 50 wt %, from about 25 wt % to about 50 wt %, from about 25 wt % to about 45 wt %, from about 30 wt % to about 45 wt %, from about 30 wt % to about 40 wt %, from about 35 wt % to about 40 wt %, or any range or subrange therebetween. In aspects, the composition can comprise functionalized oligomeric silsesquioxanes in a range from about 20 wt % to about 45 wt %, from about 20 wt % to about 40 wt %, from about 25 wt % to about 40 wt %, from about 30 wt % to about 50 wt %, or any range or subrange therebetween. Providing functionalized oligomeric silsesquioxanes can increase a hardness and/or an impact resistance of the coated article.

In aspects, the composition can be substantially free of silica nanoparticles. As used herein, the composition is substantially free of silica nanoparticles if an amount of silica nanoparticles is about 1 wt % or less. In further aspects, the composition can be free of silica nanoparticles. As used herein, silica nanoparticles refer to particles comprising an effective diameter of at least 20 nm and comprise silica. Silica nanoparticles can comprise solid particles or mesoporous particles. Silica nanoparticles can be larger (e.g., comprise a larger effective diameter) than a functionalized oligomeric silsesquioxane of the plurality of functionalized oligomeric silsesquioxanes. Silica nanoparticles can be formed from colloidal silica and/or via a sol-gel method. Without wishing to be bound by theory, silica nanoparticles can aggregate, especially at elevated temperature, impairing mechanical and/or optical properties of the composition or resulting coating and/or coated article. Providing a composition substantially free and/or free of silica nanoparticles can reduce processing issues (e.g., agglomeration, aggregation, phase separation) with the composition, improve optical properties (e.g., maintain low haze and/or high transmittance even after aging at elevated temperature and/or humidity) of the coating and/or the resulting coating and/or coated article, and reduce mechanical properties (e.g., hardness, modulus, strain) of the resulting coating and/or coated article compared to a corresponding composition, coating, and/or coated article comprising a plurality of functionalized oligomeric silsesquioxanes without silica nanoparticles.

In aspects, the composition can comprise silica nanoparticles and/or alumina nanoparticles. In further aspects, a wt % of the silica nanoparticles and/or alumina nanoparticles in the composition can be about 5% or more, about 10% or more, about 15% or more, about 50% or less, about 40% or less, about 30% or less, or about 20% or less. In further aspects, a wt % of the linker (e.g., plurality of linkers) to a total weight of the plurality of functionalized oligomeric silsesquioxanes and the linker can be in a range from about 5% to about 50%, from about 5% to about 40%, from about 10% to about 40%, from about 10% to about 30%, from about 15% to about 30%, from about 15% to about 20%, or any range or subrange therebetween. In further aspects, a mean effective diameter of the silica nanoparticles and/or alumina nanoparticles can be about 20 nm or more, about 30 nm or more, about 100 nm or less, or about 50 nm or less. In further aspects, a mean effective diameter in a range from about 20 nm to about 100 nm, from about 20 nm to about 50 nm, from about 30 nm to about 50 nm, or any range or subrange therebetween. In further aspects, the silica nanoparticles and/or the alumina nanoparticles may not be bonded to a functionalized oligomeric silsesquioxane of the plurality of functionalized oligomeric silsesquioxane in the composition. Providing nanoparticles can increase a hardness and/or an impact resistance of the coated article.

In aspects, the composition can be substantially free and/or free of an elastomer (e.g., thermoplastic elastomer). In aspects, the composition can comprise an elastomer. In aspects, the composition can comprise a thermoplastic elastomer, for example, a thermoplastic polyurethane, a thermoplastic polyamide, poly(dichlorophosphazene), a silicone-based rubber, and/or block copolymers. In aspects, the composition can comprise a block copolymer. Exemplary aspects of block-copolymers include high-impact polystyrene, styrene-butadiene block copolymer, and styrene-ethylene-butylene-styrene block copolymer (e.g., Kraton G1650 (Kraton)). In aspects, the composition can comprise an elastomer in a weight % (wt %) of about 0.1 wt % or more, about 0.2 wt %, about 0.5 wt % or more, about 5 wt % or less, about 2 wt % or less, or about 1 wt % or less. In aspects, the composition can comprise the elastomer in a weight % (wt %) ranging from about 0.1 wt % to about 5 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween. Providing an elastomeric polymer-based portion can enable the polymer-based portion to recover (e.g., fully recover) from folding-induced strains and/or impact-induced strains, which can decrease fatigue of the polymer-based portion from repeated folding, enable a low force to achieve a given parallel plate distance, and enable good impact and/or good puncture resistance.

In aspects, the composition can be substantially solvent-free. In further aspects, the composition can be solvent-free. In even further aspects, the composition can be entirely solvent-free. As used herein, a composition is entirely solvent-free if it only contains components that participate in the curing reaction and/or are considered a photo-initiator, or a catalyst based on the above discussion. As used herein, a composition is solvent-free if it contains 99.5 wt % or more components that participate in the curing reaction and/or are considered a photo-initiator, or a catalyst based on the above discussion. As used herein a composition is substantially solvent-free if it contains 98 wt % or more components that participate in the curing reaction and/or are considered a photo-initiator, or a catalyst based on the above discussion. For example, water and octanol are considered solvents. Solvents can comprise one or more of a polar solvent (e.g., water, an alcohol, an acetate, acetone, formic acid, dimethylformamide, acetonitrile, dimethyl sulfoxone, nitromethane, propylene carbonate, poly(ether ether ketone)) or a non-polar solvent (e.g., pentane, 1,4-dioxane, chloroform, dichloromethane, diethyl ether, hexane, heptane, benzene, toluene, xylene). For example, a composition comprising up to 0.5 wt % solvent is considered to be both substantially solvent-free and solvent-free. Likewise, a composition containing no solvent is considered to be substantially solvent-free, solvent-free, and entirely solvent-free. Providing a composition that is substantially solvent-free (e.g., entirely solvent-free) can increase the curing rate of the composition, which can decrease processing time. Providing a composition that is substantially solvent-free (e.g., entirely solvent-free) can reduce (e.g., decrease, eliminate) the use of additives, for example, rheology modifiers, and increase composition homogeneity, which can improve the quality of the resulting polymer-based portion (e.g., increased transmittance, decreased haze, increased mechanical properties). In aspects, the composition can comprise the photo-initiator in a weight % (wt %) of about 0.1 wt % or more, about 0.2 wt % or more, about 0.5 wt % or more, about 3 wt % or less, about 2 wt % or less, or about 1 wt % or less. In aspects, the composition can comprise the silane coupling agent in a weight % (wt %) ranging from about 0.1 wt % to about 3 wt %, from about 0.1 wt % to about 2 wt %, from about 0.2 wt % to about 2 wt %, from about 0.2 wt % to about 1 wt %, from about 0.5 wt % to about 1 wt %, or any range or subrange therebetween.

Methods of forming the polymer-based portion can comprise curing the composition to form the polymer-based portion. In aspects, curing the composition to form the polymer-based portion can comprise heating, ultraviolet (UV) irradiation, and/or waiting for a predetermined period of time. In aspects where the composition comprises a photo-initiator, curing can comprise irradiating the composition with at least one wavelength of light that the photo-initiator is sensitive to. In aspects, the irradiating can comprise impinging the composition with a light beam emitted from a light source. In further aspects, the light source can be configured to emit a light beam comprising an ultra-violet (UV) wavelength or a visible wavelength. In even further aspects, the wavelength of the light beam can be in a range from about 10 nm to about 400 nm, from about 100 nm to about 400 nm, from about 200 nm to about 400 nm, from about 10 nm to about 300 nm, from about 100 nm to about 300 nm, from about 200 nm to about 300 nm, from about 10 nm to about 200 nm, from about 100 nm to about 200 nm, or any range or subrange therebetween. In even further aspects, an operating wavelength range of the light source may be over a range of optical wavelengths from about 315 nm to about 400 nm, from about 280 nm to about 315 nm, from about 100 nm to about 280 nm, or from 122 nm to about 200 nm. In even further aspects, the wavelength of the light beam can be in a range from about 300 nm to about 1,000 nm, from about 350 nm to about 900 nm, from about 400 to about 800 nm, from about 500 nm to about 700 nm, or any range or subrange therebetween. In still further aspects, the wavelength of the light beam can be about 365 nm, about 415 nm, or about 590 nm.

In aspects, curing can comprise heating the composition at a temperature for a time. As used herein, heating a composition “at a temperature” means that the composition is exposed to the temperature, for example, by being placed in an oven. In further aspects, the temperature can be about 80° C. or more, about 100° C. or more, about 120° C. or more, about 140° C. or more, about 250° C. or less, about 200° C. or less, about 180° C. or less, or about 160° C. or less. In further aspects, the temperature can be in a range from about 80° C. to about 250° C., from about 80° C. to about 200° C., from about 100° C. to about 200° C., from about 100° C. to about 180° C., from about 120° C. to about 180° C., from about 120° C. to about 160° C., from about 140° C. to about 160° C., or any range or subrange therebetween. In further aspects, the time can be about 15 minutes or more, about 30 minutes or more, 1 hour or more about 12 hours or less, about 6 hours or less, about 3 hours or less, or about 2 hours or less. In further aspects, the time can be in a range from about 15 minutes to about 12 hours, from about 15 minutes to about 6 hours, from about 15 minutes to about 3 hours, from about 30 minutes to about 3 hours, from about 1 hour to about 3 hours, from about 1 hour to about 2 hours, or any range or subrange therebetween.

In aspects, curing the composition to form the polymer-based material can result in a volume change of the polymer-based portion relative to a volume of the composition. In further aspects, a magnitude of a difference of the volume of the polymer-based portion relative to the volume of the composition as a percentage of the volume of the composition can be about 5% or less, about 2% or less, about 1% or less, about 0.5% or less, about 0.1% or less, about 0.01% or more, about 0.1% or more, about 0.5% or more, about 1% or more. In further aspects, a magnitude of a difference of the volume of the polymer-based portion relative to the volume of the composition as a percentage of the volume of the composition can be in a range from 0% to about 5%, from 0% to about 2%, from 0% to about 1%, from 0.01% to about 1%, from about 0.1% to about 1%, from about 0.5% to about 1%, from about 0.01% to about 5%, from about 0.01% to about 2%, from about 0.1% to about 2%, from about 0.5% to about 2%, or any range or subrange therebetween.

Example composition ranges of polymer-based portions and/or compositions in aspects of the disclosure are presented in Table 1. R1 is the broadest of the ranges in Table 1. R3-R4 and R6 are free from an elastomer. R2 and R6 are free from functionalized oligomeric silsesquioxanes. R2 and R4-R5 are free from functionalized oligomeric silsesquioxanes. R1-R2 and R5 can comprise an elastomer. R1 and R2-R5 can comprise the functionalized oligomeric silsesquioxanes. R1, R3, and R5 can comprise silica nanoparticles. R1 and R3 can comprise both the functionalized oligomeric silsesquioxanes and silica nanoparticles.

Again, it is to be understood that other ranges or subranges discussed above for these components can be used in combination with any of the ranges presented in Table 1.

TABLE 1
Composition ranges (wt %) of aspects of polymer-based portions

| | Range | | | | | |
|---|---|---|---|---|---|---|
| | R1 | R2 | R3 | R4 | R5 | R6 |
| Difunctional | 20-70 | 35-60 | 35-60 | 35-60 | 20-60 | 20-60 |
| Urethane- | | | | | | |
| Acrylate | | | | | | |
| Oligomer | | | | | | |
| Reactive | 5-70 | 35-65 | 5-65 | 35-65 | 5-65 | 35-65 |
| Diluent | | | | | | |
| Photo-initiator | 0-2 | 0.2-2 | 0.2-2 | 0.2-2 | 0.2-2 | 0.2-2 |
| Silane | 0-4.9 | 0.1-4.9 | 0.1-4.9 | 0.1-4.9 | 0.1-4.9 | 0.1-4.9 |
| Coupling | | | | | | |
| Agent | | | | | | |
| Elastomer | 0-5 | 0-5 | 0 | 0 | 0-5 | 0 |
| Functionalized | 0-50 | 0 | 20-50 | 20-50 | 20-50 | 0 |
| Oligomeric | | | | | | |
| Silsesquioxanes | | | | | | |
| Silica | 0-50 | 0 | 0-50 | 0 | 0 | 10-30 |
| Nanoparticles | | | | | | |

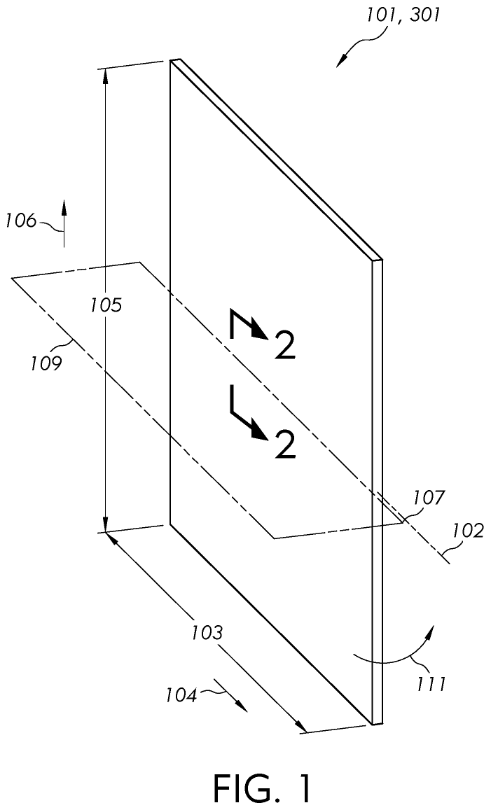

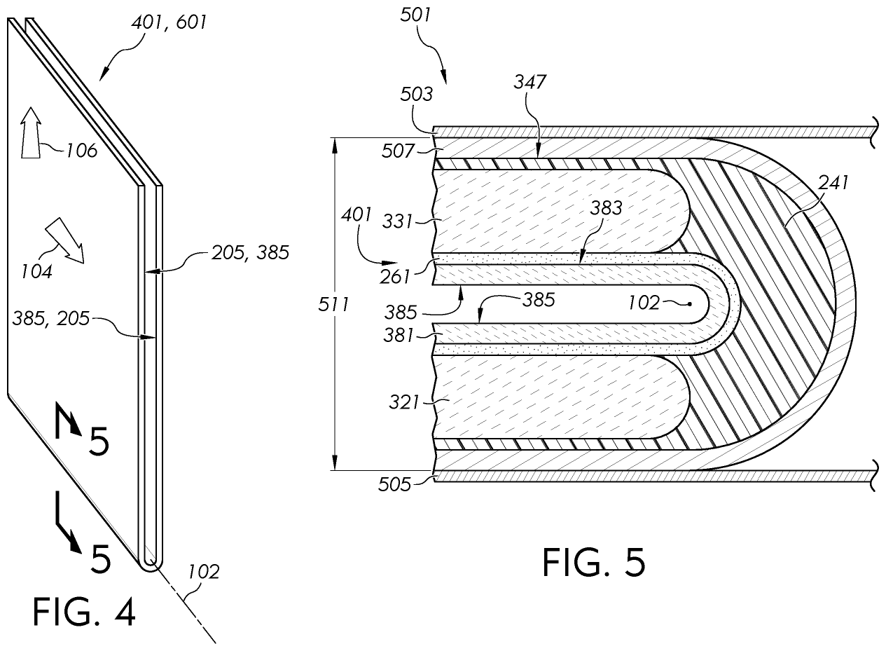

FIGS. 1-3 schematically illustrate example aspects of the foldable apparatus 101 and/or 301 in an unfolded (e.g., flat configuration) in accordance with aspects of the disclosure while FIGS. 4-6 schematically illustrate example aspects of a foldable apparatus 401 and/or 601 in a folded configuration in accordance with aspects of the disclosure. In aspects, as shown in FIG. 2, foldable apparatus 101 of the disclosure comprise a ribbon 201. In aspects, as shown in FIG. 3, the foldable apparatus 301 can comprise a first portion 321 and a second portion 331. In further aspects, as shown, the foldable apparatus can comprise a first substrate 371 and/or a second substrate 381. In aspects, the ribbon 201, the first substrate 371, the first portion 321, the second portion 331, and/or the second substrate 381 can comprise a glass-based substrate and/or a ceramic-based substrate having a pencil hardness of 8H or more, for example, 9H or more. As used herein, pencil hardness is measured using ASTM D 3363-20 with standard lead graded pencils. Additionally, the first substrate 371 and/or the second substrate 381, if present, may comprise a glass-based substrate and/or a ceramic-based substrate to enhance puncture resistance and/or impact resistance.

In aspects, the ribbon 201, the first substrate 371, the first portion 321, the second portion 331, and/or the second substrate 381 can comprise a glass-based substrate. As used herein, “glass-based” includes both glasses and glass-ceramics, wherein glass-ceramics have one or more crystalline phases and an amorphous, residual glass phase. A glass-based material (e.g., glass-based substrate) may comprise an amorphous material (e.g., glass) and optionally one or more crystalline materials (e.g., ceramic). Amorphous materials and glass-based materials may be strengthened. As used herein, the term “strengthened” may refer to a material that has been chemically strengthened, for example, through ion exchange of larger ions for smaller ions in the surface of the substrate (e.g., first substrate, second substrate), as discussed below. However, other strengthening methods, for example, thermal tempering, or utilizing a mismatch of the coefficient of thermal expansion between portions of the substrate (e.g., first substrate, second substrate) to create compressive stress and central tension regions, may be utilized to form strengthened substrates. Exemplary glass-based materials, which may be free of lithia or not, comprise soda lime glass, alkali aluminosilicate glass, alkali-containing borosilicate glass, alkali-containing aluminoborosilicate glass, alkali-containing phosphosilicate glass, and alkali-containing aluminophosphosilicate glass. In aspects, glass-based material can comprise an alkali-containing glass or an alkali-free glass, either of which may be free of lithia or not. In aspects, the glass material can be alkali-free and/or comprise a low content of alkali metals (e.g., R₂O of about 10 mol % or less, wherein R₂O comprises Li₂O Na₂O, K₂O, or the more expansive list provided below). In one or more aspects, a glass-based material may comprise, in mole percent (mol %). SiO₂ in a range from about 40 mol % to about 80%, Al₂O₃ in a range from about 5 mol % to about 30 mol %, B₂O₃ in a range from 0 mol % to about 10 mol %, ZrO₂ in a range from 0 mol % to about 5 mol %, P₂O₅ in a range from 0 mol % to about 15 mol %, TiO₂ in a range from 0 mol % to about 2 mol %, R₂O in a range from 0 mol % to about 20 mol %, and RO in a range from 0 mol % to about 15 mol %. As used herein, R₂O can refer to an alkali metal oxide, for example, Li₂O, Na₂O, K₂O, Rb₂O, and Cs₂O. As used herein, RO can refer to MgO, CaO, SrO, BaO, and ZnO. In aspects, a glass-based substrate may optionally further comprise in a range from 0 mol % to about 2 mol % of each of Na₂SO₄, NaCl, NaF, NaBr, K₂SO₄, KCl, KF, KBr, As₂O₃, Sb₂O₃, SnO₂, Fe₂O₃, MnO, MnO₂, MnO₃, Mn₂O₃, Mn₃O₄, Mn₂O₇. “Glass-ceramics” include materials produced through controlled crystallization of glass. In aspects, glass-ceramics have about 1% to about 99% crystallinity. Examples of suitable glass-ceramics may include Li₂O—Al₂O₃—SiO₂ system (i.e., LAS-System) glass-ceramics, MgO—Al₂O₃—SiO₂ system (i.e., MAS-System) glass-ceramics, ZnO×Al₂O₃×nSiO₂ (i.e., ZAS system), and/or glass-ceramics that include a predominant crystal phase including β-quartz solid solution, β-spodumene, cordierite, petalite, and/or lithium disilicate. The glass-ceramic substrates may be strengthened using the chemical strengthening processes. In one or more aspects, MAS-System glass-ceramic substrates may be strengthened in Li₂SO₄ molten salt, whereby an exchange of 2Li⁺ for Mg²⁺ can occur.

In aspects, the ribbon 201, the first substrate 371, the first portion 321, the second portion 331, and/or the second substrate 381 can comprise a ceramic-based substrate. As used herein, “ceramic-based” includes both ceramics and glass-ceramics, wherein glass-ceramics have one or more crystalline phases and an amorphous, residual glass phase. Ceramic-based materials may be strengthened (e.g., chemically strengthened). In aspects, a ceramic-based material can be formed by heating a glass-based material to form ceramic (e.g., crystalline) portions. In further aspects, ceramic-based materials may comprise one or more nucleating agents that can facilitate the formation of crystalline phase(s). In aspects, ceramic-based materials can comprise one or more oxides, nitrides, oxynitrides, carbides, borides, and/or silicides. Example aspects of ceramic oxides include zirconia (ZrO₂), zircon (ZrSiO₄), an alkali metal oxide (e.g., sodium oxide (Na₂O)), an alkali earth metal oxide (e.g., magnesium oxide (MgO)), titania (TiO₂), hafnium oxide (Hf₂O), yttrium oxide (Y₂O₃), iron oxides, beryllium oxides, vanadium oxide (VO₂), fused quartz, mullite (a mineral comprising a combination of aluminum oxide and silicon dioxide), and spinel (MgAl₂O₄). Example aspects of ceramic nitrides include silicon nitride (Si₃N₄), aluminum nitride (AlN), gallium nitride (GaN), beryllium nitride (Be₃N₂), boron nitride (BN), tungsten nitride (WN), vanadium nitride, alkali earth metal nitrides (e.g., magnesium nitride (Mg₃N₂)), nickel nitride, and tantalum nitride. Example aspects of oxynitride ceramics include silicon oxynitride, aluminum oxynitride, and a SiAlON (a combination of alumina and silicon nitride and can have a chemical formula, for example, Si₁₂₋ₘ₋ₙAlₘ₊ₙOₙN₁₆₋ₙ, Si₆₋ₙAlₙOₙN₈₋ₙ, or Si₂₋ₙAlₙO₁₊ₙN₂₋ₙ, where m, n, and the resulting subscripts are all non-negative integers). Example aspects of carbides and carbon-containing ceramics include silicon carbide (SiC), tungsten carbide (WC), an iron carbide, boron carbide (B₄C), alkali metal carbides (e.g., lithium carbide (Li₄C₃)), alkali earth metal carbides (e.g., magnesium carbide (Mg₂C₃)), and graphite. Example aspects of borides include chromium boride (CrB₂), molybdenum boride (Mo₂B₅), tungsten boride (W₂B₅), iron boride, titanium boride, zirconium boride (ZrB₂), hafnium boride (HfB₂), vanadium boride (VB₂), Niobium boride (NbB₂), and lanthanum boride (LaB₆). Example aspects of silicides include molybdenum disilicide (MoSi₂), tungsten disilicide (WSi₂), titanium disilicide (TiSi₂), nickel silicide (NiSi), alkali earth silicide (e.g., sodium silicide (NaSi)), alkali metal silicide (e.g., magnesium silicide (Mg₂Si)), hafnium disilicide (HfSi₂), and platinum silicide (PtSi).

Throughout the disclosure, an elastic modulus (e.g., Young's modulus) of the ribbon 201, the first substrate 371, the first portion 321, the second portion 331, and/or the second substrate 381 (e.g., glass-based material, ceramic-based material) is measured using indentation methods in accordance with ASTM E2546-15. In aspects, the ribbon 201, the first substrate 371, the first portion 321, the second portion 331, and/or the second substrate 381 can comprise an elastic modulus of about 10 GigaPascals (GPa) or more, about 50 GPa or more, about 60 GPa or more, about 70 GPa or more, about 100 GPa or less, or about 80 or less. In aspects, the ribbon 201, the first substrate 371, the first portion 321, and/or the second portion 331 can comprise an elastic modulus in a range from about 10 GPa to about 100 GPa, from about 50 GPa to about 100 GPa, from about 50 GPa to about 80 GPa, from about 60 GPa to about 80 GPa, from about 70 GPa ta about 80 GPa, or any range or subrange therebetween.

In aspects, the first portion 321, the second portion 331, first substrate 371, and/or the second substrate 381 can comprise a polymeric substrate. In further aspects, the first substrate 371 and/or the second substrate 381 can comprise a rigid polymer, for example but not limited to, blends, nanoparticle, and/or fiber composites of one or more of styrene-based polymers (e.g., polystyrene (PS), styrene acrylonitrile (SAN), styrene maleic anhydride (SMA)), phenylene-based polymer (e.g., polyphenylene sulfide (PPS)), polyvinylchloride (PVC), polysulfone (PSU), polyphthalmide (PPA), polyoxymethylene (POM), polylactide (PLA), polyimides (PI), polyhydroxybutyrate (PHB), polyglycolides (PGA), polyethyleneterephthalate (PET), and/or polycarbonate (PC). In further aspects, the first portion 321, the second portion 331, the first substrate 371, and/or the second substrate 381 can comprise one or more of an optically transparent: an acrylic (e.g., polymethylmethacrylate (PMMA)), an epoxy, a silicone, and/or a polyurethane. Examples of epoxies include bisphenol-based epoxy resins, novolac-based epoxies, cycloaliphatic-based epoxies, and glycidylamine-based epoxies. In further aspects, the first portion 321, the second portion 331, the first substrate 371, and/or the second substrate 381 can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). Example aspects of polyolefins include low molecular weight polyethylene (LDPE), high molecular weight polyethylene (HDPE), ultrahigh molecular weight polyethylene (UHMWPE), and polypropylene (PP). Example aspects of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example aspects of elastomers include rubbers (e.g., polybutadiene, polyisoprene, chloroprene rubber, butyl rubber, nitrile rubber) and block copolymers (e.g., styrene-butadiene, high-impact polystyrene, poly(dichlorophosphazene)). In aspects, the first substrate 371 and/or the second substrate 381 can comprise a sol-gel material. In aspects, the first substrate 371 and/or the second substrate 381 comprising a polymeric substrate can comprise an elastic modulus of about 3 GigaPascals (GPa) or more, about 8 GPa or more, about 9 GPa or more, or about 10 GPa or more).

As shown in FIG. 2, the ribbon 201 can comprise a first major surface 203 and a second major surface 205 opposite the first major surface 203. As shown in FIG. 2, the first major surface 203 can extend along a first plane 204a. As further shown in FIG. 2, the ribbon 201 can comprise the second major surface 205 extending along a second plane 204b. In aspects, as shown, the second plane 204b can be parallel to the first plane 204a. As used herein, a ribbon thickness 227 can be defined between the first major surface 203 and the second major surface 205 as a distance between the first plane 204a and the second plane 204b. In aspects, the ribbon thickness 227 can be about 10 micrometers (μm) or more, about 25 μm or more, about 40 μm or more, about 60 μm or more, about 80 μm or more, about 100 μm or more, about 125 μm or more, about 150 μm or more, about 3 millimeters (mm) or less, about 2 mm or less, about 1 mm or less, about 800 μm or less, about 500 μm or less, about 300 μm or less, about 200 μm or less, about 180 μm or less, or about 160 μm or less. In aspects, the ribbon thickness 227 can be in a range from about 10 μm to about 3 mm, from about 10 μm to about 2 mm, from about 25 μm to about 2 mm, from about 40 μm to about 2 mm, from about 60 μm to about 2 mm, from about 80 μm to about 2 mm, from about 100 μm to about 2 mm, from about 100 μm to about 1 mm, from about 100 μm to about 800 μm, from about 100 μm to about 500 μm, from about 125 μm to about 500 μm, from about 125 μm to about 300 μm, from about 125 μm to about 200 μm, from about 150 μm to about 200 μm, from about 150 μm to about 160 μm, or any range or subrange therebetween. In aspects, the ribbon thickness 227 can be in a range from about 80 μm to about 2 mm, from about 80 μm to about 1 mm, from about 80 μm to about 500 μm, from about 80 μm to about 300 μm. In aspects, the ribbon thickness 227 can be in a range from about 200 μm to about 2 mm, from about 200 μm to about 1 mm, from about 200 μm to about 500 μm, from about 500 μm to about 2 mm, from about 500 μm to about 1 mm, or any range or subrange therebetween. In aspects, the ribbon thickness 227 can be about 300 μm or less, for example, from about 10 μm to about 300 μm, from 25 μm to about 300 μm, from about 25 μm to about 200 μm, from about 25 μm to about 180 μm, from about 40 μm to about 180 μm, from about 40 μm to about 160 μm, from about 60 μm to about 160 μm, from about 80 μm to about 160 μm, or any range or subrange therebetween.

In aspects, as shown in FIG. 2, the ribbon 201 can comprise a first portion 221 and a second portion 231 with a central portion 251 positioned therebetween. In further aspects, the first portion 221 and/or the second portion 231 can comprise the ribbon thickness 227. In further aspects, as shown, the first portion 221 can comprise a first surface area 223 comprising a portion of the first major surface 203 and a second surface area 225 comprising a portion of the second major surface 205 opposite the first surface area 223. In further aspects, the second portion 231 can comprise a third surface area 233 comprising a portion of the first major surface 203 and a fourth surface area 235 comprising a portion of the second major surface 205 opposite the third surface area 233. In further aspects, as shown, the central portion 251 can comprise a first central surface area 211 positioned between the first surface area 223 and the third surface area 233. In even further aspects, as shown, the first central surface area 211 can extend along a third plane 204c. In even further aspects, as shown, the central portion 251 can comprise a second central surface area 213 that is coplanar with the second major surface 205. In even further aspects, as shown, the central portion 251 can comprise the second central surface area 213 comprising a portion of the second major surface 205 opposite the first central surface area 211 and positioned between the second surface area 225 and the fourth surface area 235. In even further aspects, as shown, a central thickness 217 can be defined between the first central surface area 211 and the second central surface area 213, for example as the distance between the third plane 204c and the second plane 204b. In still further aspects, as shown, the central thickness 217 is less than the ribbon thickness 227 to provide a recess 219 that can be defined between the first plane 204a and the first central surface area 211. In still further aspects, although not shown, the foldable apparatus can comprise the ribbon comprising a second recess opposite the recess. In still further aspects, the central thickness can be about 0.5% or more, about 1% or more, about 2% or more, about 5% or more, about 40% or less, about 30% or less, about 20% or less, about 13% or less, about 10% or less, or about 5% or less of the ribbon thickness 227. In aspects, the central thickness 217 as a percentage of the ribbon thickness 227 can be in a range from about 0.5% to about 40%, from about 0.5% to about 30%, from about 0.5% to about 20%, from about 0.5% to about 13%, from about 0.5% to about 10%, from about 0.5% to about 5%, or any range or subrange therebetween. In aspects, the central thickness 217 as a percentage of the ribbon thickness 227 can be in a range from about 1% to about 13%, from about 2% to about 13%, from about 5% to about 13%, from about 5% to about 10%, or any range or subrange therebetween. In further aspects, the central thickness 217 can be within one or more of the ranges for the substrate thickness while being less than the substrate thickness. In further aspects, the central thickness 217 can be about 10 μm or more, about 25 μm or more, about 50 μm or more, about 80 μm or more, about 220 μm or less, about 125 μm or less, about 100 μm or less, about 80 μm or less, about 60 μm or less, or about 40 μm or less. In even further aspects, the central thickness 217 can be in a range from about 10 μm to about 220 μm, from about 10 μm to about 125 μm, from about 10 μm to about 100 μm, from about 10 μm to about 80 μm, from about 25 μm to about 80 μm, from about 25 μm to about 60 μm, from about 50 μm to about 60 μm, or any range or subrange therebetween. In further aspects, the central thickness 217 can be greater than about 80 μm, for example, about 80 μm or more, about 100 μm or more, about 125 μm or more, about 220 μm or less, about 175 μm or less, or about 150 μm or less. In even further aspects, the central thickness 217 can be in a range from about 80 μm to about 220 μm, from about 80 μm to about 175 μm, from about 80 μm to about 150 μm, from about 100 μm to about 150 μm, from about 125 μm to about 150 μm, or any range or subrange therebetween. In further aspects, the central thickness 217 can be less than about 80 μm, for example, in a range from about 10 μm to about 80 μm, from about 25 μm to about 60 μm, from about 10 μm to about 50 μm, from about 25 μm to about 50 μm, from about 10 μm to about 40 μm, from about 25 μm to about 40 μm, or any range or subrange therebetween.

In aspects, as shown in FIG. 2, the first central surface area 211 can be recessed from the first major surface 203 by a first distance 209. In further aspects, the first distance 209 can be measured as the distance between the first plane 204a and the third plane 204c. In further aspects, the first distance 209 as a percentage of the ribbon thickness 227 can be about 60% or more, about 70% or more, about 80% or more, about 87% or more, about 90% or more, or about 95% or more, about 99.5% or less, about 99% or less, about 98% or less, or about 95% or less. In further aspects, the first distance 209 as a percentage of the ribbon thickness 227 can be in a range from about 60% to about 99.5%, from about 70% to about 99.5%, from about 80% to about 99.5%, from about 87% to about 99.5%, from about 90% to about 99.5%, from about 95% to about 99.5%, or any range or subrange therebetween. In further aspects, the first distance 209 as a percentage of the ribbon thickness 227 can be in a range from about 87% to about 99%, from about 87% to about 98%, from about 87% to about 95%, from about 90% to about 95%, or any range or subrange therebetween.

As shown in FIG. 2, the central portion 251 can comprise a first transition region 212. The first transition region 212 can attach the first portion 221 to a region of the central portion 251 comprising the central thickness 217 (e.g., region comprising the first central surface area 211). In aspects, as shown in FIG. 2, the first transition region 212 can comprise a first transition surface area 215 attaching the first central surface area 211 to the first surface area 223. A thickness of the first transition region 212 at a location can be measured as a distance from a location on the first transition surface area 215 corresponding to the location to the second major surface 205 (e.g., second plane 204b). In further aspects, as shown, a thickness of the first transition region 212 can smoothly decrease, monotonically decrease, and/or smoothly and monotonically decrease between the ribbon thickness 227 of the first portion 221 and the central thickness 217 of the central portion 251. As used herein, a thickness decreases smoothly if changes in the cross-sectional area are smooth (e.g., gradual) rather than abrupt (e.g., step) changes in thickness. As used herein, a thickness decreases monotonically in a direction if the thickness decreases for a portion and for the rest of the time either stays the same, decreases, or a combination thereof (i.e., the thickness decreases but never increases in the direction). Providing a smooth shape of the first transition region and/or the second transition region can reduce optical distortions. Providing a monotonically decreasing thickness of the first transition region and/or the second transition region can reduce an incidence of mechanical instabilities and/or decrease a visibility of the transition region. In aspects, as shown in FIG. 2, the thickness of the first transition region 212 can continuously increase from the first central surface area 211 (e.g., the central thickness 217) to the first portion 221 (e.g., ribbon thickness 227). In aspects, as shown, the thickness of the first transition region 212 can increase at a constant rate from the first central surface area 211 to the first portion 221. In aspects, although not shown, the thickness of the first transition region may increase more slowly where the first central surface area meets the first transition region than in the middle of the first transition region. In aspects, although not shown, the thickness of the first transition region may increase more slowly where the first portion meets the first transition region than in the middle of the first transition region. In aspects, although not shown, the central portion may not comprise a first transition region, for example, providing a step transition between the substrate thickness and the central thickness.

As shown in FIG. 2, the central portion 251 can comprise a second transition region 218. The second transition region 218 can attach the second portion 231 to a region of the central portion 251 comprising the central thickness 217 (e.g., region comprising the first central surface area 211). In aspects, as shown in FIG. 2, the second transition region 218 can comprise a second transition surface area 229 attaching the first central surface area 211 to the third surface area 233. A thickness of the second transition region 218 at a location can be measured as a distance from a location on the second transition surface area 229 corresponding to the location to the second major surface 205 (e.g., second plane 204b). In further aspects, as shown, a thickness of the second transition region 218 can smoothly decrease, monotonically decrease, and/or smoothly and monotonically decrease between the ribbon thickness 227 of the second portion 231 and the central thickness 217 of the central portion 251. In aspects, as shown in FIG. 2, the thickness of the second transition region 218 can continuously increase from the first central surface area 211 (e.g., the central thickness 217) to the second portion 231 (e.g., ribbon thickness 227). In aspects, as shown, the thickness of the second transition region 218 can increase at a constant rate from the first central surface area 211 to the second portion 231. In aspects, although not shown, the thickness of the second transition region may increase more slowly where the first central surface area meets the second transition region than in the middle of the second transition region. In aspects, although not shown, the thickness of the second transition region may increase more slowly where the second portion meets the second transition region than in the middle of the second transition region. In aspects, although not shown, the central portion may not comprise a second transition region, for example, providing a step transition between the substrate thickness and the central thickness.

In further aspects, as shown in FIG. 2, a width 252 of the central portion 251 can be defined as the minimum distance between an outer peripheral portion of the first surface area 223 of the first portion 221 and an outer peripheral portion of the third surface area 233 of the second portion 231 when the foldable apparatus 101 is in the configuration shown in FIG. 1. In aspects, the width 252 of the central portion 251 can be about 1 times or more, about 1.4 times or more, about 1.5 times or more, about 2 times or more, about 3 times or less, about 2.5 times or less, or about 2 times or less the minimum parallel plate distance of the foldable apparatus. In aspects, the width 252 of the central portion 251 as a multiple of the minimum parallel plate distance can be in a range from about 1.4 times to about 3 times, from about 1.4 times to about 2.5 times, from about 1.4 times to about 2 times, from about 1.5 times to about 3 times, from about 1.5 times to about 2.5 times, from about 1.5 times to about 2 times, from about 2 times to about 3 times, from about 2 times to about 2.55 times, or any range or subrange therebetween. Without wishing to be bound by theory, the length of a bent portion in a circular configuration between parallel plates can be about 0.8 times the parallel plate distance. In aspects, the width 252 of the central portion 251 can be about 1 mm or more, about 2 mm or more, about 4 mm or more, about 5 mm or more, about 10 mm or more, about 20 mm or more, about 40 mm or more, about 200 mm or less, about 100 mm or less, or about 60 mm or less. In aspects, the width 252 of the central portion 251 can be in a range from about 1 mm to about 200 mm, from about 5 mm to about 200 mm, from about 10 mm to about 175 mm, from about 20 mm to about 150 mm, from about 30 mm to about 125 mm, from about 40 mm to about 100 mm, from about 50 mm to about 90 mm, from about 60 mm to about 80 mm, from about 5 mm to about 60 mm, from about 10 mm to about 60 mm, from about 20 mm to about 60 mm, from about 40 mm to about 60 mm, or any range or subrange therebetween. In aspects, the width 252 of the central portion 251 can be in a range from about 1 mm to about 100 mm, from about 1 mm to about 60 mm, from about 1 mm to about 40 mm, from about 1 mm to about 30 mm, from about 2 mm to about 30 mm, from about 2 mm to about 20 mm, from about 5 mm to about 20 mm, from about 10 mm to about 20 mm, or any range or subrange therebetween. In aspects, the width 252 of the central portion 251 can be in a range from about 1 mm to about 20 mm, from about 1 mm to about 10 mm, from about 2 mm to about 10 mm, from about 2 mm to about 5 mm, or any range or subrange therebetween. In aspects, the width 252 of the central portion 251 can be in a range from about the minimum parallel plate distance to about 200 mm, from about the minimum parallel plate distance to about 100 mm, from about minimum parallel plate distance to about 60 mm, from about the minimum parallel plate distance to about 40 mm, from about the minimum parallel plate distance to about 30 mm, from about minimum parallel plate distance to about 20 mm, a range from about 1.5 times the minimum parallel plate distance to about 200 mm, from about 1.5 times the minimum parallel plate distance to about 100 mm, from about 1.5 times the minimum parallel plate distance to about 60 mm, from about 1.5 times the minimum parallel plate distance to about 40 mm, from about 1.5 times the minimum parallel plate distance to about 30 mm, from about 1.5 times the minimum parallel plate distance to about 30 mm, or any range or subrange therebetween.

As shown in FIG. 3, the first substrate 371 can comprise a first major surface 373 and a second major surface 375 opposite the first major surface 373. In aspects, the first major surface 373 can extend along a first plane (e.g., similar to first plane 204a in FIG. 2). In aspects, the first substrate 371 can comprise the second major surface 375 extending along a second plane (e.g., similar to first plane 204a in FIG. 2). A substrate thickness 377 can be defined as an average distance between the first major surface 373 and the second major surface 375 of the first substrate 371. In aspects, the substrate thickness 377 can be within one or more of the ranges discussed above for the ribbon thickness 227 or the central thickness 217. As used herein, ribbons comprise the central portion comprising a central thickness less than a ribbon thickness whereas substrates comprise a substantially uniform substrate thickness over a first major surface of the substrate.

As shown in FIG. 3, the second substrate 381 can comprise a third major surface 383 and a fourth major surface 385 opposite the third major surface 383. In aspects, the third major surface 383 can extend along a third plane, and/or the fourth major surface 385 can extend along a fourth plane. A second substrate thickness 387 can be defined as an average distance between the third major surface 383 and the fourth major surface 385. In aspects, the second substrate thickness 387 can be within one or more of the ranges discussed above for the ribbon thickness 227 or the central thickness 217.

In aspects, as shown in FIG. 3, the first portion 321 can comprise a first surface area 323 opposite a second surface area 325. In further aspects, as shown, the second portion 331 can comprise a third surface area 333 opposite a fourth surface area 335. In further aspects, in the illustrated flat configuration, the first surface area 323 and/or the third surface area 333 can extend along a third plane, and/or the second surface area 325 and/or the fourth surface area 335 can extend along a fourth plane. In even further aspects, a second portion thickness can be defined between the third plane and the fourth plane. In still further aspects, the second portion thickness can be within one or more of the ranges discussed above for the first portion thickness 327 and/or the ribbon thickness 227. In yet further aspects, the second portion thickness can be substantially equal to the first portion thickness 327.

In further aspects, as shown in FIG. 3, the first portion 321 can comprise a first edge surface area 329 extending between the first surface area 323 and the second surface area 325, and/or the second portion 331 can comprise a second edge surface area 339 extending between the third surface area 333 and the fourth surface area 335. In even further aspects, as shown in FIG. 3, the first edge surface area 329 and/or the second edge surface area 339 can comprise a first outwardly convex curved edge surface and/or a second outwardly convex curved edge surface, respectively. In still further aspects, the first edge surface area 329 and/or the second edge surface area 339 can comprise a cross-sectional profile taken perpendicular to the edge surface that is the shape of an arc of a circle, although other shapes, for example, ellipses, are possible. In yet further aspects, the first outwardly convex curved edge surface and/or the second outwardly convex curved edge surface can be characterized by a first radius of curvature 309 and/or a second radius of curvature 337, respectively. In still yet further aspects, the first radius of curvature 309 and/or the second radius of curvature 337 as a percentage of the first portion thickness 327 can be about 30% or more, about 40% or more, about 45% or more, about 49% or more, about 70% or less, about 60% or less, about 55% or less, or about 51% or less. In even further aspects, the first radius of curvature 309 and/or the second radius of curvature 337 as a percentage of the first portion thickness 327 can be in a range from about 30% to about 70%, from about 30% to about 60%, from about 30% to about 55%, from about 30% to about 51%, from about 40% to about 70%, from about 40% to about 60%, from about 40% to about 55%, from about 40% to about 51%, from about 45% to about 70%, from about 45% to about 60%, from about 45% to about 55%, from about 45% to about 51%, from about 49% to about 70%, from about 49% to about 60%, from about 49% to about 55%, from about 49% to about 51%, or any range or subrange therebetween. In further aspects, although not shown, the first edge surface area and/or the second edge surface area can comprise linear (e.g., planar) edge surfaces, namely, a first linear edge surface and/or a second linear edge surface, respectively.

In further aspects, as shown in FIG. 3, a minimum distance 343 between the first portion 321 and the second portion 331 can be defined as the minimum distance between an outer peripheral portion 355 of the first edge surface area 329 of the first portion 321 and an outer peripheral portion 359 of the second edge surface area 339 of the second portion 331 when the foldable apparatus 301 is in the flat configuration shown in FIG. 3. In aspects, the minimum distance 343 between the first portion 221 and the second portion 231 can be about 1 times or more, about 1.4 times or more, about 1.5 times or more, about 2 times or more, about 3 times or less, about 2.5 times or less, or about 2 times or less the minimum parallel plate distance of the foldable apparatus. In aspects, the minimum distance 343 as a multiple of the minimum parallel plate distance can be in a range from about 1.4 times to about 3 times, from about 1.4 times to about 2.5 times, from about 1.4 times to about 2 times, from about 1.5 times to about 3 times, from about 1.5 times to about 2.5 times, from about 1.5 times to about 2 times, from about 2 times to about 3 times, from about 2 times to about 2.55 times, or any range or subrange therebetween. Without wishing to be bound by theory, the length of a bent portion in a circular configuration between parallel plates can be about 0.8 times the parallel plate distance. In aspects, the minimum distance 343 can be about 1 mm or more, about 2 mm or more, about 4 mm or more, about 5 mm or more, about 10 mm or more, about 20 mm or more, about 40 mm or more, about 200 mm or less, about 100 mm or less, or about 60 mm or less. In aspects, the minimum distance 343 can be in a range from about 1 mm to about 200 mm, from about 5 mm to about 200 mm, from about 10 mm to about 175 mm, from about 20 mm to about 150 mm, from about 30 mm to about 125 mm, from about 40 mm to about 100 mm, from about 50 mm to about 90 mm, from about 60 mm to about 80 mm, from about 5 mm to about 60 mm, from about 10 mm to about 60 mm, from about 20 mm to about 60 mm, from about 40 mm to about 60 mm, or any range or subrange therebetween. In aspects, the minimum distance 343 can be in a range from about 1 mm to about 100 mm, from about 1 mm to about 60 mm, from about 1 mm to about 40 mm, from about 1 mm to about 30 mm, from about 2 mm to about 30 mm, from about 2 mm to about 20 mm, from about 5 mm to about 20 mm, from about 10 mm to about 20 mm, or any range or subrange therebetween. In aspects, the minimum distance 343 can be in a range from about 1 mm to about 20 mm, from about 1 mm to about 10 mm, from about 2 mm to about 10 mm, from about 2 mm to about 5 mm, or any range or subrange therebetween. In aspects, the minimum distance 343 can be in a range from about the minimum parallel plate distance to about 200 mm, from about the minimum parallel plate distance to about 100 mm, from about minimum parallel plate distance to about 60 mm, from about the minimum parallel plate distance to about 40 mm, from about the minimum parallel plate distance to about 30 mm, from about minimum parallel plate distance to about 20 mm, a range from about 1.5 times the minimum parallel plate distance to about 200 mm, from about 1.5 times the minimum parallel plate distance to about 100 mm, from about 1.5 times the minimum parallel plate distance to about 60 mm, from about 1.5 times the minimum parallel plate distance to about 40 mm, from about 1.5 times the minimum parallel plate distance to about 30 mm, from about 1.5 times the minimum parallel plate distance to about 30 mm, or any range or subrange therebetween. By providing a minimum distance between the first portion and the second portion, folding of the foldable apparatus without failure can be facilitated.

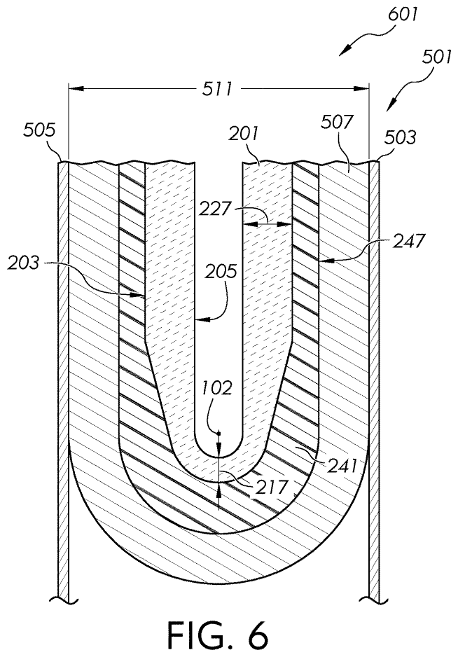

In aspects, the ribbon 201, the first substrate 371, the first portion 321, the second portion 331, and/or the second substrate 381 may comprise a glass-based substrate and/or ceramic-based substrate where one or more portions of the substrate may comprise a compressive stress region. In aspects, the compressive stress region may be created by chemically strengthening the substrate (e.g., first substrate, second substrate), portions, and/or ribbon. Chemically strengthening may comprise an ion exchange process, where ions in a surface layer are replaced by—or exchanged with—larger ions having the same valence or oxidation state. Methods of chemically strengthening will be discussed later. Without wishing to be bound by theory, chemically strengthening the substrate (e.g., first substrate, second substrate), first portion, and/or second portion can enable small (e.g., smaller than about 10 mm or less) bend radii because the compressive stress from the chemical strengthening can counteract the bend-induced tensile stress on the outermost surface of the substrate or ribbon (e.g., third major surface 383 in FIG. 5, first major surface 203 shown in FIG. 6). A compressive stress region may extend into a portion of the substrate for a depth called the depth of compression. As used herein, depth of compression means the depth at which the stress in the chemically strengthened substrates described herein changes from compressive stress to tensile stress. Depth of compression may be measured by a surface stress meter or a scattered light polariscope (SCALP, wherein values reported herein were made using SCALP-5 made by Glasstress Co., Estonia) depending on the ion exchange treatment and the thickness of the article being measured. Where the stress in the substrate is generated by exchanging potassium ions into the substrate, a surface stress meter, for example, the FSM-6000 (Orihara Industrial Co., Ltd. (Japan)), is used to measure depth of compression. Unless specified otherwise, compressive stress (including surface CS) is measured by surface stress meter (FSM) using commercially available instruments, for example, the FSM-6000, manufactured by Orihara. Surface stress measurements rely upon the accurate measurement of the stress optical coefficient (SOC), which is related to the birefringence of the glass. Unless specified otherwise, SOC is measured according to Procedure C (Glass Disc Method) described in ASTM standard C770-16, entitled “Standard Test Method for Measurement of Glass Stress-Optical Coefficient,” the contents of which are incorporated herein by reference in their entirety. Where the stress is generated by exchanging sodium ions into the substrate, and the article being measured is thicker than about 75 μm, SCALP is used to measure the depth of compression and central tension (CT). Where the stress in the substrate is generated by exchanging both potassium and sodium ions into the glass, and the article being measured is thicker than about 75 μm, the depth of compression and CT are measured by SCALP. Without wishing to be bound by theory, the exchange depth of sodium may indicate the depth of compression while the exchange depth of potassium ions may indicate a change in the magnitude of the compressive stress (but not the change in stress from compressive to tensile). The refracted near-field (RNF; the RNF method is described in U.S. Pat. No. 8,854,623, entitled “Systems and methods for measuring a profile characteristic of a glass sample”, which is incorporated herein by reference in its entirety) method also may be used to derive a graphical representation of the stress profile. When the RNF method is utilized to derive a graphical representation of the stress profile, the maximum central tension value provided by SCALP is utilized in the RNF method. The graphical representation of the stress profile derived by RNF is force balanced and calibrated to the maximum central tension value provided by a SCALP measurement. As used herein, “depth of layer” (DOL) means the depth that the ions have exchanged into the substrate (e.g., sodium, potassium). Through the disclosure, when the central tension cannot be measured directly by SCALP (as when the article being measured is thinner than about 75 μm) the maximum central tension can be approximated by a product of a maximum compressive stress and a depth of compression divided by the difference between the thickness of the substrate and twice the depth of compression, wherein the compressive stress and depth of compression are measured by FSM.

In aspects, the ribbon 201 or the first substrate 371 may be chemically strengthened to form a first compressive stress region extending to a first depth of compression from the first major surface 203 or 373. In further aspects, the first compressive stress region can extend from one or more portions of the first major surface 203 comprising the first surface area 223 and/or the third surface area 233. In aspects, the ribbon 201 or the first substrate 371 may be chemically strengthened to form a second compressive stress region extending to a second depth of compression from the second major surface 205 or 375. In further aspects, the second compressive stress region can extend from one or more portions of the second major surface 205 comprising the second surface area 225 and/or the fourth surface area 235. In even further aspects, the first depth of compression (e.g., from the first major surface 203 or 373) and/or second depth of compression (e.g., from the second major surface 205 or 375) as a percentage of the ribbon thickness 227 or the substrate thickness 377 can be about 1% or more, about 5% or more, about 10% or more, about 30% or less, about 25% or less, or about 20% or less. In even further aspects, the first depth of compression and/or the second depth of compression as a percentage of the ribbon thickness 227 or the substrate thickness 377 can be in a range from about 1% to about 30%, from about 1% to about 25%, from about 5% to about 25%, from about 5% to about 20%, from about 10% to about 20%, or any range or subrange therebetween. In aspects, the first depth of compression and/or the second depth of compression can be about 1 μm or more, about 10 μm or more, about 50 μm or more, about 200 μm or less, about 150 μm or less, or about 100 μm or less. In aspects, the first depth of compression and/or the second depth of compression can be in a range from about 1 μm to about 200 μm, from about 1 μm to about 150 μm, from about 10 μm to about 150 μm, from about 50 μm to about 150 μm, from about 50 μm to about 100 μm, or any range or subrange therebetween. In aspects, the first depth of compression can be greater than, less than, or substantially the same as the second depth of compression. By providing a glass-based substrate and/or a ceramic-based substrate comprising a first depth of compression and/or a second depth of compression in a range from about 1% to about 30% of the first thickness, good impact and/or puncture resistance can be enabled.

In aspects, the first compressive stress region can comprise a maximum first compressive stress. In aspects, the second compressive stress region can comprise a maximum second compressive stress. In further aspects, the maximum first compressive stress and/or the maximum second compressive stress can be about 100 MegaPascals (MPa) or more, about 300 MPa or more, about 500 MPa or more, about 700 MPa or more, about 1,500 MPa or less, about 1,200 MPa or less, about 1,000 MPa or less, or about 900 MPa or less. In further aspects, the maximum first compressive stress and/or the maximum second compressive stress can be in a range from about 100 MPa to about 1,500 MPa, from about 100 MPa to about 1,200 MPa, from about 300 MPa to about 1,200 MPa, from about 300 MPa to about 1,000 MPa, from about 500 MPa to about 1,000 MPa, from about 700 MPa to about 1,000 MPa, from about 700 MPa to about 900 MPa, or any range or subrange therebetween. Providing a maximum first compressive stress and/or a maximum second compressive stress in a range from about 100 MPa to about 1,500 MPa can enable good impact and/or puncture resistance.

In aspects, the ribbon 201 may be chemically strengthened to form a first central compressive stress region extending to a first central depth of compression from the first central surface area 211. In aspects, the ribbon 201 may be chemically strengthened to form a second central compressive stress region extending to a second central depth of compression from the second central surface area 213. In further aspects, the first central depth of compression and/or the second central depth of compression can be about 1 μm or more, about 10 μm or more, about 30 μm or more, about 50 μm or more, about 200 μm or less, about 150 μm or less, about 100 μm or less, or about 60 μm or less. In further aspects, the first central depth of compression and/or the second central depth of compression can be in a range from about 1 μm to about 200 μm, from about 1 μm to about 150 μm, from about 10 μm to about 150 μm, from about 10 μm to about 100 μm, from about 30 μm to about 100 μm, from about 30 μm to about 60 μm, from about 50 μm to about 60 μm, or any range or subrange therebetween. In further aspects, the first central depth of compression and/or the second central depth of compression as a percentage of the central thickness 217 can be within one or more of the ranges discussed above for the first depth of compression as a percentage of the ribbon thickness 227. In further aspects, the first central compressive stress region can comprise a maximum first central compressive stress. In further aspects, the second central compressive stress region can comprise a maximum second central compressive stress. In even further aspects, the maximum first central compressive stress and/or the maximum second central compressive stress can be within one or more of the ranges discussed above for the maximum first compressive stress and/or the maximum second compressive stress.

In further aspects, the first portion 321 and/or the second portion 331 can comprise a glass-based substrate or a ceramic-based substrate. In even further aspects, the first portion 321 can be chemically strengthened to form a fifth compressive stress region extending to a fifth depth of compression from the first surface area 323, the second surface area 325, and/or the first edge surface area 329. In even further aspects, the second portion 331 can be chemically strengthened to form a sixth compressive stress region extending to a sixth depth of compression from the third surface area 333, the fourth surface area 335, and/or the second edge surface area 339. In still further aspects, the fifth depth of compression and/or sixth depth of compression can be within one or more of the ranges discussed above for the first depth of compression. In still further aspects, the fifth depth of compression and/or sixth depth of compression as a percentage of the first portion thickness 327 can be within one or more of the ranges discussed above for the first depth of compression as a percentage of the substrate thickness. In still further aspects, the fifth compressive stress can comprise a maximum fifth compressive stress, and/or the sixth compressive stress region can comprise a maximum sixth compressive stress. In yet further aspects, the maximum fifth compressive stress and/or the maximum sixth compressive stress can be within one or more of the ranges discussed above for the maximum first compressive stress. In aspects, the first portion 321 and/or the second portion 331 can be substantially unstrengthened. As used herein, substantially unstrengthened refers to a substrate comprising either no depth of compression or a depth of compression in a range from 0% to about 5% of the substrate thickness.

In aspects, the second substrate 381 can comprise a glass-based substrate or a ceramic-based substrate. In further aspects, the third major surface 383 can be chemically strengthened to form a third compressive stress region extending to a third depth of compression from the third major surface 383. In further aspects, the fourth major surface 385 can be chemically strengthened to form a fourth compressive stress region extending to a fourth depth of compression from the fourth major surface 385. In even further aspects, the third depth of compression and/or fourth depth of compression can be within one or more of the ranges discussed above for the first depth of compression. In even further aspects, the third depth of compression and/or fourth depth of compression as a percentage of the second substrate thickness 387 can be within one or more of the ranges discussed above for the first depth of compression as a percentage of the substrate thickness. In still further aspects, the third compressive stress can comprise a maximum third compressive stress, and/or the fourth compressive stress region can comprise a maximum fourth compressive stress. In yet further aspects, the maximum third compressive stress and/or the maximum fourth compressive stress can be within one or more of the ranges discussed above for the maximum first compressive stress. In aspects, the second substrate 381 can be substantially unstrengthened.

In aspects, as shown in FIGS. 2-3, the foldable apparatus 101 and/or 301 can comprise a polymer-based portion 241. In further aspects, the polymer-based portion 241 can comprise the polymer-based portion described above. In further aspects, the polymer-based portion 241 can comprise an elastic modulus within one or more of the ranges discussed above for the elastic modulus of the polymer-based portion. In further aspects, the polymer-based portion 241 can comprise a glass transition temperature (Tg), tensile strength, ultimate elongation, and/or index of refraction within one or more of the corresponding ranges discussed above for the polymer-based portion. In further aspects, the polymer-based portion 241 comprises a polymer (e.g., optically transparent polymer). In further aspects, the polymer-based portion 241 can comprise one or more of an optically transparent: an acrylic (e.g., polymethylmethacrylate (PMMA)), an epoxy, silicone, and/or a polyurethane. Examples of epoxies include bisphenol-based epoxy resins, novolac-based epoxies, cycloaliphatic-based epoxies, and glycidylamine-based epoxies. In further aspects, the polymer-based portion 241 can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and/or polyether ether ketone (PEEK). Example aspects of polyolefins include low molecular weight polyethylene (LDPE), high molecular weight polyethylene (HDPE), ultrahigh molecular weight polyethylene (UHMWPE), and polypropylene (PP). Example aspects of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example aspects of elastomers include rubbers (e.g., polybutadiene, polyisoprene, chloroprene rubber, butyl rubber, nitrile rubber), polyurethanes, and block copolymers (e.g., styrene-butadiene, high-impact polystyrene, polydichlorophosphazene) comprising one or more of polystyrene, polydichlorophosphazene, and/or poly(5-ethylidene-2-norbornene). In aspects, the polymer-based portion 241 can further comprise nanoparticles, for example, carbon black, carbon nanotubes, silica nanoparticles, or nanoparticles comprising a polymer. In aspects, the polymer-based portion can further comprise fibers to form a polymer-fiber composite.

In aspects, as shown in FIG. 2, the polymer-based portion can be at least partially positioned in the recess 219 defined between the first plane 204a defined by the first major surface 203 and a third plane 204c defined by the first central surface area 211. In further aspects, as shown, the polymer-based portion 241 can fill the recess 219 while also extending beyond the recess 219. In further aspects, although not shown, the recess may not be totally filled, for example, to leave room for electronic devices and/or mechanical devices. In aspects, as shown in FIG. 2, the first contact surface 245 of the polymer-based portion 241 can face the first central surface area 211 of the ribbon 201. In further aspects, as shown, the first contact surface 245 of the polymer-based portion 241 can contact and/or be attached to the first central surface area 211 of the ribbon 201. In aspects, as shown in FIG. 2, the polymer-based portion 241 can contact and/or be attached to the first transition surface area 215 and/or the second transition surface area 229. In aspects, as shown in FIG. 2, the first contact surface 245 of the polymer-based portion 241 can face, contact, and/or be attached to the first major surface 203 (e.g., first surface area 223, third surface area 233) of the ribbon 201.

In even further aspects, as shown in FIG. 2, a polymer thickness 257 of the polymer-based portion 241 can be defined as a minimum distance between the first contact surface 245 and the second contact surface 247, which corresponds to a minimum distance between the first major surface 203 (e.g., first plane 204a) and the second contact surface 247 of the polymer-based portion 241. In still further aspects, the polymer thickness 257 can be about 1 μm or more, about 5 μm or more, about 10 μm or more, about 15 μm or more, about 20 μm or more, about 60 μm or less, about 40 μm or less, about 30 μm or less, about 25 μm or less, about 20 μm or less, or about 10 μm or less. In still further aspects, the polymer thickness 257 can be in a range from about 1 μm to about 60 μm, from about 1 μm to about 40 μm, from about 1 μm to about 30 μm, from about 1 μm to about 25 μm, from about 1 μm to about 20 μm, from about 1 μm to about 10 μm, from about 5 μm to about 10 μm, or any range or subrange therebetween. In still further aspects, the polymer thickness 257 can be in a range from about 5 μm to about 40 μm, from about 5 μm to about 30 μm, from about 5 μm to about 25 μm, from about 5 μm to about 20 μm, from about 10 μm to about 20 μm, from about 15 μm to about 20 μm, or any range or subrange therebetween. In still further aspects, the polymer thickness 257 can be in a range from about 10 μm to about 60 μm, from about 10 μm to about 40 μm, from about 10 μm to about 30 μm, from about 10 μm to about 25 μm, from about 15 μm to about 25 μm, from about 20 μm to about 25 μm, or any range or subrange therebetween. In still further aspects, the polymer thickness 257 can be in a range from about 20 μm to about 40 μm, from about 20 μm to about 30 μm, from about 20 μm to about 25 μm, or any range or subrange therebetween.

In aspects, as shown in FIG. 3, the polymer-based portion 241 can be at least partially positioned between the first edge surface area 329 of the first portion 321 and the second edge surface area 339 of the second portion 331. In further aspects, as shown, the polymer-based portion 241 can contact and/or be attached to the first edge surface area 329 and/or the second edge surface area 339. In further aspects, as shown, the polymer-based portion 241 can completely fill a region between the first edge surface area 329 and the second edge surface area 339 bounded by a first plane (e.g., line 319b) extending between the first surface area 323 and the third surface area 333 and a second plane (e.g., line 313b) extending between the second surface area 325 and the fourth surface area 335. In further aspects, as shown, the first contact surface 345 can extend along the second plane (e.g., line 313b) extending between the second surface area 325 and the fourth surface area 335. In further aspects, as indicated by the lines 313a-c in FIG. 3, the polymer-based portion may occupy a central region 315. In further aspects, as shown in FIG. 3, the polymer-based portion 241 can contact and/or be attached to the first surface area 323 and/or the third surface area 333. In even further aspects, as shown, a polymer thickness 357 of the polymer-based portion 241 can be defined as a minimum distance between the first surface area 323 of the first portion 321 and the second contact surface 247 in a direction 202 of the first portion thickness 327, which corresponds to a minimum distance between the first plane (e.g., line 319b) and the second contact surface 347 of the polymer-based portion 241. In still further aspects, the polymer thickness 357 can be within one or more of the ranges discussed above for the polymer thickness 257. In further aspects, as shown in FIG. 3, the second contact surface 347 of the polymer-based portion 241 can face the second major surface 375 of the first substrate 371 and/or the sixth major surface 305 of the display device 307. In even further aspects, as shown, the second contact surface 347 of the polymer-based portion 241 can contact and/or be attached to the second major surface 375 of the first substrate 371. In further aspects, although not shown, the polymer-based portion can occupy a central portion 317 bounded by lines 319a-c without contacting the first surface area 323 and/or the third surface area 333.

In aspects, as shown in FIG. 3, the foldable apparatus 301 can comprise an adhesive layer 261. In aspects, the adhesive layer 261 can comprise one or more of a polyolefin, a polyamide, a halide-containing polymer (e.g., polyvinylchloride or a fluorine-containing polymer), an elastomer, a urethane, phenolic resin, parylene, polyethylene terephthalate (PET), and polyether ether ketone (PEEK). Example aspects of polyolefins include low molecular weight polyethylene (LDPE), high molecular weight polyethylene (HDPE), ultrahigh molecular weight polyethylene (UHMWPE), and polypropylene (PP). Example aspects of fluorine-containing polymers include polytetrafluoroethylene (PTFE), polyvinylfluoride (PVF), polyvinylidene fluoride (PVDF), perfluoropolyether (PFPE), perfluorosulfonic acid (PFSA), a perfluoroalkoxy (PFA), fluorinated ethylene propylene (FEP) polymers, and ethylene tetrafluoro ethylene (ETFE) polymers. Example aspects of elastomers include rubbers (e.g., polybutadiene, polyisoprene, chloroprene rubber, butyl rubber, nitrile rubber) and block copolymers (e.g., styrene-butadiene, high-impact polystyrene, poly(dichlorophosphazene). In further aspects, the adhesive layer 261 can comprise an optically clear adhesive. In even further aspects, the optically clear adhesive can comprise one or more optically transparent polymers: an acrylic (e.g., polymethylmethacrylate (PMMA)), an epoxy, silicone, and/or a polyurethane.

Examples of epoxies include bisphenol-based epoxy resins, novolac-based epoxies, cycloaliphatic-based epoxies, and glycidylamine-based epoxies. In even further aspects, the optically clear adhesive can comprise, but is not limited to, acrylic adhesives, for example, 3M 8212 adhesive, or an optically transparent liquid adhesive, for example, a LOCTITE optically transparent liquid adhesive. Exemplary aspects of optically clear adhesives comprise transparent acrylics, epoxies, silicones, and polyurethanes. For example, the optically transparent liquid adhesive could comprise one or more of LOCTITE AD 8650, LOCTITE AA 3922, LOCTITE EA E-05MR, LOCTITE UK U-09LV, which are all available from Henkel.

In aspects, as shown in FIG. 3, the adhesive layer 261 can comprise a third contact surface 263 and a fourth contact surface 265 opposite the third contact surface 263. In further aspects, an adhesive thickness 267 of the adhesive layer 261 can be defined as a minimum distance between the third contact surface 263 and a fourth contact surface 265 (e.g., in the direction 202). In even further aspects, the adhesive thickness 267 of the adhesive layer 261 can be within one or more of the ranges discussed above for the polymer thickness 357. In further aspects, as shown, the third contact surface 263 can face, contact, and/or be attached to the third major surface 383 of the second substrate 381. In further aspects, as shown, the fourth contact surface 265 can face, contact, and/or be attached to the second surface area 325 of the first portion 321 and/or the fourth surface area 335 of the second portion 331. In even further aspects, as shown, the fourth contact surface 265 can face, contact, and/or be attached to the first contact surface 345 of the polymer-based portion. In further aspects, as indicated by lines 313a-c, although not shown, the polymer-based portion 241 can be positioned in the central region 315 rather than the adhesive layer 261. In further aspects, although not shown, the polymer-based portion can occupy the region shown as occupied by the adhesive layer in FIG. 3.

In aspects, as shown in FIG. 3, the foldable apparatus 301 can comprise a second adhesive layer 361. In further aspects, the second adhesive layer 361 can comprise a second thickness 367 defined as a minimum distance between a fifth contact surface 363 of the second adhesive layer 361 and a sixth contact surface 365 of the second adhesive layer 361 opposite the fifth contact surface 363. In even further aspects, the second thickness 367 can be within one or more of the ranges discussed above for the polymer thickness 357. In even further aspects, as shown, the fifth contact surface 363 of the second adhesive layer 361 can face, contact, and/or be attached to the sixth major surface 305 of the display device 307. In even further aspects, as shown, the sixth contact surface 365 of the second adhesive layer 361 can face, contact, and/or be attached to the first major surface 373 of the first substrate 371.

The ribbon 201 or the first substrate 371 can comprise a second index of refraction. In aspects, an index of refraction of the ribbon 201 or the first substrate 371 may be about 1.4 or more, about 1.45 or more, about 1.49 or more, about 1.50 or more, about 1.53 or more, about 1.6 or less, about 1.55 or less, about 1.54 or less, or about 1.52 or less. In aspects, the index of refraction of the ribbon 201 or the first substrate 371 can be in a range from about 1.4 to about 1.6, from about 1.45 to about 1.6, from about 1.45 to about 1.55, from about 1.49 to about 1.55, from about 1.50 to about 1.55, from about 1.53 to about 1.55, from about 1.49 to about 1.54, from about 1.49 to about 1.52, or any range or subrange therebetween. The polymer-based portion 241 can comprise a first index of refraction, which can be within one or more of the ranges discussed above for the index of refraction of the polymer-based portion 241. Throughout the disclosure, a magnitude of a difference between two values or an absolute difference between two values is the absolute value of the difference between the two values. In aspects, an absolute difference between the first index of refraction of the polymer-based portion 241 and the second index of refraction of the ribbon 201 or the first substrate 371 can be about 0.01 or less, about 0.008 about 0.005 or less, about 0.004 or less, about 0.001 or more, about 0.002 or more, or about 0.003. In aspects, an absolute difference between the first index of refraction of the polymer-based portion 241 and the second index of refraction of the ribbon 201 or the first substrate 371 can be in a range from about 0.001 to about 0.01, from about 0.001 to about 0.008, from about 0.002 to about 0.008, from about 0.002 to about 0.005, from about 0.003 to about 0.005, from about 0.003 to about 0.004, or any range or subrange therebetween. In aspects, the first surface index of refraction can be greater than the central index of refraction. In further aspects, the difference between the first index of refraction of the polymer-based portion 241 and the second index of refraction of the ribbon 201 or the first substrate 371 can be measured at 589 nm and can be within one or more of the above ranges. In further aspects, the first index of refraction of the polymer-based portion 241 and the second index of refraction of the ribbon 201 or the first substrate 371 can be averaged over optical wavelengths from 400 nm to 700 nm (analogous to transmittance) and can be within or more of the above ranges.

In aspects, as shown in FIG. 2, the foldable apparatus 101 can comprise a release liner 271 although other substrates (e.g., a glass-based substrate and/or a ceramic-based substrate discussed throughout the application with reference to FIG. 3, for example, first substrate 371 or second substrate 381) may be used in further aspects rather than the illustrated release liner 271. In aspects, as shown in FIG. 2, the release liner 271 can comprise a fifth major surface 273 and a sixth major surface 275 opposite the fifth major surface 273. In further aspects, as shown, the sixth major surface 275 of the release liner 271 can face the first major surface 203 and/or the first central surface area 211 of the ribbon 201. In further aspects, as shown, the sixth major surface 275 of the release liner 271 can face, contact, and/or be attached to the second contact surface 247 of the polymer-based portion 241. In further aspects, the fifth major surface 273 of the release liner 271 can comprise a planar surface, and/or the sixth major surface 275 of the release liner 271 can comprise a planar surface. In further aspects, the release liner 271 can comprise a paper and/or a polymer. Exemplary aspects of paper comprise kraft paper, machine-finished paper, poly-coated paper (e.g., polymer-coated, glassine paper, siliconized paper), or clay-coated paper. Exemplary aspects of polymers comprise polyesters (e.g., polyethylene terephthalate (PET)) and polyolefins (e.g., low-density polyethylene (LDPE), high-density polyethylene (HDPE), polypropylene (PP)).

In aspects, as shown in FIG. 3, the fifth major surface 303 of the display device 307 can comprise a planar surface. In further aspects, as shown, the sixth major surface 305 of the display device 307 can comprise a planar surface. In further aspects, as shown, sixth major surface 305 of the display device 307 can face the first major surface 373 of the first substrate 371, the first surface area 323 of the first portion 321, the third surface area 333 of the second portion 331, the second contact surface 347 of the polymer-based portion 241, and/or the third major surface 383 of the second substrate 381. In further aspects, as shown, the sixth major surface 305 of the display device 307 can face, contact, and/or be attached to fifth contact surface 363 of the second adhesive layer 361. In further aspects, the display device 307 can comprise a liquid crystal display (LCD), an electrophoretic display (EPD), an organic light-emitting diode (OLED) display, or a plasma display panel (PDP). In aspects, the display device 307 can be part of a portable electronic device, for example, a consumer electronic product, a smartphone, a tablet, a wearable device, or a laptop.

Aspects of the disclosure can comprise a consumer electronic product. The consumer electronic product can comprise a front surface, a back surface, and side surfaces. The consumer electronic product can further comprise electrical components at least partially within the housing. The electrical components can comprise a controller, a memory, and a display. The display can be at or adjacent the front surface of the housing. The consumer electronic product can comprise a cover substrate disposed over the display. In aspects, at least one of a portion of the housing or the cover substrate comprises the polymer-based portion and/or foldable apparatus discussed throughout the disclosure. The display can comprise a liquid crystal display (LCD), an electrophoretic display (EPD), an organic light-emitting diode (OLED) display, or a plasma display panel (PDP). In aspects, the consumer electronic product can be a portable electronic device, for example, a smartphone, a tablet, a wearable device, or a laptop.

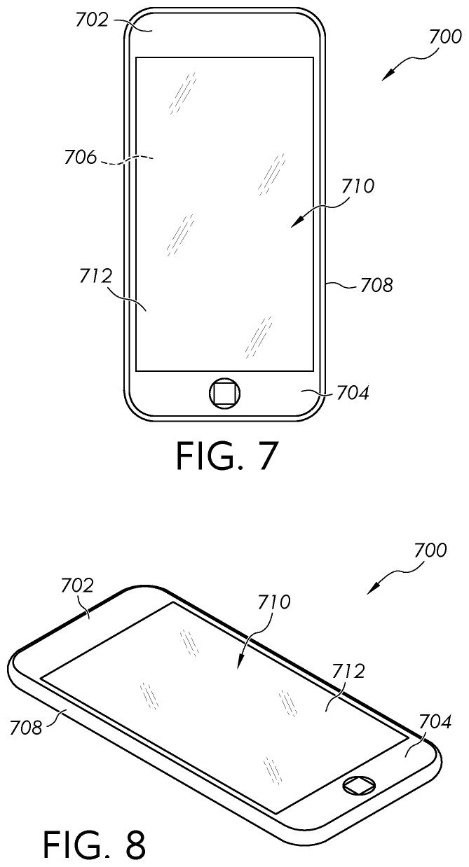

The polymer-based portion and/or foldable apparatus disclosed herein may be incorporated into another article, for example, an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc.), appliance articles, or any article that may benefit from some transparency, scratch-resistance, abrasion resistance or a combination thereof. An exemplary article incorporating any of the polymer-based portion and/or foldable apparatus disclosed herein is shown in FIGS. 7 and 8. Specifically, FIGS. 7 and 8 show a consumer electronic device 700 including a housing 702 having a front surface 704, a back surface 706, and side surfaces 708. The consumer electronic device 700 can comprise electrical components (not shown) that are at least partially inside or entirely within the housing and including at least a controller, a memory, and a display 710 at or adjacent to the front surface of the housing. The consumer electronic device 700 can comprise a cover substrate 712 at or over the front surface of the housing such that it is over the display. In aspects, at least one of the cover substrate 712 or a portion of housing 702 may include any of the polymer-based portion and/or foldable apparatus disclosed herein.

Throughout the disclosure, with reference to FIG. 1, the width 103 of the foldable apparatus 101 and/or 301 is considered the dimension of the foldable apparatus taken between opposed edges of the foldable apparatus in a direction 104 of a fold axis 102 of the foldable apparatus, wherein the direction 104 also comprises the direction of the width 103. Furthermore, throughout the disclosure, the length 105 of the foldable apparatus 101 and/or 301 is considered the dimension of the foldable apparatus 101 and/or 301 taken between opposed edges of the foldable apparatus in a direction 106 perpendicular to the fold axis 102 of the foldable apparatus. In aspects, as shown in FIGS. 1-2, the foldable apparatus of any aspects of the disclosure can comprise a fold plane 109 that includes the fold axis 102 when the foldable apparatus is in the flat configuration (e.g., see FIG. 1). In further aspects, as shown in FIG. 2, the fold plane 109 can extend in the direction 202 of the ribbon thickness 227 when the foldable apparatus is in the flat configuration (e.g., see FIG. 2). The fold plane 109 may comprise a central axis 107 of the foldable apparatus, which can be positioned at the second major surface 205 as shown in FIG. 2. In aspects, the foldable apparatus can be folded in a direction 111 (e.g., see FIG. 1) about the fold axis 102 extending in the direction 104 of the width 103 to form a folded configuration (e.g., see FIGS. 4-6). As shown, the foldable apparatus may include a single fold axis to allow the foldable apparatus to comprise a bifold wherein, for example, the foldable apparatus may be folded in half. In further aspects, the foldable apparatus may include two or more fold axes. For example, providing two fold axes can allow the apparatus to comprise a trifold.

FIGS. 4-6 schematically illustrate example aspects of the foldable apparatus 401 and/or 601 in accordance with aspects of the disclosure in the folded configuration. In aspects, as shown in FIG. 5, the fourth major surface 385 of the second substrate 381 can be on the inside of the folded foldable apparatus 401. A user would view a device containing the foldable apparatus 401 through the substrate (e.g., second substrate 381) and, thus, would be viewing from the side of the fourth major surface 385 of the second substrate 381, for example, if a display device (e.g., display device 307) is mounted in place of PET sheet 507. In aspects, as shown in FIG. 6, the second major surface 205 of the ribbon 201 can be on the inside of the folded foldable apparatus 601. A user would view a device containing the foldable apparatus 601 through the ribbon 201 and, thus, would be viewing from the side of the second major surface 205 of the ribbon 201, for example, if a display device (e.g., display device 307) is mounted in place of PET sheet 507. Although not shown, the foldable apparatus can be folded such that the ribbon 201 or second substrate 381 is on the outside of the folded foldable apparatus. A user would view a device containing the foldable apparatus through the ribbon 201 or second substrate 381 and, thus, would be viewing from the side of the second major surface 205 of the ribbon 201 and/or the fourth major surface 385 of the second substrate 381.

As used herein, “foldable” includes complete folding, partial folding, bending, flexing, or multiple capabilities. As used herein, the terms “fail,” “failure” and the like refer to breakage, destruction, delamination, or crack propagation. A substrate (e.g., substrate, foldable apparatus, polymer-based portion) achieves a parallel plate distance of “X” or has a parallel plate distance of “X” if it resists failure when the substrate is held at a parallel plate distance of “X” for 24 hours at about 60° C. and about 90% relative humidity.

As used herein, the “parallel plate distance” of a foldable apparatus is measured with the following test configuration and process using a parallel plate apparatus 501 (see FIGS. 5-6) that comprises a pair of parallel rigid stainless-steel plates 503 and 505 comprising a first rigid stainless-steel plate 503 and a second rigid stainless-steel plate 505. When measuring the “parallel plate distance” for the foldable apparatus 101, as shown in FIG. 6, the foldable apparatus 101 of FIG. 2 is modified to form the foldable apparatus 601 by replacing the material beyond the second contact surface 247 of the polymer-based portion 241, namely, replacing the release liner 271, with a 100 μm thick sheet of poly(ethylene terephthalate) 507. When measuring the “parallel plate distance” for the foldable apparatus 301, as shown in FIG. 5, the foldable apparatus 301 is modified to form the foldable apparatus 401 by replacing the material beyond the second contact surface 347 of the polymer-based portion 241, namely replacing the first substrate 371, the second adhesive layer 361, and the display device 307, with a 100 μm thick sheet of poly(ethylene terephthalate) 507. As shown in FIGS. 5-6, the foldable apparatus 401 and/or 601 is placed between the pair of parallel rigid stainless-steel plates 503 and 505. As shown in FIG. 5, the foldable apparatus 401 is placed between the pair of parallel rigid stainless-steel plates 503 and 505 such that the second major surface 205 of the ribbon 201 is on the inside of the bend (e.g., facing one another) while the 100 μm thick sheet of poly(ethylene terephthalate) 507 faces and/or contacts the pair of parallel rigid stainless-steel plates 503 and 505. As shown in FIG. 6, the foldable apparatus 601 is placed between the pair of parallel rigid stainless-steel plates 503 and 505 such that the second substrate 381 is on the inside of the bend (e.g., facing itself) while the 100 μm thick sheet of poly(ethylene terephthalate) 507 faces and/or contacts the pair of parallel rigid stainless-steel plates 503 and 505. The distance between the parallel plates is reduced at a rate of 50 μm/second until the parallel plate distance 511 is equal to the “parallel plate distance” to be tested. Then, the parallel plates are held at the parallel plate distance to be tested for 24 hours at about 60° C. and about 90% relative humidity. As used herein, the “minimum parallel plate distance” is the smallest parallel plate distance that the substrate (e.g., substrate, foldable apparatus, polymer-based portion) can withstand without failure under the conditions and configuration described above.

For determining the parallel plate distance or the minimum parallel plate distance of the polymer-based portion, the first contact surface of the polymer-based portion is attached to a 30 μm thick glass-based substrate and the second major surface of the polymer-based portion is attached to a 100 μm thick sheet of poly(ethylene terephthalate) (e.g., PET sheet 507) that is formed into a foldable apparatus by hot pressing at 180° C. for 1 hour. For determining a parallel plate distance for a polymer-based portion (e.g., polymer-based portion 241), the 30 μm thick glass-based material comprises a composition, nominally, in mol % of: 69.1 SiO₂; 10.2 Al₂O₃; 15.1 Na₂O; 0.01 K₂O; 5.5 MgO; 0.09 SnO₂. The foldable apparatus formed from the polymer-based portion is then configured with the 100 μm thick PET sheet contacting the pair of parallel rigid stainless-steel plates. The distance between the parallel plates is reduced at a rate of 50 μm/second until the parallel plate distance is equal to the “parallel plate distance” to be tested. Then, the parallel plates are held at the parallel plate distance to be tested for 24 hours at about 60° C. and about 90% relative humidity.

In aspects, the foldable apparatus 101, 301, 401, and/or 601 and/or the polymer-based portion can achieve a parallel plate distance of 100 mm or less, 50 mm or less, 20 mm or less, or 10 mm or less. In further aspects, the foldable apparatus can achieve a parallel plate distance of 10 millimeters (mm), or 7 mm, or 5 mm, 4 mm, 3 mm, 2 mm, or 1 mm. In aspects, the foldable apparatus 101, 301, 401, and/or 601 and/or the polymer-based portion can comprise a parallel plate distance of about 10 mm or less, about 7 mm or less, about 5 mm or less, about 4 mm or less, about 1 mm or more, about 2 mm or more, or about 3 mm or more. In aspects, the foldable apparatus 101, 301, 401, and/or 601 and/or the polymer-based portion can comprise a parallel plate distance in a range from about 1 mm to about 10 mm, from about 2 mm to about 10 mm, from about 13 mm to about 10 mm, from about 3 mm to about 7 mm, from about 3 mm to about 5 mm, from about 3 mm to about 4 mm, or any range or subrange therebetween.

In aspects, the foldable apparatus 101, 301, 401, and/or 601 and/or the polymer-based portion can withstand a cyclic bending test. As used herein, the cyclic bending test comprises placing a testing apparatus comprising the material to be tested in the parallel plate apparatus 501 (see FIGS. 5-6) and bending the foldable apparatus, as described above for the parallel plate test, to achieve a predetermined parallel plate distance, between plates 503, 505 a predetermined number of times at 23° C. with a relative humidity of 50%. The testing apparatus comprises attaching the second contact surface 247 and/or 347 of the polymer-based portion 241 of the foldable apparatus to be tested to a 100 μm thick poly(ethylene terephthalate) sheet 507 as discussed above for the parallel plate distance, where the sheet 507 faces the pair of rigid stainless-steel plates 503, 505. In aspects, the foldable apparatus 101, 301, 401, and/or 601 and/or the polymer-based portion can withstand 2,000 bending cycles at a parallel plate distance of 3 millimeters. In further aspects, the foldable apparatus 101, 301, 401, and/or 601 and/or the polymer-based portion can withstand 20,000 bending cycles at a parallel plate distance of 3 millimeters. In even further aspects, the foldable apparatus 101, 301, 401, and/or 601 and/or the polymer-based portion can withstand 200,000 bending cycles at a parallel plate distance of 3 millimeters. In aspects, the foldable apparatus 101, 301, 401, and/or 601 and/or the polymer-based portion can withstand 2,000 bending cycles at a parallel plate distance of 4 millimeters. In further aspects, the foldable apparatus 101, 301, 401, and/or 601 and/or the polymer-based portion can withstand 20,000 bending cycles at a parallel plate distance of 4 millimeters. In even further aspects, the foldable apparatus 101, 301, 401, and/or 601 and/or the polymer-based portion can withstand 200,000 bending cycles at a parallel plate distance of 4 millimeters.

The foldable apparatus 101, 301, 401, and/or 601 may have an impact resistance defined by the capability of the polymer-based portion and/or foldable apparatus to avoid failure at a pen drop height (e.g., 5 centimeters (cm) or more, 8 cm or more, 10 cm or more, 12 cm or more, 15 cm or more), when measured according to the “Pen Drop Test.” As used herein, the “Pen Drop Test” is conducted such that samples are tested with the load (i.e., from a pen dropped from a certain height) imparted to an outer surface (e.g., second major surface 205 of the ribbon 201 shown in FIG. 2, fourth major surface 385 of the second substrate 381 shown in FIG. 3) of the polymer-based portion and/or foldable apparatus configured as in the parallel plate test. During testing, the foldable apparatus is placed on an aluminum plate (6063 aluminum alloy, as polished to a surface roughness with 400 grit paper). No tape is used on the side of the sample resting on the aluminum plate.

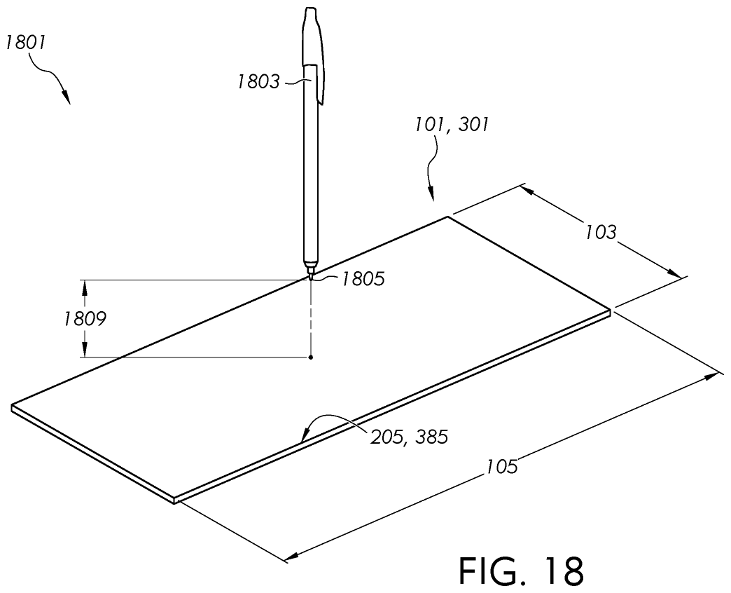

Referring to FIG. 18, in the Pen Drop test 1801, the pen 1803 employed is a BIC Easy Glide Pen, Fine comprising a tungsten carbide ballpoint tip 1805 of 0.7 mm (0.68 mm) diameter, and a weight of 5.73 grams (g) including the cap (4.68 g without the cap). The ballpoint pen 1803 is held at a predetermined height 1809 from an outer surface (e.g., second major surface 205 of the ribbon 201 shown in FIG. 2, fourth major surface 385 of the second substrate 381 shown in FIG. 3) of the foldable apparatus. A tube (not shown) is used for the Pen Drop Test 1801 to guide the ballpoint pen 1803 to the outer surface (e.g., second major surface 205, fourth major surface 385) of the sample, and the tube is placed in contact with the outer surface of the foldable apparatus so that the longitudinal axis of the tube is substantially perpendicular to the outer surface of the foldable apparatus. The tube has an outside diameter of 1 inch (2.54 cm), an inside diameter of nine-sixteenths of an inch (1.4 cm), and a length of 90 cm. An acrylonitrile butadiene (“ABS”) shim (not shown) is employed to hold the ballpoint pen 1803 at a predetermined height 1809 for each test. After each drop, the tube is relocated relative to the outer surface of the sample to be tested to guide the ballpoint pen 1803 to a different impact location on the outer surface of the sample to be tested. It is to be understood that the Pen Drop Test can 1801 be used for any of the foldable apparatus and/or polymer-based portions of aspects of the disclosure.

When performing the Pen Drop test on a foldable apparatus 101 and/or 301 shown in FIGS. 2-3) as described for determining the parallel plate distance, the foldable apparatus 101 of FIG. 2 is modified by replacing the material beyond the second contact surface 347 of the polymer-based portion 241, with a 100 μm thick sheet of poly(ethylene terephthalate) 507. Then, the outer surface that the pen is dropped on is opposite the 100 μm thick sheet of poly(ethylene terephthalate). When performing the Pen Drop test on a polymer-based portion (e.g., polymer-based portion 241), the first contact surface is attached of the polymer-based portion to a 30 μm thick glass-based material (e.g., ribbon 201, first substrate 371, second substrate 381), and the second contact surface of the polymer-based portion is attached to the 100 μm thick sheet of poly(ethylene terephthalate). For performing the Pen Drop Test for a polymer-based portion, the 30 μm thick glass-based material comprises a composition, nominally, in mol % of: 69.1 SiO₂; 10.2 Al₂O₃; 15.1 Na₂O; 0.01 K₂O; 5.5 MgO; 0.09 SnO₂. The combined 30 μm thick glass-based substrate, the polymer-based portion, and the 100 μm thick sheet of poly(ethylene terephthalate) are formed into a foldable apparatus by hot pressing at 180° C. for 1 hour. Then, the outer surface that the pen is dropped on is opposite the 100 μm thick sheet of poly(ethylene terephthalate), namely, an outer surface of the glass-based substrate.

For the Pen Drop Test 1801, the ballpoint pen 1803 is dropped with the cap attached to the top end (i.e., the end opposite the tip) so that the ballpoint tip 1805 can interact with the outer surface (e.g., second major surface 205 of the ribbon 201 shown in FIG. 2, fourth major surface 385 of the second substrate 381 shown in FIG. 3) of the coating. In a drop sequence according to the Pen Drop Test, one pen drop is conducted at an initial height of 1 cm, followed by successive drops in 0.5 cm increments up to 20 cm, and then after 20 cm, 2 cm increments until failure of the sample to be tested. After each drop is conducted, the presence of any observable fracture, failure, or other evidence of damage to the foldable apparatus is recorded along with the particular predetermined height for the pen drop. Using the Pen Drop Test, multiple samples can be tested according to the same drop sequence to generate a population with improved statistical accuracy. For the Pen Drop Test, the ballpoint pen is to be changed to a new pen after every 5 drops, and for each new foldable apparatus tested. In addition, all pen drops are conducted at random locations on the foldable apparatus at or near the center of the foldable apparatus unless indicated otherwise, with no pen drops near or on the edge of the sample.

For purposes of the Pen Drop Test, “failure” means the formation of a visible mechanical defect in a sample. The mechanical defect may be a crack or plastic deformation (e.g., surface indentation). The crack may be a surface crack or a through crack. The crack may be formed on an interior or exterior surface of a sample. The crack may extend through all or a portion of the polymer-based portion and/or the substrate. A visible mechanical defect has a dimension of 0.2 millimeters or more. In aspects, the foldable apparatus 101 and/or 301 (e.g., formed with the polymer-based portion) can withstand a pen drop height of 1 cm or more, 2 cm or more, 3 cm or more, 4 cm or more, 5 cm or more, 6 cm or more, 7 cm or more, 8 cm or more, 9 cm or more, and/or 10 cm or more.

In aspects, the foldable apparatus can further comprise one or more of an easy-to-clean coating, a low-friction coating, an oleophobic coating, a diamond-like coating, a scratch-resistant coating, or an abrasion-resistant coating. For example, a coating can be disposed over the second major surface 205 of the ribbon 201 and/or the fourth major surface 385 of the second substrate 381. A scratch-resistant coating may comprise an oxynitride, for example, aluminum oxynitride or silicon oxynitride with a thickness of about 500 micrometers or more. In such aspects, the abrasion-resistant layer may comprise the same material as the scratch-resistant layer. In aspects, a low friction coating may comprise a highly fluorinated silane coupling agent, for example, an alkyl fluorosilane with oxymethyl groups pendant on the silicon atom. In such aspects, an easy-to-clean coating may comprise the same material as the low friction coating. In other aspects, the easy-to-clean coating may comprise a protonatable group, for example, an amine, for example, an alkyl aminosilane with oxymethyl groups pendant on the silicon atom. In such aspects, the oleophobic coating may comprise the same material as the easy-to-clean coating. In aspects, a diamond-like coating comprises carbon and may be created by applying a high voltage potential in the presence of a hydrocarbon plasma.

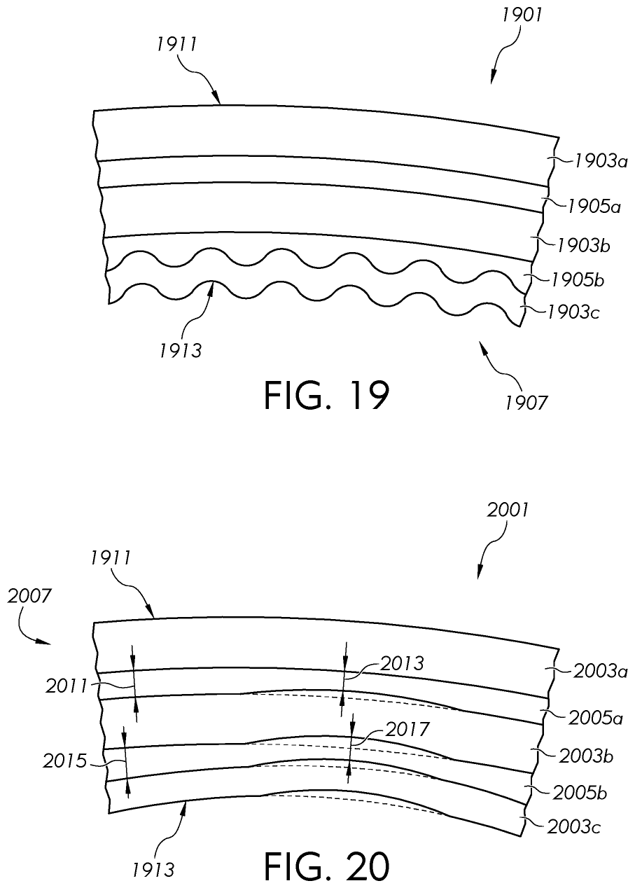

Aspects of the disclosure can reduce (e.g., mitigate, avoid) instabilities of foldable apparatus during folding the foldable apparatus. For example, with reference to FIG. 19, a first instability 1907 is visible at a second major surface 1913 of the foldable apparatus 1901 opposite a first major surface 1911 of the foldable apparatus 1901. As shown, the foldable apparatus can comprise five layers (e.g., portions) comprising three layers 1903a, 1903b, and 1903c with a Young's modulus greater than an another two layers 1905a and 1905b. In this example, an outer layer 1903c at the second major surface 1913 of the foldable apparatus 1901 exhibits wrinkling. Without wishing to be bound by theory, wrinkling can be caused by variations in the local stress experienced by the outer layer 1903c, where the bend-induced strain (e.g., in-plane strain relative to the second major surface 1913) exceeds a critical strain that the outer layer 1903c can withstand. Without wishing to be bound by theory, wrinkling can be the result of stress coupling (e.g., not decoupled) between adjacent layers and/or an adjacent pair of layers (e.g., 1903b and 1903c) with a Young's modulus greater than another layer 1905b positioned therebetween.

For example, with reference to FIG. 20, a second instability 2007 is exhibited by a first layer 2005a of a foldable apparatus 2001 and is visible at the second major surface 1913 of the foldable apparatus 2001. As shown, the foldable apparatus can comprise five layers (e.g., portions) comprising three layers 2003a, 2003b, and 2003c with a Young's modulus greater than an another two layers 2005a and 2005b. In this example, the first layer 2005a exhibits thinning. As shown in FIG. 20, the solid lines deviate from the dashed lines, which represent the profile of the foldable apparatus 2001 without the second instability 2007. For example, a first thickness 2011 of the first layer 2005a is greater than a second thickness 2013 of the first layer 2005a. Further, a second layer 2005b can comprise a first thickness 2015 of the second layer 2005b that is greater than a second thickness 2017 of the second layer 2005b. Thinning of the first layer 2005a and/or second layer 2005b at a location comprising the second thickness 2013 or 2017, respectively, can cause optical distortions and/or contribute to failure of the foldable apparatus 2001 in subsequent folding events. Without wishing to be bound by theory, thinning of an inner layer 2005a and/or 2005b can be caused by variations in the local stress experienced by the corresponding inner layer, where the bend-induced exceeds a critical strain that the corresponding inner layer can withstand.

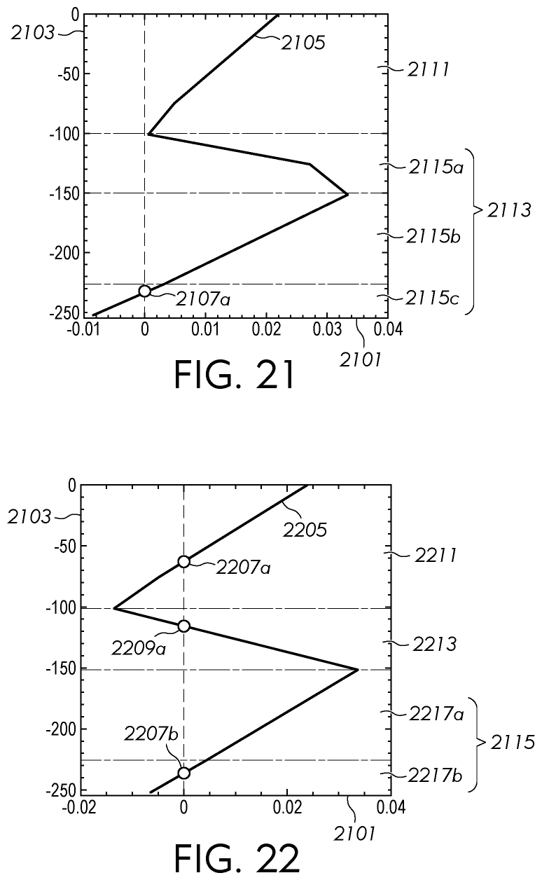

Throughout the disclosure, a neutral plane is a series of locations comprising substantially 0 strain when the foldable apparatus is folded in direction 111 (see FIG. 1). In aspects, where the foldable apparatus comprises a plurality of layers with each layer being substantially homogenous, a neutral plane of the foldable apparatus can comprise a plane extending substantially parallel to the first major surface 203, 373, or 1911 and/or second major surface 205, 375, or 1913 when the foldable apparatus is in an unfolded (e.g., flat) configuration. In further aspects, the foldable apparatus can comprise a plurality of neutral planes that are each substantially parallel to the first major surface 203, 373, or 1911 and/or second major surface 205, 375, or 1913 when the foldable apparatus is in an unfolded (e.g., flat) configuration. As used herein, a first neutral plane is a neutral plane where a first region closer to the first major surface relative to the neutral plane is positive (e.g., corresponding to tensile stress) and a second region closer to the second major surface relative to the neutral plane is negative (e.g., corresponding to compressive stress). Neutral planes and strain in portions of foldable apparatus can be characterized by a plot of strain at a location versus a position in a direction (e.g., direction 202 of the substrate thickness, first portion thickness, second portion thickness, and/or ribbon thickness) along the foldable apparatus. For example, FIGS. 21-28 show strain at a location on a horizontal axis 2101 or 2301 (i.e., x-axis) versus the location on a vertical axis 2103 or 2303 (i.e., y-axis) with the strain at the location shown by curves 2105, 2205, 2305, 2405, 2505, 2605, 2705, or 2805.

As used herein, a second neutral plane is a neutral plane where a first region closer to the first major surface relative to the neutral plane is negative (e.g., corresponding to compressive stress) and a second region closer to the second major surface relative to the neutral plane is positive (e.g., corresponding to tensile stress). In aspects, a second portion can comprise a second neutral plane. In further aspects, each second portion of the plurality of second portions can comprise a second neutral plane. In even further aspects, each second portion can comprise its own second neutral plane. For example, with reference to FIG. 22, the foldable apparatus can comprise a second portion 2213 with a second neutral plane 2209a within the one second portion 2213. In aspects, a number of second neutral planes can be equal to the number of second portions, and each second neutral plane positioned in a corresponding second portion.

In aspects, the foldable apparatus can comprise a plurality of first neutral planes and at least one second neutral plane. In further aspects, a number of first neutral planes of the plurality of first neutral planes can be equal to a number of first portions of the plurality of first portions, and a number of second neutral planes of the at least one second neutral plane can be equal to a number of second portions of the at least one second portion. In further aspects, each first portion of the plurality of first portions can comprise a first neutral plane, and each second portion of the at least one second portion can comprise a second neutral plane. For example, with reference to FIG. 22, the foldable apparatus comprises two first portions 2211 and 2215 with corresponding first neutral planes 2207a and 2207b and one second portion 2213 positioned therebetween with a second neutral plane 2209a therein. Providing a foldable apparatus where each first portion comprises a first neutral plane and each second portion comprises a second neutral plane can reduce bend-induced stresses within the first portions and at least one second portion. As discussed above, reduced bend-induced stresses can reduce bend-induced mechanical instabilities in the foldable apparatus and/or fatigue of the foldable apparatus.

Throughout the disclosure, a second portion comprises a maximum Young's modulus that is less than a minimum Young's modulus of an adjacent first portion. Further, the maximum Young's modulus of the second portion is at least about 500 times less than the minimum Young's modulus of the adjacent first portion. Consequently, a prospective portion comprising a maximum Young's modulus that is more than a minimum Young's modulus of an adjacent first portion is treated as part of the first portion. A prospective portion comprising a maximum Young's modulus that is less than a minimum Young's modulus of an adjacent first portion by a multiple of less than 500 is treated as part of the first portion. A prospective portion comprising a maximum Young's modulus that is less than a minimum Young's modulus of an adjacent first portion by a multiple of about 500 or more is treated as a second portion, although a greater multiple may be specified in further aspects, for example, in the next two paragraphs.

Also, a prospective portion can be classified relative to an adjacent second portion. As used herein, a second portion is adjacent to another portion if there is no other layer between the second portion and the another portion. A prospective portion comprising a minimum Young's modulus that is less than a maximum Young's modulus of an adjacent second portion is treated as part of the adjacent second portion. A prospective portion comprising a minimum Young's modulus that is greater than a maximum Young's modulus of the adjacent second portion by a multiple of less than 500 is treated as part of the adjacent second portion. A prospective portion comprising a minimum Young's modulus that is greater than a maximum Young's modulus of the adjacent second portion by a multiple of about 500 or more is treated as a first portion, although a greater multiple may be specified in further aspects, for example, in the next paragraph.

In aspects, a maximum Young's modulus of a second portion can be less than a minimum Young's modulus of an adjacent first portion by a multiple of about 500 or more, about 750 or more, about 1,000 or more, about 5,000 or more, about 8,000 or more, about 10,000 or more, about 15,000 or more, about 30,000 or more, about 60,000 or more, about 500,000 or less, about 400,000 or less, about 300,000 or less, about 150,000 or less, or about 100,000 or less. In aspects, a maximum Young's modulus of a second portion can be less than a minimum Young's modulus of an adjacent first portion by a multiple in a range from about 500 to about 500,000, from about 500 to about 400,000, from about 750 to about 400,000, from about 1,000 to about 400,000, from about 1,000 to about 300,000, from about 3,000 to about 300,000, from about 5,000 to about 300,000, from about 8,000 to about 300,000, from about 8,000 to about 150,000, from about 10,000 to about 150,000, from about 10,000 to about 100,000, from about 15,000 to about 100,000, from about 30,000 to about 100,000, from about 60,000 to about 100,000, or any range or subrange therebetween. In aspects, each second portion can comprise a corresponding maximum Young's modulus that is less than each first portion of the corresponding adjacent pair of first portions by a multiple of about 500 or more, about 750 or more, about 1,000 or more, about 5,000 or more, about 8,000 or more, about 10,000 or more, about 15,000 or more, about 30,000 or more, about 60,000 or more, about 500,000 or less, about 400,000 or less, about 300,000 or less, about 150,000 or less, or about 100,000 or less. In aspects, each second portion can comprise a corresponding maximum Young's modulus that is less than each first portion of the corresponding adjacent pair of first portions by a multiple of about 500 or more, about 750 or more, about 1,000 or more, about 5,000 or more, about 8,000 or more, about 10,000 or more, about 15,000 or more, about 30,000 or more, about 60,000 or more, about 500,000 or less, about 400,000 or less, about 300,000 or less, about 150,000 or less, or about 100,000 or less. In aspects, a maximum Young's modulus of a second portion can be less than a minimum Young's modulus of an adjacent first portion by a multiple in a range from about 500 to about 500,000, from about 500 to about 400,000, from about 750 to about 400,000, from about 1,000 to about 400,000, from about 1,000 to about 300,000, from about 3,000 to about 300,000, from about 5,000 to about 300,000, from about 8,000 to about 300,000, from about 8,000 to about 150,000, from about 10,000 to about 150,000, from about 10,000 to about 100,000, from about 15,000 to about 100,000, from about 30,000 to about 100,000, from about 60,000 to about 100,000, or any range or subrange therebetween. Providing at least one second portion comprising a much lower (e.g., from about 500 times to about 500,000 times, from about 10,000 times to about 100,000 times) Young's modulus than an adjacent pair of first portions can reduce bend-induced stresses on one or more of the first portions in the adjacent pair of first portions. Reducing bend-induced stresses can reduce (e.g., decreases, eliminate) bend-induced mechanical instabilities of the foldable apparatus. Also, reducing bend-induced stresses can reduce fatigue of the foldable apparatus while increasing the reliability and/or durability of the foldable apparatus. For example, with reference to FIG. 22, a region 2217a comprising a first portion adjacent to an another region 2217b that does not meet the above-mentioned threshold to be a second portion is treated as part of the same first portion of the region 2217a. Consequently, the first portion 2215 comprises both the region 2217a and the another region 2217a.

In aspects, a first portion can comprise a first neutral plane. In further aspects, each first portion of the plurality of first portions can comprise a first neutral plane. In further aspects, each first portion can comprise its own first neutral plane. For example, with reference to FIG. 22, the foldable apparatus can comprise two first portions 2211 and 2215 with a first neutral plane 2207a within the one first portion 2211 and an another first neutral plane 2207b within the another first portion 2215. In aspects, a number of first neutral planes can be equal to the number of first portions, and each first neutral plane positioned in a corresponding first portion. For the foldable apparatus corresponding to FIG. 22, no mechanical instability is observed. In contrast, as shown in FIG. 21, the foldable apparatus comprises a first portion 2111 and a second portion 2113 comprising three adjacent regions 2115a-c. As shown in FIG. 21, the foldable apparatus comprises a single first neutral plane 2107a and no second neutral planes. The region 2115b did not qualify as a second portion because the ratio between the maximum Young's modulus of the region 2217b and the minimum Young's modulus of the adjacent regions 2115a and 2115c is less than 500—less than 200. For the foldable apparatus corresponding to FIG. 21, mechanical instabilities were observed, namely, wrinkling was observed at a parallel plate distance of 34 mm.

In aspects, a ratio of the elastic modulus (e.g., Young's modulus) of the first substrate 371 or ribbon 201 to the elastic modulus (e.g., Young's modulus) of the substrate can be within one or more of the ranges discussed above with reference to the ratio of a maximum Young's modulus of a second portion can be less than a minimum Young's modulus of an adjacent first portion, for example, in a range from about 500 to about 200,000. In aspects, with reference to FIG. 3, the first substrate 371 can be part of a first portion, the second substrate 381 can be part of another first portion, and the polymer-based portion 241 can be part of a second portion with the foldable substrate comprising two first neutral planes—one in the first portion and another in the another first portion—and one second neutral plane.

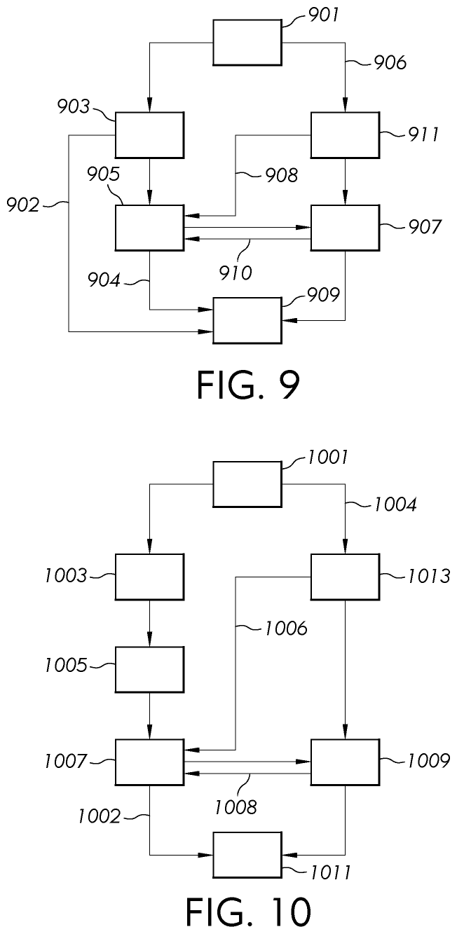

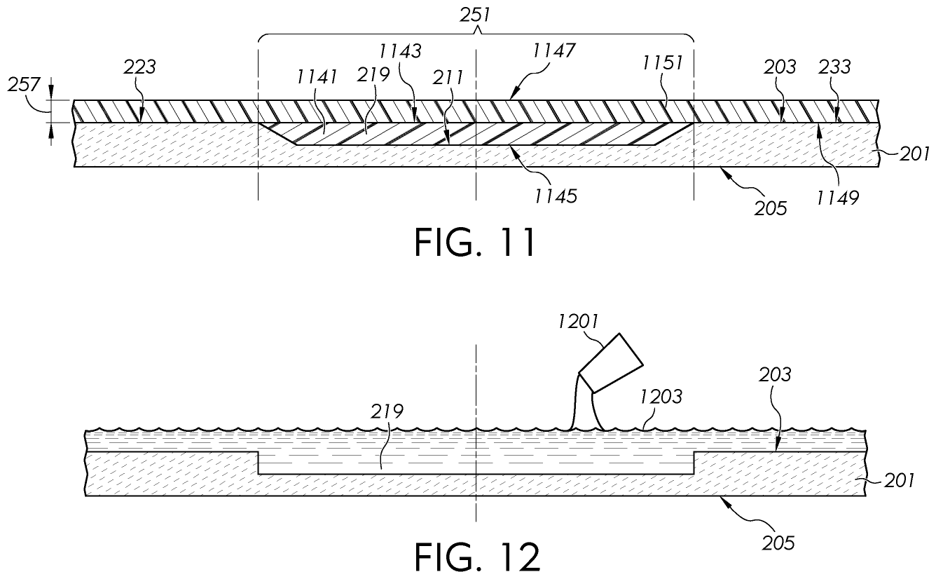

Aspects of methods of making the foldable apparatus in accordance with aspects of the disclosure will be discussed with reference to the flow charts in FIGS. 9-10 and example method steps illustrated in FIGS. 11-17.

Aspects of methods of making the foldable apparatus 101 in accordance with aspects of the disclosure will be discussed with reference to the flow chart in FIG. 9 and example method steps illustrated in FIGS. 11-13. With reference to the flow chart of FIG. 9, methods can start at step 901. In aspects, step 901 can comprise providing a ribbon. In further aspects, the substrate can resemble the ribbon 201 of FIG. 2 comprising the ribbon thickness 227. In further aspects, the ribbon 201 can be provided by purchase or otherwise obtaining a substrate or by forming the substrate. In further aspects, the substrate can comprise a glass-based substrate and/or a ceramic-based substrate. In further aspects, glass-based substrates can be provided by forming them with a variety of ribbon forming processes, for example, slot draw, down-draw, fusion down-draw, up-draw, press roll, redraw, or float. In even further aspects, the substrate can be chemically strengthened and comprise a depth of compression (e.g., first depth of compression, second depth of compression), compressive stress (e.g., first maximum compressive stress, second maximum compressive stress), and/or depth of layer (e.g., first depth of layer, second depth of layer) within one or more of the corresponding ranges discussed above. In further aspects, step 901 can comprise providing the polymer-based portion or precursors thereof, as discussed above. In further aspects, step 901 can comprise providing the polymer-based portion 241.

In aspects, after step 901, as shown in FIG. 12, methods can proceed to step 903 comprising disposing a polymer-based portion 241 over the first major surface 203 and/or in the recess 219 by dispensing a liquid 1203 from a container 1201. In further aspects, the container 1201 can comprise a flexible tube, micropipette, or syringe. In further aspects, as shown in FIG. 12, the liquid 1203 may be disposed in the recess 219 by pouring the liquid 1203 from the container 1201 into the recess 219. In further aspects, disposing the liquid 1203 into the recess 219 may at least partially (e.g., substantially fully) fill the recess 219. In even further aspects, as shown, the liquid 1203 can further contact and/or cover the first major surface 203. In further aspects, the liquid 1203 may comprise a precursor, a solvent, particles, nanoparticles, and/or fibers. In even further aspects, the precursor that can comprise, without limitation, one or more of a monomer (e.g., reactive diluent), an oligomer, an accelerator, a curing agent, a catalyst, a photoinitiator, an antioxidant, a silane coupling agent, a urethane, and/or an acrylate. In aspects, the solvent for the adhesive precursor may comprise a polar solvent (e.g., water, an alcohol, an acetate, acetone, formic acid, dimethylformamide, acetonitrile, dimethyl sulfoxone, nitromethane, propylene carbonate, poly(ether ether ketone)) and/or a non-polar solvent (e.g., pentane, 1,4-dioxane, chloroform, dichloromethane, diethyl ether, hexane, heptane, benzene, toluene, xylene). The liquid 1203 can be cured to form a first layer of the polymer-based portion 241 as shown in FIG. 2. In further aspects, the curing the liquid 1203 may comprise heating the liquid 1203. In further aspects, curing the liquid 1203 may comprise irradiating the liquid 1203 with ultraviolet (UV) radiation. In further aspects, the curing the liquid 1203 to form at least a portion of the polymer-based portion 241 can comprise waiting a predetermined amount of time (e.g., from about 30 minutes to 24 hours, from about 1 hour to about 8 hours).

In aspects, after step 903, methods can proceed to step 905 comprising assembling the foldable apparatus using the ribbon 201. In further aspects, although not shown, step 905 can comprise disposing an adhesive layer over the polymer-based portion and/or the second major surface of the ribbon. In further aspects, step 905 can comprise disposing the (e.g., see release liner 271 in FIG. 2) and/or the display device (e.g., see display device 307 in FIG. 3). In further aspects, step 905 can comprise disposing a coating over the ribbon 201.

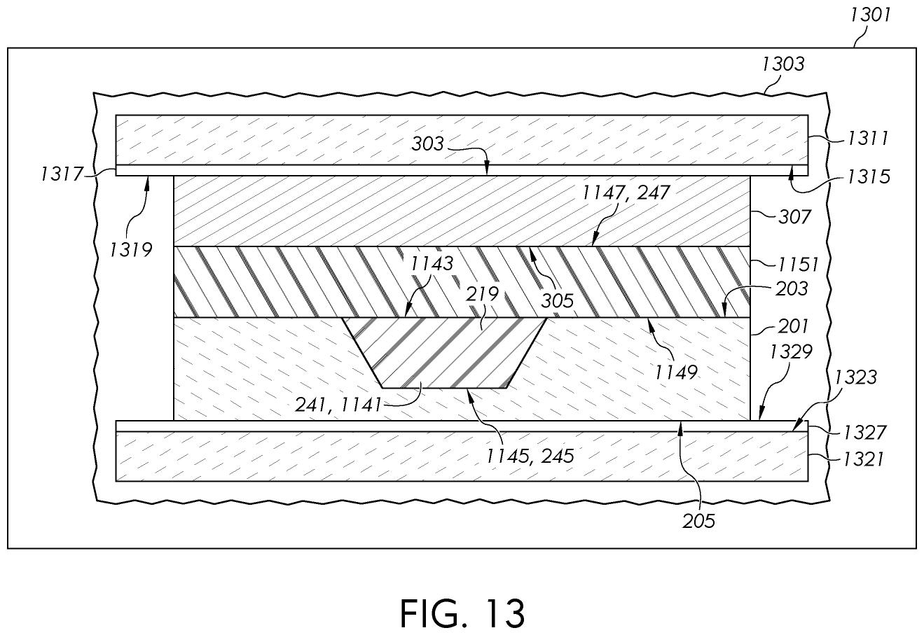

In aspects, after step 903, 905, or 911, as shown in FIG. 13, methods can proceed to step 907 comprising laminating the ribbon 201 and the polymer-based portion 241. In further aspects, as shown, the polymer-based portion 241 can comprise a first layer 1141 disposed in the recess 219 and a second layer 1151 disposed over the first layer 1141 and the first major surface 203. In further aspects, although not shown, the polymer-based portion 241 can comprise a monolithic layer, for example, as a result of step 905. In further aspects, as shown, the second layer 1151 can contact a third contact surface 1143 of the first layer 1141. In further aspects, step 907 can comprise applying a first release liner 1317 over the display device 307. As shown, the first release liner 1317 can comprise a first surface area 1319 facing a second contact surface 247 or 1147 of the polymer-based portion 241 or the second layer 1151, respectively. As shown, the first surface area 1319 of the first release liner 1317 can contact the fifth major surface 303 of the display device 307. In even further aspects, the second contact surface 247 or 1147 of the polymer-based portion 241 or the second layer 1151 can contact the sixth major surface 305 of the display device 307. In even further aspects, a first support 1311 can be disposed over the first release liner 1317, for example, with a third surface 1315 of the first support 1311 facing and/or contacting the first release liner 1317. In further aspects, as shown in FIG. 13, step 907 can comprise applying a second release liner 1327 over the second major surface 205 of the ribbon 201. In even further aspects, a first surface area 1329 of the second release liner 1327 can face and/or contact the second major surface 205 of the ribbon 201. In even further aspects, a second support 1321 can be disposed over the second release liner 1327, for example, with a third surface 1323 of the second support 1321 facing and/or contacting the second release liner 1327. In further aspects, as shown in FIG. 13, methods can comprise placing the assembly in a vacuum container 1303. In even further aspects, the vacuum container can provide an airtight closure and can withstand the conditions of heating and/or applying pressure. Exemplary aspects of vacuum containers include the OBSJ/ABSJ vacuum bags available from Simtech. In further aspects, the first release liner 1317 and/or the second release liner 1327 can comprise any of the material discussed above for release liner 271, for example, a fluorine-containing polymer. In further aspects, the first support 1311 and/or the second support 1321 can comprise an elastic modulus of about 3 GPa or more and/or can comprise a glass-based material and/or a ceramic-based material. Providing one or more release liners can reduce (e.g., prevent) adhesion of the polymer-based portion to undesired materials during methods and can reduce damage to the foldable apparatus during processing. Providing one or more supports can decrease deformation (e.g., warp) of the substrate and/or polymer-based portion during processing. Providing a vacuum container can protect the substrate, polymer-based portion and/or foldable apparatus from contamination during processing.

In aspects, step 907 can further comprise heating the polymer-based portion and the substrate at a first temperature for a first period of time. In further aspects, as shown in FIG. 13, heating the assembly can comprise placing the polymer-based portion and the substrate in an oven 1301. In further aspects, the first temperature can be about 40° C. or more, about 50° C. or more, about 60° C. or more, about 100° C. or less, about 90° C. or less, about 80° C. or less, or about 70° C. or less. In further aspects, the first temperature can be in a range from about 40° C. to about 100° C., from about 40° C. to about 90° C., from about 50° C. to about 90° C., from about 50° C. to about 80° C., from about 60° C. to about 80° C., from about 60° C. to about 70° C., or any range or subrange therebetween. In further aspects, the first period of time can be about 10 minutes or more, about 15 minutes or more, about 20 minutes or more, about 25 minutes or more, about 8 hours or less, about 4 hours or less, about 2 hours or less, about 1 hour or less, about 45 minute or less, or about 35 minutes or less. In further aspects, the first period of time can be in a range from about 10 minutes to about 8 hours, from about 10 minutes to about 4 hours, from about 15 minutes to about 4 hours, from about 15 minutes to about 2 hours, from about 20 minutes to about 2 hours, from about 20 minutes to about 1 hour, from about 20 minutes to about 45 minutes, from about 25 minutes to about 45 minutes, from about 25 minutes to about 35 minutes, or any range or subrange therebetween. In even further aspects, step 907 can comprise heating the polymer-based portion and the substrate from ambient temperature (e.g., about 25° C.) to the first temperature at a first rate. In even further aspects, the first rate can be about 0.1° C. per minutes (° C./min) or more, about 0.5° C./min or more, about 1° C./min or more, about 10° C./min or less, about 5° C./min or less, or about 3° C./min or less. In even further aspects, the first rate can be in a range from about 0.1° C./min to about 10° C./min, from about 0.1° C./min to about 5° C./min, from about 0.5° C./min to about 5° C./min, from about 0.5° C./min to about 3° C./min, from about 1° C./min to about 1° C./min to about 3° C./min, or any range or subrange therebetween.

In aspects, step 907 can further comprise heating the polymer-based portion and the substrate at a second temperature for a second period of time at a gauge pressure. As used herein, gauge pressure refers to pressure measured relative to atmospheric pressure (e.g., about 101.325 kPa). In further aspects, the second temperature can be about 150° C. or more, about 170° C. or more, about 190° C. or more, about 250° C. or less, about 230° C. or less, or about 210° C. or less. In further aspects, the second temperature can be in a range from about 150° C. to about 250° C., from about 150° C. to about 230° C., from about 170° C. to about 230° C., from about 170° C. to about 210° C., from about 190° C. to about 210° C., or any range or subrange therebetween. In further aspects, the second period of time can be about 30 minutes or more, about 35 minutes or more, about 40 minutes or more, about 2 hours or less, about 50 minutes or less, or about 45 minutes or less. In further aspects, the second period of time can be in a range from about 30 minutes to about 2 hours, from about 30 minutes to about 50 minutes, from about 35 minutes to about 50 minutes, from about 35 minutes to about 45 minutes, from about 40 minutes to about 45 minutes, or any range or subrange therebetween. In further aspects, the gauge pressure can be positive. In further aspects, the gauge pressure can be about 1.0 MegaPascals (MPa) or more, about 1.1 MPa or more, about 1.2 MPa or more, about 1.5 MPa or less, about 1.4 MPa or less, or about 1.3 MPa or less. In further aspects, the gauge pressure can be in a range from about 1.0 MPa to about 1.5 MPa, from about 1.0 MPa to about 1.4 MPa, from about 1.1 MPa to about 1.4 MPa, from about 1.1 MPa to about 1.3 MPa, from about 1.2 MPa to about 1.3 MPa, or any range or subrange therebetween. In further aspects, the second temperature can be greater than the first temperature. In even further aspects, step 907 can comprise heating the polymer-based portion and the substrate from the first temperature to the second temperature at a second rate. In still further aspects, the second rate can be about 0.1° C. per minutes (° C./min) or more, about 0.5° C./min or more, about 1° C./min or more, about 10° C./min or less, about 5° C./min or less, or about 3° C./min or less. In even further aspects, the second rate can be in a range from about 0.1° C./min to about 10° C./min, from about 0.1° C./min to about 5° C./min, from about 0.5° C./min to about 5° C./min, from about 0.5° C./min to about 3° C./min, from about 1° C./min to about 1° C./min to about 3° C./min, or any range or subrange therebetween. In further aspects, step 907 can comprise increasing a pressure at a third rate to reach the gauge pressure. In even further aspects, the third rate can be about 3 kiloPascals per minute (kPa/min) or more, about 7 kPa/min or more, about 10 kPa/min or more, about 15 kPa/min or more, about 50 kPa/min or less, about 35 kPa/min or less, about 30 kPa/min or less, about 25 kPa/min or less, or about 20 kPa/min or less. In even further aspects, the third rate can be in a range from about 3 kPa/min to about 50 kPa/min, from about 3 kPa/min to about 35 kPa/min, from about 7 kPa/min to about 35 kPa/min, from about 7 kPa/min to about 30 kPa/min, from about 10 kPa/min to about 30 kPa/min, from about 10 kPa/min to about 25 kPa/min, from about 15 kPa/min to about 25 kPa/min, from about 15 kPa/min to about 20 kPa/min, or any range or subrange therebetween.

In further aspects, step 907 can comprise cooling the substrate and the polymer-based portion as a laminate from the second temperature to ambient temperature (e.g., about 25° C.) or another predetermined temperature at a fourth rate. In even further aspects, the fourth rate can be about 0.5° C./min or more, about 1° C./min or more, about 2° C./min or more, about 4° C./min or more, about 20° C./min or less, about 10° C./min or less, about 8° C./min or less, or about 6° C./min or less. In even further aspects, the fourth rate can be in a range from about 0.5° C./min to about 20° C./min, from about 0.5° C./min to about 10° C./min, from about 1° C./min to about 10° C./min, from about 1° C./min to about 8° C./min, from about 2° C./min to about 8° C./min, from about 2° C./min to about 6° C./min, from about 4° C./min to about 6° C./min, or any range or subrange therebetween. In further aspects, step 907 can comprise decreasing a pressure from the gauge pressure to ambient pressure (e.g., 0 Pascals gauge pressure) or another predetermined pressure at a fifth rate. In even further aspects, the fifth rate can be about 10 kPa/min or more, about 35 kPa or more, about 50 kPa/min or more, about 103 kPa/min or less, about 80 kPa/min or less, or about 60 kPa/min or less. In even further aspects, the fifth rate can be in a range from about 10 kPa/min to about 103 kPa/min, from about 35 kPa/min to about 103 kPa/min, from about 35 kPa/min to about 80 kPa/min, from about 50 kPa/min to about 80 kPa/min, from about 50 kPa/min to about 60 kPa/min, or any range or subrange therebetween. In further aspects, step 907 can comprise removing the laminate formed from the polymer-based portion and the substrate from the vacuum container, support layer(s), and/or release liner(s), if present. As a result of step 907, the polymer-based portion 241 can become adhered to the ribbon 201 and/or the display device 307, and/or the first layer 1141 and the second layer 1151 can become adhered and/or form a monolithic polymer-based portion (e.g., polymer-based portion 241).

In aspects, after step 901, as shown in FIG. 11, methods can proceed to step 911 comprising disposing one or more layers of the polymer-based portion (e.g., first layer 1141, second layer 1151) over the ribbon 201. In further aspects, as shown, step 911 can comprise disposing the first layer 1141 in the recess 219. In even further aspects, a first contact surface 1145 of the first layer 1141 can face and/or contact the first central surface area 211. In further aspects, as shown, step 911 can comprise disposing a second layer 1151 over the first major surface 203 of the ribbon 201. In even further aspects, a fourth contact surface 1149 of the second layer 1151 can face and/or contact the first major surface 203 (e.g., first surface area 223, third surface area 233). In even further aspects, the fourth contact surface 1149 of the second layer 1151 can face and/or contact the third contact surface 1143 of the first layer 1141. In even further aspects, the second layer 1151 can comprise the polymer thickness (e.g., polymer thickness 257) between the second contact surface 1147 and the third contact surface 1143.

After step 903, 905, or 907, methods can be complete at step 909, whereupon methods of making the foldable apparatus 101 can be complete. In aspects, as discussed above with reference to the flow chart in FIG. 9, methods can start at step 901 and then proceed sequentially through steps 903, 905, 907, and 909. In aspects, methods can follow arrow 902 from step 903 to step 909, for example, if the foldable apparatus is complete after step 903 with the polymer-based portion 241 contacting and/or adhered to the ribbon 201. In aspects, methods can follow arrow 904 from step 905 to step 909, for example, if the foldable apparatus is complete after step 905. In aspects, methods can follow step 906 from step 901 to 911, for example, if the polymer-based portion is created by disposing one or more layers (e.g., already formed layers) comprising the material of the polymer-based portion over the ribbon 201. In aspects, methods can follow step 908 from step 911 to step 905, for example, if the foldable apparatus is to be further assembled in step 905. In aspects, methods can follow 910 from step 907 to step 905, for example, if the foldable apparatus is to be further assembled in step 905. Any of the above options may be combined to make a foldable apparatus in accordance with aspects of the disclosure.

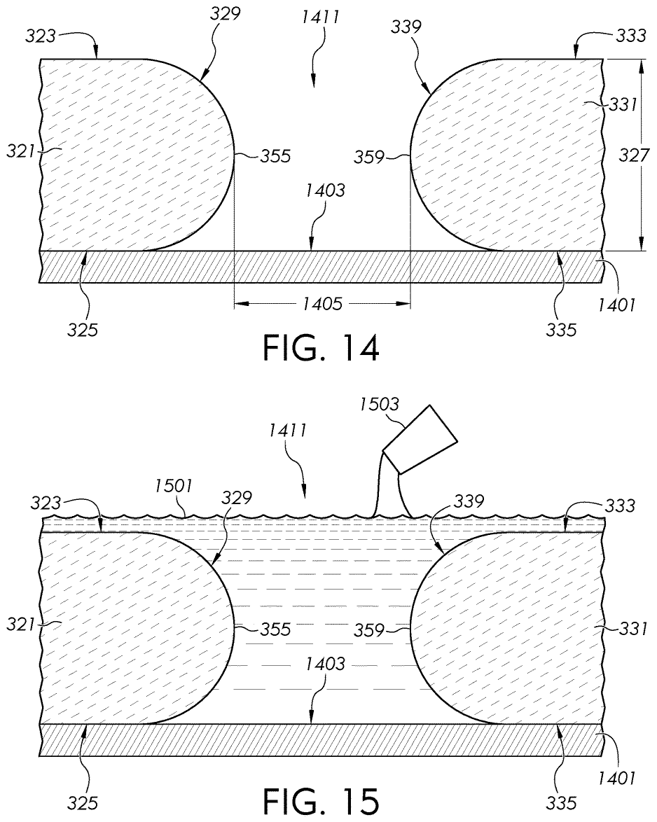

Aspects of methods of making the foldable apparatus 301 in accordance with aspects of the disclosure will be discussed with reference to the flow chart in FIG. 10 and example method steps illustrated in FIGS. 14-17. With reference to the flow chart of FIG. 10, methods can start at step 1001. In aspects, step 1001 can comprise providing a first portion 321 and a second portion 331. In further aspects, the first portion 321 and the second portion 331 can comprise the first portion thickness 327. In further aspects, the first portion 321 and a second portion 331 can be provided by purchase or otherwise obtaining the portions or by forming the portions. In further aspects, the first portion 321 and a second portion 331 can comprise a glass-based material and/or a ceramic-based material. In aspects, step 1001 can comprise providing the first substrate 371 and/or the second substrate 381. In further aspects, the first substrate 371 and/or the second substrate 381 can be provided by purchase or otherwise obtaining a substrate or by forming the portions. In further aspects, the first substrate 371 and/or the second substrate 381 can comprise a glass-based substrate and/or a ceramic-based substrate. In further aspects, glass-based substrates can be provided by forming them with a variety of ribbon forming processes, for example, slot draw, down-draw, fusion down-draw, up-draw, press roll, redraw, or float. In even further aspects, the substrate can be chemically strengthened and comprise a depth of compression (e.g., first depth of compression, second depth of compression), compressive stress (e.g., first maximum compressive stress, second maximum compressive stress), and/or depth of layer (e.g., first depth of layer, second depth of layer) within one or more of the corresponding ranges discussed above. In further aspects, step 1001 can comprise providing the polymer-based portion or precursors thereof, as discussed above.

After step 1001, as shown in FIG. 14, methods can proceed to step 1003 comprising spacing the first portion 321 apart from the second portion 331. In aspects, a minimum distance 1405 between the first portion 321 and the second portion 331 (e.g., between the outer peripheral portion 355 of the first edge surface area 329 of the first portion 321 and the outer peripheral portion 359 of the second edge surface area 339 of the second portion 331) can be within the ranges discussed above with regards to minimum distance 343. In further aspects, a recess 1411 can be formed between the first portion 321 (e.g., first edge surface area 329) and the second portion 331 (e.g., second edge surface area 339). In further aspects, as shown, a layer 1401 can be attached to the first portion 321 and the second portion 331. In further aspects, as shown, the layer 1401 can comprise a contact surface 1403 that can face and/or contact the second surface area 325 of the first portion 321 and/or the fourth surface area 335 of the second portion 331. In further aspects, although not shown, the layer can comprise a contact surface that can face the first surface area of the first portion and/or the third surface area of the second portion. In further aspects, the layer 1401 can comprise a flexible layer (e.g., a flexible film). In further aspects, the layer 1401 can comprise a removable layer that may be removed by a wide range of techniques, for example, peeling off the layer, heating the layer, exposing the layer to light, or other techniques. In even further aspects, the layer 1401 can comprise a polymer although the layer 1401 may be formed from other materials in further aspects. In still further aspects, the layer 1401 may comprise applying a previously formed layer that can, for example, comprise a tape. In still further aspects, the layer 1401 can comprise a polymeric pressure-sensitive adhesive, for example, a block copolymer (e.g., a styrene-rubber block copolymer). In yet further aspects, the pressure-sensitive adhesive can comprise a high-temperature release film, meaning that the adhesion of the polymeric adhesive decreases above a predetermined temperature (e.g., 100° C., 150° C., 200° C., 300° C., 400° C.), which can comprise, for example, polypropylene, PVF, ETFE, FEP, polyimide, and/or polymethylpentene. In yet further aspects, the pressure-sensitive adhesive can comprise a low-temperature release film, meaning that the adhesion of the polymeric adhesive decreases below a predetermined temperature (e.g., 100° C., 50° C., 30° C.). By providing a pressure-sensitive adhesive that comprises a temperature-sensitive release film (e.g., high-temperature release film, low-temperature release film), processing costs can be reduced and potential damage to the foldable apparatus associated with removing the layer 1401. In aspects, although not shown, step 1003 can further comprise disposing the adhesive layer 261 over the layer 1401, for example, before attaching the first portion 321 and the second portion 331 to the layer 1401 such that the adhesive layer 261 are positioned between the first portion 321, the layer 1401, and the second portion 331.

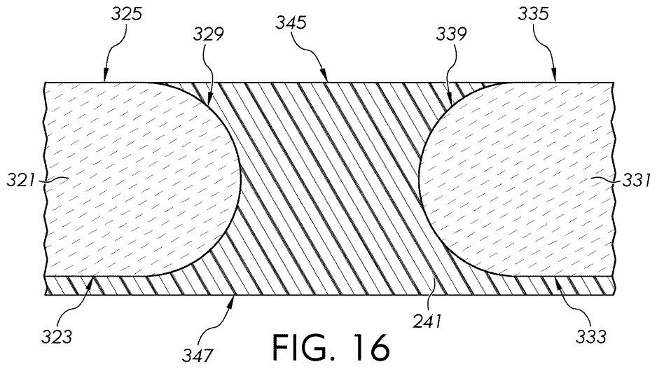

After step 1003, as shown in FIG. 15, the method can proceed to step 1005 comprising filling the recess 1411 between the first portion 321 and the second portion 331 with a liquid 1501 to form the polymer-based portion 241. In aspects, as shown, forming the polymer-based portion 241 can comprise dispensing a liquid 1501 from a container 1503 into the recess 1411. In aspects, as shown by the liquid level line, the liquid 1501 may fill the recess 1411 past a point where the liquid level would extend along a common plane (i.e., is coplanar) with the first surface area 323 of the first portion 321 and the third surface area 333 of the second portion 331. In further aspects, as shown by the liquid level line, the liquid 1501 may be poured so that the liquid level is disposed over the first surface area 323 and the third surface area 333. In even further aspects, the liquid level may be a distance above the first surface area 323 and/or a distance above the third surface area 333 that can be within one or more of the ranges discussed above for the polymer thickness 357. In further aspects, the liquid 1501 can comprise any of the materials discussed above with respect to FIG. 12 including precursors of the materials and/or solvents. Step 1005 can further include curing the liquid 1501 to connect the pair of portions 321 and 331 together. In aspects, curing the liquid 1501 can comprise heating, ultraviolet (UV) irradiation, and/or waiting for a predetermined period of time. In aspects, the layer 1401 can be removed after forming the polymer-based portion 241, as shown in FIG. 16. In even further aspects, as shown, the polymer-based portion 241 can cover (e.g., be disposed over) at least a portion of the first surface area 323 of the first portion 321. In still further aspects, a thickness of the polymer-based portion measured from the first surface area 323 can be within one or more of the ranges discussed above for the polymer thickness 357. In even further aspects, as shown, the polymer-based portion 241 can cover (e.g., be disposed over) at least a portion of the third surface area 333 of the second portion 331. In aspects, although not shown, the first portion and the second portion can be rotated 180 degrees such that the polymer-based portion covers at least a portion of the third surface area of the first portion and/or at least a portion of the fourth surface area of the second portion. In further aspects, a thickness of the polymer-based portion measured from the second surface area can be within one or more of the ranges discussed above for the polymer thickness 357. It is to be understood that the polymer-based portion 241 formed in FIG. 15 can be rotated 180° to form part of the foldable apparatus 301 shown in FIG. 3.

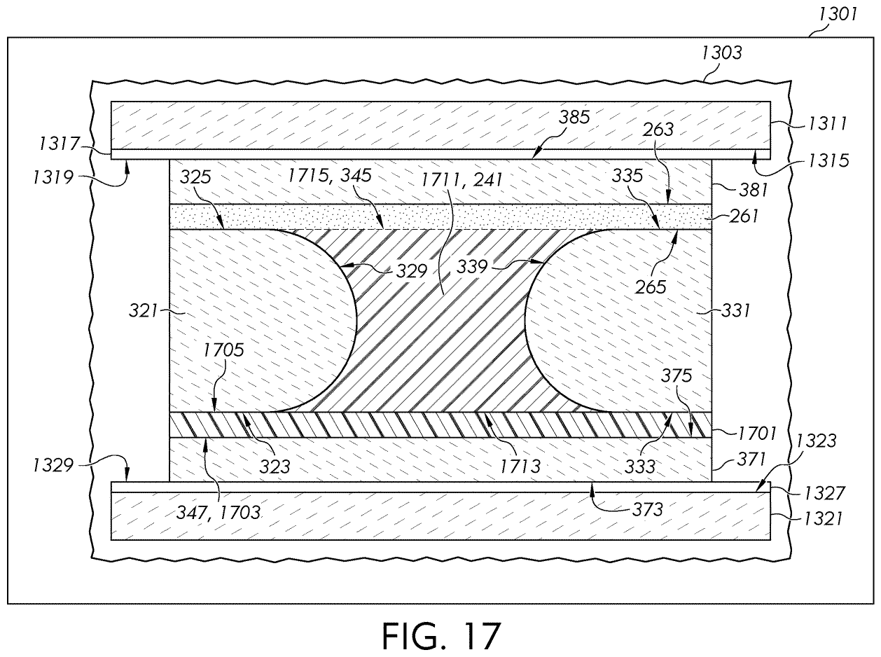

After step 1005 or 1013 (described below), as shown in FIG. 17, the method can proceed to step 1007 comprising assembling the foldable apparatus. In aspects, shown in FIGS. 3 and 17, step 1007 can comprise disposing the adhesive layer 261 over the first portion 321, the second portion 331, and the polymer-based portion 241. For example, in FIGS. 3 and 17, a fourth contact surface 265 of the adhesive layer 261 can be disposed such that it contacts the second surface area 325 of the first portion 321, the fourth surface area 335, and/or the first contact surface 345 of the polymer-based portion 241. In further aspects, step 1007 can comprise disposing the second substrate 381 over the first portion 321, the second portion 331, and the polymer-based portion 241. In even further aspects, the second substrate 381 and the adhesive layer 261 can be disposed over the polymer-based portion 241 together or the second substrate 381 can be attached to the adhesive layer 261 after the adhesive layer 261 is disposed over the polymer-based portion. In aspects, step 1007 can comprise attaching the second major surface 375 of the first substrate 371 to the second contact surface 347 of the polymer-based portion 241. In further aspects, the second major surface 375 of the first substrate 371 can face the first surface area 323 of the first portion 321 and the third surface area 333 of the second portion 331. In further aspects, the second adhesive layer 361 and/or the display device 307 can be disposed over the polymer-based portion 241 together with the first substrate 371 or sequentially.

After step 1007 or 1013 (described below), methods can proceed to step 1009 comprising laminating the first portion 321, the second portion 331, and the polymer-based portion 241. In further aspects, as shown, the polymer-based portion 241 can comprise a first layer 1711 disposed between the first portion 321 and the second portion 331 and a second layer 1701 disposed over the first layer 1711, the first portion 321, and the second portion 331. In further aspects, although not shown, the polymer-based portion 241 can comprise a monolithic layer, for example, as a result of step 1005. In further aspects, step 1009 can comprise disposing the first substrate 371 over the second release liner 1327. In even further aspects, the second support 1321 can be disposed over the second release liner 1327, for example, with the third surface 1323 of the second support 1321 facing and/or contacting the second release liner 1327. In even further aspects, as shown, the second release liner 1327 can comprise the first surface 1329 that faces the second contact surface 347 or 1703 of the polymer-based portion 241 or the second layer 1701, respectively. In even further aspects, the second contact surface 347 or 1703 of the polymer-based portion 241 or the second layer 1701 can face the second major surface 375 of the first substrate 371. In further aspects, step 1009 can comprise disposing a first release liner 1317 over the second substrate 381. As shown, the first release liner 1317 can comprise a first surface area 1319 facing the first contact surface 345 or 1715 of the polymer-based portion 241 or the second layer 1701, respectively. In even further aspects, a first support 1311 can be disposed over the first release liner 1317, for example, with a third surface 1315 of the first support 1311 facing and/or contacting the first release liner 1317. In further aspects, as shown in FIG. 17, methods can comprise placing the assembly in a vacuum container 1303. In even further aspects, the vacuum container can provide an airtight closure and can withstand the conditions of heating and/or applying pressure. Exemplary aspects of vacuum containers include the OBSJ/ABSJ vacuum bags available from Simtech. In further aspects, the first release liner 1317 and/or the second release liner 1327 can comprise any of the material discussed above for release liner 271, for example, a fluorine-containing polymer. In further aspects, the first support 1311 and/or the second support 1321 can comprise an elastic modulus of about 3 GPa or more and/or can comprise a glass-based material and/or a ceramic-based material. Providing one or more release liners can reduce (e.g., prevent) adhesion of the film to undesired materials during methods and can reduce damage to the foldable apparatus during processing. Providing one or more supports can decrease deformation (e.g., warp) of the substrate and/or polymer-based portion during processing. Providing a vacuum container can protect the substrate, polymer-based portion, and/or foldable apparatus from contamination during processing.

In aspects, step 1009 can further comprise heating the polymer-based portion, the first portion, and the second portion at a first temperature for a first period of time. In further aspects, as shown in FIG. 17, heating the assembly can comprise placing the polymer-based portion, the first portion, and the second portion in an oven 1301. In further aspects, the first temperature can be within one or more of the ranges discussed above for the first temperature with reference to step 909. In further aspects, the first period of time can be within one or more of the ranges discussed above for the first time with reference to step 909. In even further aspects, step 909 can comprise heating the polymer-based portion and the substrate from ambient temperature (e.g., about 25° C.) to the first temperature at a first rate. In even further aspects, the first rate can be within one or more of the ranges discussed above for the first rate with reference to step 909.

In aspects, step 1009 can further comprise heating the polymer-based portion and the substrate at a second temperature for a second period of time at a gauge pressure. In further aspects, the second temperature can be within one or more of the ranges discussed above for the second temperature with reference to step 909. In further aspects, the second period of time can be within one or more of the ranges discussed above for the second period of time with reference to step 909. In further aspects, the gauge pressure can be positive. In further aspects, the gauge pressure can be within one or more of the gauge pressures discussed above with reference to step 909. In further aspects, the second temperature can be greater than the first temperature. In even further aspects, step 1009 can comprise heating the polymer-based portion and the substrate from the first temperature to the second temperature at a second rate. In still further aspects, the second rate can be within one or more of the ranges discussed above for the second rate with reference to step 909. In further aspects, step 1009 can comprise increasing a pressure at a third rate to reach the gauge pressure. In even further aspects, the third rate can be within one or more of the ranges discussed above for the third rate with reference to step 909.

In further aspects, step 1009 can comprise cooling the substrate and the polymer-based portion as a laminate from the second temperature to ambient temperature (e.g., about 25° C.) or another predetermined temperature at a fourth rate. In even further aspects, the fourth rate can be within one or more of the ranges discussed above for the fourth rate with reference to step 909. In further aspects, step 1009 can comprise decreasing a pressure from the gauge pressure to ambient pressure (e.g., 0 Pascals gauge pressure) or another predetermined pressure at a fifth rate. In even further aspects, the fifth rate can be within one or more of the ranges discussed above for the fifth rate with reference to step 909. In further aspects, step 1009 can comprise removing the laminate formed from the polymer-based portion and the substrate from the vacuum container, support layer(s), and/or release liner(s), if present. As a result of step 1009, the polymer-based portion 241 can become adhered to the first portion 321, the second portion 331, and/or the display device 307, and/or the first layer 1141 and the second layer 1151 can become adhered and/or form a monolithic polymer-based portion (e.g., polymer-based portion 241).

In aspects, after step 1001, as shown in FIG. 17, methods can proceed to step 1013 comprising disposing one or more layers of the polymer-based portion (e.g., first layer 1711, second layer 1701) over and/or between the first portion 321 and the second portion 331. In further aspects, step 1013 can comprise disposing the first layer 1711 between the first portion 321 and the second portion 331. In further aspects, as shown, the first contact surface 1715 of the first layer 1711 can be coplanar with the second surface area 325 and the fourth surface area 335. In even further aspects, a fourth contact surface 1705 of the second layer 1701 can face and/or contact the first surface area 323 and/or the third surface area 333. In even further aspects, the fourth contact surface 1705 of the second layer 1701 can face and/or contact the third contact surface 1713 of the first layer 1711. In even further aspects, the second layer 1701 can comprise the polymer thickness (e.g., polymer thickness 357) between the second contact surface 1703 and the fourth contact surface 1705.

After step 1007 or 1009, methods can be complete at step 1011, whereupon methods of making the foldable apparatus 301 can be complete. In aspects, as discussed above with reference to the flow chart in FIG. 10, methods can start at step 1001 and then proceed sequentially through steps 1003, 1005, 1007, and 1009. In aspects, methods can follow arrow 1002 from step 1007 to step 1011, for example, if the foldable apparatus is complete after step 1007 with the assembled foldable apparatus. In aspects, methods can follow arrow 1004 from step 1001 to step 1013, for example, if the polymer-based portion is created by disposing one or more layers (e.g., already formed layers) comprising the material of the polymer-based portion over and/or between the first portion 321 and the second portion 331. In aspects, methods can follow step 1006 from step 1013 to step 1007, for example, if the foldable apparatus is to be further assembled in step 1007. In aspects, methods can follow 1008 from step 1009 to step 1007, for example, if the foldable apparatus is to be further assembled in step 1007. Any of the above options may be combined to make a foldable apparatus in accordance with aspects of the disclosure.

### EXAMPLES

Various aspects will be further clarified by the following examples. Tables 2-6 present information about aspects of polymer-based portions, which may be used to form the foldable apparatus.

Examples A-U and AA-II comprised polymer-based portions. Specifically, Examples A-U and BB were created using a difunctional urethane-acrylate oligomer, namely, BR-543 (Dymax), in combination with two or more reactive diluents comprising. Examples AA and CC-II comprised Photomer 6230 (IGM Resins) and/or Photomer 4184 (IGM Resins) as the urethane acrylate oligomer. Photomer 6230 (IGM Reins) and Photomer 4184 comprise higher glass transition temperatures than BR-543 (Dymax). The reactive diluents include the following materials in the Miramer product line available from Miwon: 144 (a phenol ether acrylate), 164 (a nonyl phenol acrylate), 166 (a nonyl phenol acrylate), 1084 (isooctyl acrylate), and 1192 (biphenyl-methyl acrylate). Examples T-U and DD-II further comprised either 20 nm diameter silica nanoparticles (e.g., Nanocryl C130 (Evonik), Nanocryl C140 (Evonik)) or a functionalized oligomeric silsesquioxane (e.g., acrylate functionalized (APOSS, MA0736 (Hybrid Plastics), methacrylate functionalized (MAPOSS, MA0735 (Hybrid Plastics)), glycidyl functionalized (GPOSS, EP409 (Hybrid Plastics)) cross-linked with an amine-functionalized poly(dimethyl siloxane) (DMS-A21 (Gelest)). Examples A-U and AA-II further comprised 1.5 wt % of a photo-initiator, namely, ethyl (2,4,6-trimethylbenzoyl) phenylphosphinate. The properties presented in Tables 3 and 6 were not affected by the presence of up to 4.9 wt % of a silane coupling agent (e.g., 3-mercaptopropyltrimethoxysilane (SIM6476.0 (Gelest)), 3-acryloxypropyltrimethoxysilane (SIA0200.0 (Gelest))). The peel adhesion presented in Table 4 is based on the stated Example further comprising 3 wt % of 3-mercaptopropyltrimethoxysilane (SIM6476.0 (Gelest)). Unless otherwise specified Examples A-U, AA-BB, and FF-II further comprise 3 wt % of 3-mercaptopropyltrimethoxysilane (SIM6476.0 (Gelest)) while Examples CC-EE further comprises 3 wt % of 3-acryloxypropyltrimethoxysilane (SIA0200.0 (Gelest)).

Table 2 presents the composition of Examples A-S and AA-CC while Table 3 presents the properties of Examples A-S and AA-CC. Examples A-S comprise the difunctional urethane-acrylate oligomer in a range from 30 wt % to 55 wt %. Examples B-G and J-L comprise 50 wt % of the difunctional urethane-acrylate oligomer. As shown in Table 3, Examples A-U comprise a glass transition temperature in a range from about −40° C. to about −10° C. (or from about −40° C. to about −15° C.). Further, Examples A-H and L-N comprise a glass transition temperature of about −30° C. or less (e.g., from −40° C. to −30° C.). In contrast, Examples AA comprises a glass transition temperature greater than 0° C.

As shown in Table 2, Examples B, D-E, H, O, and Q-R comprise two reactive diluents (e.g., mono-functional acrylate monomer, mono-acrylate). As shown in Table 3, Examples B, D-E, H, O, and Q-R comprise a cured index of refraction (cured refractive index) from about 1.489 to about 1.526. As used herein, the cured refractive index refers to the index of refraction of the polymer-based portion after reacting the composition to form the polymer-based portion. In contrast, the liquid refractive index refers to the index of refraction of the composition before it is reacted. As shown in Table 2, Examples C, I, J-L, N, P, and S comprise three reactive diluents (e.g., mono-functional acrylate monomer, mono-acrylate). As shown in Table 3, Examples C, I, J-L, N, P, and S comprise a cured refractive index from about 1.500 to about 1.515. As shown in Table 2, Examples A, F, and M comprise four reactive diluents (e.g., mono-functional acrylate monomer, mono-acrylate).

By providing more than two reactive diluents, the index of refraction of the resulting, cured polymer-based portion can more closely match an index of refraction a substrate (e.g., glass-based substrate comprising an index of refraction from about 1.50 to about 1.52) without substantially changing the glass-transition temperature or mechanical properties.

As shown in Table 3, Examples A-K comprise a tensile strength from 0.16 MPa to 1.25 while Examples A-G and J-K comprise a tensile strength from 0.16 MPa to 0.71 MPa. As shown in Table 3, Examples A-K comprise an ultimate elongation from 150% to 222%. As shown in Table 3, Examples A-K comprise an elastic modulus from 0.85 MPa to 3.12 MPa while Examples A-D, F-I, and K comprise an elastic modulus from 0.85 MPa to 1.21 MPa. In contrast, Examples AA-CC comprise an elastic modulus from about 2.4 MPa to about 55 MPa.

TABLE 2
Composition ranges (wt %) of Examples of polymer-based portions

| | Example | | | | | | | |
|---|---|---|---|---|---|---|---|---|
| | A | B | C | D | E | F | G | H |
| Dymax | 30 | 50 | 50 | 50 | 50 | 50 | 50 | 55 |
| BR-543 | | | | | | | | |
| Miramer 144 | 20 | 0 | 0 | 0 | 20 | 10 | 10 | 0 |
| Miramer 164 | 0 | 0 | 0 | 0 | 0 | 10 | 0 | 0 |
| Miramer 166 | 20 | 40 | 20 | 0 | 0 | 0 | 10 | 0 |
| Miramer 1084 | 20 | 0 | 20 | 40 | 0 | 15 | 20 | 35 |
| Miramer 1192 | 10 | 10 | 10 | 10 | 10 | 10 | 10 | 10 |

Example

| | I | J | K | L | M | N |
|---|---|---|---|---|---|---|
| Dymax | 40 | 50 | 50 | 50 | 35 | 30 |
| BR-543 | | | | | | |
| Miramer 144 | 0 | 0 | 0 | 10 | 15 | 20 |
| Miramer 164 | 40 | 20 | 0 | 0 | 0 | 0 |
| Miramer 166 | 0 | 20 | 10 | 0 | 25 | 0 |
| Miramer 1084 | 10 | 0 | 20 | 20 | 25 | 30 |
| Miramer 1192 | 10 | 20 | 20 | 15 | 10 | 20 |

| | Example | | | | | | | |
|---|---|---|---|---|---|---|---|---|
| | O | P | Q | R | S | AA | BB | CC |
| Dymax | 40 | 40 | 40 | 40 | 30 | 0 | 40 | 0 |
| BR-543 | | | | | | | | |
| Photomer | 0 | 0 | 0 | 0 | 0 | 50 | 0 | 50 |
| 6230 | | | | | | | | |
| Photomer | 0 | 0 | 0 | 0 | 0 | 40 | 0 | 40 |
| 4184 | | | | | | | | |
| Miramer 144 | 25 | 10 | 40 | 40 | 40 | 0 | 0 | 0 |
| Miramer 164 | 0 | 0 | 0 | 0 | 0 | 0 | 40 | 0 |
| Miramer 166 | 0 | 40 | 10 | 0 | 20 | 0 | 0 | 0 |
| Miramer 1084 | 0 | 0 | 0 | 20 | 0 | 0 | 0 | 0 |
| Miramer 1192 | 10 | 10 | 10 | 20 | 10 | 10 | 20 | 10 |

TABLE 3
Properties of Examples of polymer-based portions

| | Example | | | | | | | |
|---|---|---|---|---|---|---|---|---|
| | A | B | C | D | E | F | AA | BB |
| Tg (° C.) | −33 | −32 | −34 | −39 | −33 | −33 | 9 | −14 |
| Tensile Strength (MPa) | 0.16 | 0.71 | 0.53 | 0.51 | 0.71 | 0.66 | 1.74 | 1.25 |
| Ultimate Elongation (%) | 222 | 172 | 150 | 180 | 209 | 219 | 107 | 154 |
| Elastic Modulus (MPa) | 0.92 | 1.15 | 0.86 | 0.85 | 3.12 | 0.85 | 2.70 | 2.43 |
| Viscosity (Pa-s) | 0.45 | 6.72 | 2.16 | 0.83 | 1.65 | 1.77 | 0.96 | 2.63 |
| Liquid Refractive Index | 1.481 | 1.494 | 1.481 | 1.471 | 1.483 | 1.483 | 1.481 | 1.506 |
| Cured Refractive Index | 1.502 | 1.503 | 1.497 | 1.489 | 1.500 | 1.499 | 1.500 | 1.522 |

Example

| | G | H | I | J | K | CC |
|---|---|---|---|---|---|---|
| Tg (° C.) | −33 | −35 | −23 | −18 | −26 | — |
| Tensile Strength (MPa) | 0.67 | 1.10 | 1.25 | 0.80 | 0.57 | 17.4 |
| Ultimate Elongation (%) | 180 | 171 | 198 | 200 | 165 | 110 |
| Elastic Modulus (MPa) | 0.85 | 1.96 | 1.21 | 1.97 | 0.91 | 53 |
| Viscosity (Pa-s) | 2.13 | 1.31 | 1.67 | 2.96 | 1.45 | — |
| Liquid Refractive Index | 1.484 | 1.472 | 1.491 | 1.504 | 1.492 | — |
| Cured Refractive Index | 1.498 | 1.490 | 1.501 | 1.507 | 1.501 | — |

| | Example | | | | | | | |
|---|---|---|---|---|---|---|---|---|
| | L | M | N | O | P | Q | R | S |
| Tg (° C.) | −31 | −33 | −30 | −27 | −29 | −24 | −15 | −23 |
| Viscosity (Pa-s) | 1.37 | 0.78 | 2.4 | 2.17 | 2.7 | 1.76 | 1.61 | 0.9 |
| Liquid | 1.484 | 1.487 | 1.488 | 1.497 | 1.495 | 1.499 | 1.509 | 1.499 |
| Refractive Index | | | | | | | | |
| Cured Refractive | 1.502 | 1.503 | 1.512 | 1.511 | 1.507 | 1.513 | 1.526 | 1.515 |
| Index | | | | | | | | |

A foldable apparatus resembling foldable apparatus 401, where the polymer-based portion comprises Example B with a polymer thickness of 20 μm, was able to achieve a parallel plate distance of 3 mm. Additionally, a foldable apparatus resembling foldable apparatus 601, where the polymer-based portion comprises Example B, was able to withstand 200,000 cycles bending to a parallel plate distance of 3 mm without failure.

Table 4 presents peel adhesion measured via a 1800 peel adhesion test in accordance with ASTM D3330 Test Method D with a 76 micron (0.003 inch) thick PET pressed onto the polymer-based portion and an annealed soda lime glass substrate with 4.5 kgf at a constant speed of 305 mm/min (12 inch/min) using an Poweroll PR-1000 (IMASS). The PET, polymer-based portion, and glass substrate comprised dimensions of 12.7 mm (0.5 inch) by 152 mm (6 inch). Twenty minutes elapsed from when the PET was pressed onto polymer-based portion and glass substrate before performing the 180° peel of the PET at a constant peed of 305 in/min using an TL-2300 Peel Tester (IMASS). As shown in FIG. 4, Example B comprises a peel adhesion of 0.052 N/12.7 mm (N/0.5 inch), Example C comprises a peel adhesion of 0.072 N/12.7 mm, and Example BB comprises a peel adhesion of 0.121 N/12.7 mm.

TABLE 4
Peel adhesion of Examples of polymer-based portions

| | Peel |
|---|---|
| | Adhesion |
| Example | (N/12.7 mm) |
| B | 0.052 |
| C | 0.072 |
| BB | 0.121 |

TABLE 5
Composition ranges (wt %) of Examples of polymer-based portions

| | Example | | | | | | | |
|---|---|---|---|---|---|---|---|---|
| | T | U | DD | EE | FF | GG | HH | II |
| Dymax | 37.5 | 25 | 0 | 0 | 0 | 0 | 0 | 0 |
| BR-543 | | | | | | | | |
| Photomer | 0 | 0 | 30 | 20 | 40 | 40 | 40 | 40 |
| 6230 | | | | | | | | |
| Photomer | 0 | 0 | 37.5 | 25 | 32 | 32 | 32 | 32 |
| 4184 | | | | | | | | |
| Miramer | 30 | 20 | 0 | 0 | 0 | 0 | 0 | 0 |
| M1084 | | | | | | | | |
| Miramer | 7.5 | 5 | 7.5 | 5 | 8 | 8 | 8 | 8 |
| 1192 | | | | | | | | |
| APOSS | 25 | 50 | 25 | 50 | 0 | 0 | 0 | 0 |
| MAPOSS | 0 | 0 | 0 | 0 | 20 | 0 | 0 | 0 |
| GPOSS | 0 | 0 | 0 | 0 | 0 | 20 | 0 | 0 |
| Nanocryl | 0 | 0 | 0 | 0 | 0 | 0 | 20 | 0 |
| C130 | | | | | | | | |
| Nanocryl | 0 | 0 | 0 | 0 | 0 | 0 | 0 | 20 |
| C140 | | | | | | | | |

TABLE 6
Properties of Examples of polymer-based portions

| | Example | | | | | | | |
|---|---|---|---|---|---|---|---|---|
| | T | U | DD | EE | FF | GG | HH | II |
| Tensile Strength (MPa) | 26.9 | 37.4 | 28.5 | 44.2 | 5.84 | 1.43 | 2.66 | 5.34 |
| Ultimate Elongation (%) | 35 | 12 | 23 | 9 | 8 | 77 | 74 | 46 |
| Elastic Modulus (MPa) | 111 | 659 | 300 | 1076 | 101 | 3.2 | 3.9 | 11.8 |

Tables 5-6 present the composition and properties of Examples T-U and DD-II. Examples T-U and DD-EE comprise an acrylate functionalized oligomeric silsesquioxane (APOSS) in addition to the urethane-acrylate oligomer and reactive diluent. Example FF comprises a methacrylate functionalized oligomeric silsesquioxane (MAPOSS) in addition to the urethane-acrylate oligomer and reactive diluent. Examples GG-II comprise one of glycidyl functionalized oligomeric silsesquioxane (GPOSS) or silica nanoparticles. Example T-U and DD-EE comprise a tensile strength from about 25 MPa to about 45 MPa. Example T comprises an ultimate elongation of 35% while Example U comprises an ultimate elongation of 12%. Example T comprises an elastic modulus of 111 MPa while Example U comprises an elastic modulus of 659 MPa. In contrast, Examples FF-II comprise a lower tensile strength than Examples T-U. Examples GG-II comprise an ultimate elongation greater than Examples T-U and D-EE. Examples GG-II comprise an elastic modulus less than Examples T-U and DD-FF.

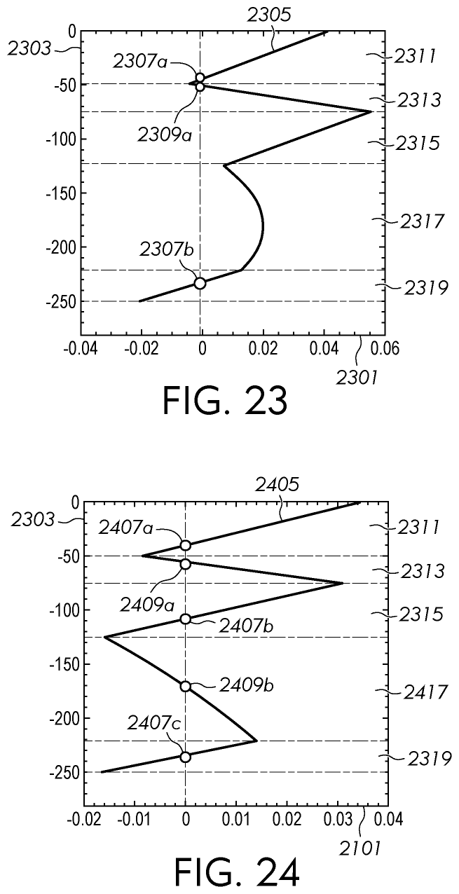

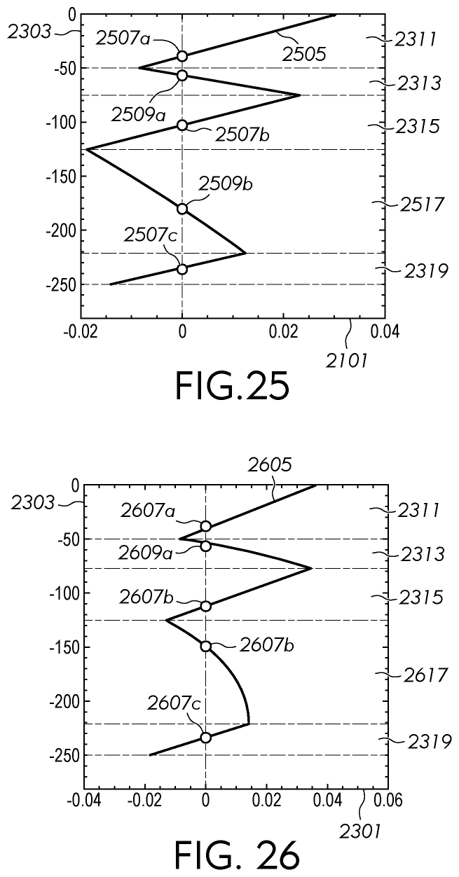

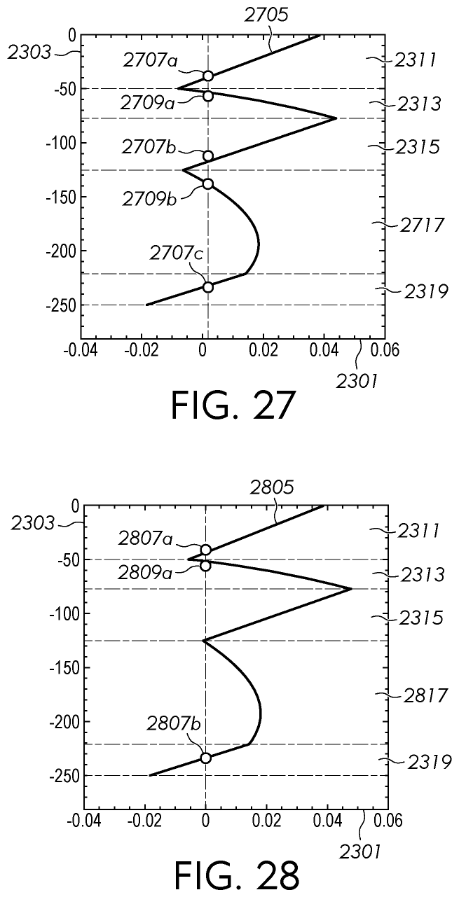

FIGS. 23-28 present simulated curves 2305, 2405, 2505, 2605, 2705, or 2805 of strain versus position for a foldable apparatus resembling foldable apparatus 301 with a 50 μm thick PET layer in place of the display device 307 and the first substrate 371 (regions 2311 and 2315, respectively). The second adhesive layer 361 comprises a thickness of 25 μm (region 2313). The second substrate 381 (region 2319), the first portion 321, and the second portion 331 comprise Composition 1 (nominally, in mol % of: 69.1 SiO₂; 10.2 Al₂O₃; 15.1 Na₂O; 0.01 K₂O; 5.5 MgO; 0.09 SnO₂) with corresponding thicknesses of 30 μm, 50 μm, and 50 μm, respectively. The polymer-based portion comprised a polymer thickness 357 of 20 μm. The adhesive layer 261 comprises an adhesive thickness 267 of 25 μm. The adhesive layer 261 and the polymer-based portion 241 comprising the same elastic modulus, which was 2.5 MPa in FIG. 23 (region 2317), 0.25 MPa in FIG. 24 (region 2417), 0.125 MPa in FIG. 25 (region 2517), 0.50 MPa in FIG. 26 (region 2617), 1 MPa in FIG. 27 (region 2717), and 1.5 MPa in FIG. 28 (region 2817).

In FIGS. 24-27, the curve 2405, 2505, 2605, and 2705 comprises a neutral plane in each of the regions demarcated by dashed lines, namely three first neutral planes 2407a-c, 2507a-c, 2607a-c, and 2707a-c and two second neutral planes 2409a-b, 2509a-b, 2609a-b, 2709a-b. Since the curves and properties of FIGS. 24-27 correspond to three first portions and two second portions such that each portion comprises a corresponding neutral plane, no mechanical instabilities are expected. FIGS. 24-25 comprise linear curves 2405 and 2505 in the region 2417 and 2517 while FIGS. 26-27 comprise non-linear curves 2605 and 2705 in the region 2617 and 2717. The non-linear curves of FIGS. 26-27 suggest that the portions of the foldable apparatus are not fully decoupled, which can increase an incidence of fatigue of the foldable substrate compared to a fully decoupled foldable apparatus in FIGS. 24-25. Consequently, an elastic modulus of the polymer-based portion of less than 0.5 MPa (e.g., 0.125 MPa in FIG. 25, 0.25 MPa in FIG. 24) appear to be fully decoupled.

FIGS. 23 and 28 comprise two first neutral planes 2307a-b and 2807a-b and a single second neutral plane 2309a and 2809a. Here, the number of neutral planes is less than the corresponding number of first portions and second portions. Consequently, it is expected that the foldable apparatus corresponding to FIGS. 23 and 28 would exhibit mechanical instabilities. Consequently, an elastic modulus of the polymer-based portion from about 0.5 MPa to about 1.5 MPa (e.g., 0.5 MPa in FIG. 26, 1 MPa in FIG. 27) is at least partially decoupled. It is expected that a thicker polymer thickness would increase the elastic modulus of the polymer-based portion for which the portions are decoupled or partially decoupled. It is noted that Examples A-D, G, I, K-M, and S comprise elastic moduli within this range.

The above observations can be combined to provide polymer-based portion and/or foldable apparatus comprising a polymeric material and methods of making the same. In aspects, an index of refraction of the polymeric material of the polymer-based portion can comprise a small (e.g., about 0.01 or less) absolute difference from an index of refraction of a substrate (e.g., first substrate, second substrate). Providing an index of refraction for the polymer-based portion within one or more of the above-mentioned ranges can reduce an absolute difference of index of refraction between the polymer-based portion and components (e.g., substrate, adhesive, hard-coating) that can be adjacent to the polymer-based portion in an application, which can reduce optical distortions. Providing a plurality of reactive diluents (e.g., 2, 3, 4, or more) in the composition used to form the polymer-based portion can enable the polymer-based portion to better match the index of refraction of adjacent components. Providing a polymeric material comprising low haze can enable good visibility through the polymer-based portion and/or foldable apparatus.

The polymer-based portion can comprise a urethane acrylate material that is elastomeric. By providing an elastomeric polymer-based portion, the polymer-based portion can recover (e.g., fully recover) from folding-induced strains and/or impact-induced strains, which can decrease fatigue of the polymer-based portion from repeated folding, enable a low force to achieve a given parallel plate distance, and enable good impact and/or good puncture resistance. Providing a composition that is substantially solvent-free can increase its curing rate, which can decrease processing time. Providing a composition that is substantially solvent-free can reduce (e.g., decrease, eliminate) the use of rheology modifiers and increase composition homogeneity, which can increase the optical transparency (e.g., transmittance) of the resulting adhesive. Providing a composition that is substantially free of a multi-functional monomer can enable a lower elastic modulus of the resulting polymer-based portion, which can improve foldability of a foldable apparatus with the polymer-based portion.

Providing a low glass transition temperature (e.g., about −10° C. or less, about −20° C. or less) of the polymer-based portion can enable consistent mechanical properties of the polymer-based portion across a temperature range in which it is used (e.g., from about 0° C. to about 60° C.). Providing a difunctional urethane-acrylate oligomer can comprise a low glass transition temperature (e.g., less than the glass transition temperature of the polymer-based portion, about −10° C. or less, about −30° C. or less). Also, the polymer-based portion can withstand high strains (e.g., about 50% or more, from about 100% to about 250%), which can improve folding performance and durability. Providing a silane-coupling agent can increase adhesion of the polymer-based portion to substrates (e.g., glass-based substrates, ceramic-based substrates, polymer-based substrates) and/or adhesives.

Methods are disclosed that can form a foldable apparatus from a polymer-based portion and a substrate (e.g., first substrate, second substrate). For example, a polymer-based portion can be formed of a polymeric material by heating a liquid comprising the material. Providing a polymer-based portion can reduce processing steps to assemble the foldable apparatus. For example, foldable apparatus can be assembled using methods of the disclosure using a single heating cycle to bond one or more polymer-based portions, substrates, and/or other components of the foldable apparatus. Consequently, processing time and costs to create the foldable apparatus can be reduced. Providing polymer-based portions can reduce energy use, reduce material waste, and otherwise improve forming of the foldable apparatus.

A foldable apparatus according to the aspects of the disclosure can provide several technical benefits. For example, the foldable apparatus can provide small effective minimum bend radii while simultaneously providing good impact and puncture resistance. The foldable apparatus can comprise glass-based and/or ceramic-based materials comprising one or more compressive stress regions, which can further provide increased impact resistance and/or puncture resistance while simultaneously facilitating good bending performance. Providing a foldable apparatus comprising a central portion comprising a central thickness that is less than a first thickness of the first portion and/or second portion can enable small effective minimum bend radii (e.g., about 10 millimeters or less) based on the reduced thickness in the central portion.

A ribbon, substrates, and/or portions can comprise glass-based and/or ceramic-based portions, which can provide good dimensional stability, reduced incidence of mechanical instabilities, good impact resistance, and/or good puncture resistance. The ribbon, the substrate, the first portion, and/or the second portion can comprise glass-based and/or ceramic-based portions comprising one or more compressive stress regions, which can further provide increased impact resistance and/or increased puncture resistance. By providing the substrate, the first portion, and/or the second portion comprising a glass-based and/or ceramic-based substrate, the substrate can also provide increased impact resistance and/or puncture resistance while simultaneously facilitating good folding performance. Providing a ribbon comprising a central portion comprising a central thickness that is less than a substrate thickness (e.g., first thickness of the first portion and/or second thickness of the second portion) can enable small effective minimum bend radii (e.g., about 10 millimeters or less) based on the reduced thickness in the central portion.

Providing the polymer-based portion can be used as an adhesive layer and as a polymeric (e.g., elastomeric) portion. Using the polymer-based portion as both an adhesive layer and a polymer portion can reduce a number of components in the foldable apparatus. An elastic modulus of the polymer-based portion and a polymer thickness of the polymer-based portion can enable substrates, portions, and/or a ribbon to be at least partially decoupled. For example, an at least partially decoupled foldable apparatus can comprise an apparatus bend force near (e.g., within a factor of 2, from about 0.5 times to about 1 time) of a total bend force from bending each first portion individually, which can enable low user-applied forces to fold the foldable apparatus. For example, a ratio of an elastic modulus of the substrates, the portions, and/or the ribbon to the elastic modulus of the polymer-based portion is in a range from about 500 to about 200,000. For example, a polymer thickness can be in a range from about 10 micrometers to about 30 micrometers. Providing the elastic modulus and/or the polymer thickness of the polymer-based portion can reduce bend-induced stresses on one or more of the first portions in the adjacent pair of first portions. Reducing bend-induced stresses can reduce (e.g., decreases, eliminate) bend-induced mechanical instabilities of the foldable apparatus. Also, reducing bend-induced stresses can reduce fatigue of the foldable apparatus while increasing the reliability and/or durability of the foldable apparatus. In aspects, the polymer-based portion can comprise a second neutral plane between two first neutral planes, which can reflect the decoupling of the components of the foldable apparatus.

Directional terms as used herein—for example, up, down, right, left, front, back, top, bottom—are made only with reference to the figures as drawn and are not intended to imply absolute orientation.

It will be appreciated that the various disclosed aspects may involve features, elements, or steps that are described in connection with that aspect. It will also be appreciated that a feature, element, or step, although described in relation to one aspect, may be interchanged or combined with alternate aspects in various non-illustrated combinations or permutations.

It is also to be understood that, as used herein the terms “the,” “a,” or “an,” mean “at least one,” and should not be limited to “only one” unless explicitly indicated to the contrary. For example, reference to “a component” comprises aspects having two or more such components unless the context clearly indicates otherwise. Likewise, a “plurality” is intended to denote “more than one.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. Ranges can be expressed herein as from “about” one particular value, and/or to “about” another particular value. When such a range is expressed, aspects include from the one particular value and/or to the other particular value. Similarly, when values are expressed as approximations, by use of the antecedent “about,” it will be understood that the particular value forms another aspect. Whether or not a numerical value or endpoint of a range in the specification recites “about,” the numerical value or endpoint of a range is intended to include two aspects: one modified by “about,” and one not modified by “about.” It will be further understood that the endpoints of each of the ranges are significant both in relation to the other endpoint and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In aspects, “substantially similar” may denote values within about 10% of each other, for example, within about 5% of each other, or within about 2% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements, or steps of particular aspects may be disclosed using the transitional phrase “comprising,” it is to be understood that alternative aspects, including those that may be described using the transitional phrases “consisting of” or “consisting essentially of,” are implied. Thus, for example, implied alternative aspects to an apparatus that comprises A+B+C include aspects where an apparatus consists of A+B+C and aspects where an apparatus consists essentially of A+B+C. As used herein, the terms “comprising” and “including”, and variations thereof shall be construed as synonymous and open-ended unless otherwise indicated.

The above aspects, and the features of those aspects, are exemplary and can be provided alone or in any combination with any one or more features of other aspects provided herein without departing from the scope of the disclosure.

It will be apparent to those skilled in the art that various modifications and variations can be made to the present disclosure without departing from the spirit and scope of the disclosure. Thus, it is intended that the present disclosure cover the modifications and variations of the aspects herein provided they come within the scope of the appended claims and their equivalents.

1. A polymer-based portion comprising an index of refraction in a range from about 1.48 to about 1.54, wherein the polymer-based portion comprises the product of curing a composition, the composition comprises a ratio of an amount of a difunctional urethane-acrylate oligomer to an amount of a reactive diluent in a range from about 0.4 to about 1.5.

2. The polymer-based portion of claim 1, wherein the composition comprises the following in weight % (wt %):
35-60 wt % of the difunctional urethane-acrylate oligomer; and
40-65 wt % of the reactive diluent.

3. The polymer-based portion of claim 1, wherein the reactive diluent comprises one or more of biphenylmethyl acrylate, phenol ether acrylate, an alkyl phenol ether acrylate, or isooctyl acrylate.

4. The polymer-based portion of claim 1, wherein the polymer-based portion comprises a glass transition temperature in a range from about −40° C. to about −10° C.

5. The polymer-based portion of claim 1, wherein the composition further comprises 0.1-4.9 wt % of a silane coupling agent.

6. The polymer-based portion of claim 1, wherein the polymer-based portion comprises an ultimate elongation of about 100% or more.

7. The polymer-based portion of claim 1, wherein the polymer-based portion comprises a tensile strength in a range from about 0.5 MegaPascals to about 2 MegaPascals.

8. The polymer-based portion of claim 1, wherein the polymer-based portion comprises an elastic modulus in a range from about 0.5 MegaPascals to about 10 MegaPascals.

9. The polymer-based portion of claim 1, wherein the polymer-based portion can withstand 200,000 bending cycles at a parallel plate distance of 3 millimeters.

10. The polymer-based portion of claim 1, wherein the polymer-based portion achieves a parallel plate distance of 10 millimeters.

11. (canceled)

12. A method of forming a polymer-based portion comprising:
creating a composition comprising a ratio of an amount of a difunctional urethane-acrylate oligomer to an amount of a reactive diluent in a range from about 0.4 to about 1.5; and
curing the composition to form the polymer-based portion,
wherein the polymer-based portion comprises an index of refraction in a range from about 1.48 to about 1.54.

13. The method of claim 12, wherein the composition comprises the following in weight % (wt %):
35-60 wt % of the difunctional urethane-acrylate oligomer; and
40-65 wt % of the reactive diluent.

14. The method of claim 12, wherein the reactive diluent comprises one or more of biphenylmethyl acrylate, phenol ether acrylate, an alkyl phenol ether acrylate, or isooctyl acrylate.

15. The method of claim 12, wherein the polymer-based portion comprises a glass transition temperature in a range from about −40° C. to about −10° C.

16. The method of claim 1, wherein creating the composition further comprises combining a 0.2-2 wt % of a photo-initiator, and curing the composition comprises irradiating the composition with at least one wavelength of light that the photo-initiator is sensitive to.

17. The method of claim 12, wherein the composition further comprises 1-4.9 wt % of a silane coupling agent.

18. The method of claim 12, wherein the composition is substantially free of a multi-functional monomer.

19. The method of claim 12, wherein the polymer-based portion comprises an ultimate elongation of about 100% or more.

20. The method of claim 12, wherein the polymer-based portion comprises an elastic modulus in a range from about 0.5 MegaPascals to about 10 MegaPascals.

21. A foldable apparatus comprising:
a ribbon comprising a central portion positioned between a first portion and a second portion, the central portion comprises a central thickness defined between a first central surface area and a second central surface area opposite the first central surface area, the ribbon comprises a ribbon thickness defined between a first major surface and a second major surface opposite the first major surface, the first central surface area recessed from the first major surface by a first distance, wherein the recess is defined between a first plane defined by the first major surface and a second plane defined by the first central surface area; and
the polymer-based portion of claim 1 at least partially positioned in the recess.
